(19) United States
(12) Patent Application Publication
(10) Pub. No.: US 2018/0126455 A1
(43) Pub. Date: May 10, 2018

(54) FLAT METAL PARTICLE, MOLDED ARTICLE HAVING FLAT METAL PARTICLE, METHOD FOR MANUFACTURING FLAT METAL PARTICLE, AND METHOD FOR MANUFACTURING METAL PLATE

(71) Applicants: NATIONAL INSTITUTE OF TECHNOLOGY, Tokyo (JP); NATIONAL UNIVERSITY CORPORATION NAGAOKA UNIVERSITY OF TECHNOLOGY, Nagaoka-shi, Niigata-ken (JP)

(72) Inventors: Satoshi MOTOZUKA, Motosu-shi (JP); Masahiko MORINAGA, Nagoya-shi (JP); Motohiro TAGAYA, Nagaoka-shi (JP)

(21) Appl. No.: 15/565,453

(22) PCT Filed: Apr. 13, 2016
(86) PCT No.: PCT/JP2016/061913

§ 371 Date: Oct. 10, 2017

(30) Foreign Application Priority Data
Apr. 13, 2015 (JP) 2015-081986

(51) Int. Cl. B22F 1/00; C01G 49/00; C01B 32/20

(52) U.S. Cl. CPC B22F 1/0018; C01G 49/009; C01B 32/20; C01P 2006/90; C01P 2004/03; C01P 2004/62; C01P 2002/70

(57) ABSTRACT

Provided are flat metal particles having an aggregate structure due to mechanochemical processing. In the present invention, a method of manufacturing flat metal particles includes mechanochemical processing performed on metal powder including metal particles having an average particle diameter of 0.1 μm to 1000 μm inclusive. In the mechanochemical processing, flat metal particles are formed from the metal particles by being subjected to rolling processing involving at least one from among processing for deforming the metal particles so as to be flat, processing for layering the metal particles that have been formed to be flat, and processing for flattening a mass of a plurality of the metal particles.

### TECHNICAL FIELD

The present invention relates to a flat metal particle, a molded article having a flat metal particle, a method of manufacturing a flat metal particle, and a method of manufacturing a metal plate.

### BACKGROUND ART

Controlling the texture (also referred to as crystal texture) of a metal material is performed for improving functionalities of the metal material. In copper alloys used for electronic parts, further improvements in processability have been demanded for achieving compactification of products and making products highly functionalized. To process a copper alloy material into a minute member with a high precision, it is desired to roll the copper alloy material to make a rolled alloy plate having a good processability. For example, it is known that it is important to orientate the (111) plane parallel with a plate surface in order to improve the press formability and bend processability of a rolled material (see Non-patent Document 1, Non-patent Document 2, Patent Document 1). In addition, Non-patent Document 4 discloses plasticity processing including bend processing on the metal plate having a texture.

In addition, controlling the texture is also performed for improving electromagnetic performance of a steel plate. Because of a rise in global environmental issues in recent years, improvements in miniaturization, high output, and high energy efficiency become a problem to be solved in electric equipment. As means for solving the problem, a material called an electromagnetic steel plate, which has a low iron loss and a high magnetic flux density, is used in electromagnetic parts incorporated in the electric equipment. Improvements in properties of the electric equipment due to the electromagnetic steel plate are attributable to the texture formed by a recrystallization texture control technique. A basis of the recrystallization texture control is to reduce a {111} plane that does not include an easy axis of magnetization in a plate surface and to increase a {110} plane and a {100} plane that include the easy axis of magnetization in the plate surface. For example, there is proposed a method for developing a {100}<001> orientation making good use of a {510}<001> orientation accumulated by a special hot rolling condition in Patent Document 2 and Patent Document 3.

Further, in the metal material, improvements in functions can also be achieved by making the shape thereof in a particle form. In recent years, problems of electromagnetic wave interference due to portable electronic equipment, specifically, malfunctions of medical equipment, which are thought to be caused by the electromagnetic wave interference due to cellular phones, have been reported in air planes and the like. As a stuff to suppress such an unnecessary high frequency radio wave, an electromagnetic wave noise suppressor such as an electromagnetic wave absorbing sheet is used. The electromagnetic wave absorbing sheet is manufactured by forming a composite from a resin and a metal material in a particle form. The noise suppression effect of the electromagnetic wave noise suppressor is more excellent as an imaginary part “μ” of the complex magnetic permeability shows a larger value. The μ becomes high in proportion to a packing ratio of the metal particle in a resin. Therefore, a method including flattening the metal material in a particle form and then orientating the flattened metal material in one direction through injection molding to increase the packing ratio is taken (see Patent Document 4). In addition, a method for producing a metal plate using a metal powder (powder rolling method) is disclosed in Patent Document 5.

In addition, some electromagnetic parts are made by performing compression molding on a particle in order to achieve the low iron loss. Many of products, such as a transformer, an electric motor, and a generator, which utilize electromagnetism utilize an alternating magnetic field and are provided with an iron core in the alternating magnetic field in order to obtain a large alternating magnetic field locally and efficiently. Reducing eddy current loss which occurs inside the iron core according to the frequency of the magnetic field is required for the iron core that is an electromagnetic part. Such an iron core is obtained by performing pressure forming on a metal particle coated with an insulating film. This is because the eddy current loss can be reduced by subdividing a region where the eddy current occurs by the insulating film at the interface with the particle (see Non-patent Document 3).

### PRIOR ART DOCUMENTS

Patent Document 1: WO 2007/148712 A1
Patent Document 2: Japanese Laid-Open Patent Publication No. 2000-160248
Patent Document 3: Japanese Laid-Open Patent Publication No. 2000-160249
Patent Document 4: Japanese Laid-Open Patent Publication No. 2000-68117
Patent Document 5: Japanese Laid-Open Patent Publication No. 50-75506
Non-patent Document 1: Ph. Lequeu and J. J. Jonas, Metallurgical transactions A, Vol. 19A (1988), pp. 105-120.
Non-patent Document 2: Isao Gokyu, Keijiro Suzuki and Chozo Fujikura, J. Japan Inst. Met. Mater., Vol. 32(1968), pp. 742-747
Non-patent Document 3: Terukazu Tokuoka, Toru Maeda and Tomoyuki Ishimine, Sokeizai, Vol. 52(2011), No. 8, pp. 11-18
Non-patent Document 4: H. Takeda, A. Hibino, and K. Tanaka, Materials transactions, Vol. 51, (2010), pp. 614-619.

### SUMMARY OF THE INVENTION

### Problems that the Invention is to Solve

As mentioned above, the metal material is used in various stuffs such as a metal plate for electronic parts, an iron core in a transformer, an electric motor, generator, or the like, an electromagnetic wave absorbing sheet, and an electrical conducting material in electronic parts. The present invention has as its object to provide a novel metal material.

### Means for Solving the Problems

To solve the above object, a flat metal particle has a texture due to mechanochemical treatment.

To solve the above object, a flat metal particle has a flat surface and directionality in crystal orientation. In an example of the flat metal particle includes a plurality of layers along the flat surface.

Preferably, the flat metal particle has a thickness of 0.05 μm or more and 100 μm or less.

Preferably, the flat metal particle has an aspect ratio d/t of 2 or more, where t represents a thickness of the flat metal particle and d represents a particle diameter which is a size in a direction orthogonal to a thickness direction of the flat metal particle.

In a pole figure, obtained by powder X-ray diffractometry, of a crystal plane of the flat metal particle preferably shows a polar or belt-like intensity distribution.

Preferably, the flat metal particle includes a metal having a body-centered cubic lattice structure, and when a total intensity of diffraction peaks of successive 5 crystal planes from a low angle side in a powder X-ray diffraction chart of the flat metal particle is set to be 100%, an intensity ratio of at least one diffraction peak of the diffraction peaks of the 5 crystal planes from the low angle side is higher by 10% or more than an intensity ratio of a diffraction peak of a metal particle that lacks a texture.

Preferably, the flat metal particle includes a metal having a body-centered cubic lattice structure, and when a total intensity of diffraction peaks at {110}, {002}, {211}, {220}, and {310} in a powder X-ray diffraction chart of the flat metal particle is set to be 100%, an intensity ratio of the diffraction peak at {002} is 20% or more.

Preferably, the metal having the body-centered cubic lattice structure is a metal or an alloy, the metal being selected from the group consisting of Fe, V, Cr, Nb, Ta, and W, and the alloy including at least one of Fe, V, Cr, Nb, Ta, and W.

Preferably, the flat metal particle includes a metal having a face-centered cubic lattice structure, and when a total intensity of diffraction peaks of successive 5 crystal planes from a low angle side in a powder X-ray diffraction chart of the flat metal particle is set to be 100%, an intensity ratio of at least one diffraction peak of the diffraction peaks of the 5 crystal planes from the low angle side is higher by 10% or more than an intensity ratio of a diffraction peak of a metal particle that lacks a texture.

Preferably, the flat metal particle includes a metal having a face-centered cubic lattice structure, and when a total intensity of diffraction peaks at {111}, {002}, {220}, {311}, and {222} in a powder X-ray diffraction chart of the flat metal particle is set to be 100%, an intensity ratio of the diffraction peak at {220} is 10% or more.

Preferably, the metal having the face-centered cubic lattice structure is a metal or an alloy, the metal being selected from the group consisting of Al, Ni, Cu, Pb, Ag, Pt, Au, and Pd, and the alloy including at least one of Al, Ni, Cu, Pb, Ag, Pt, Au, and Pd.

Preferably, the flat metal particle includes a metal having a hexagonal close-packed structure, and when a total intensity of diffraction peaks of 3 crystal planes from a low angle side in a powder X-ray diffraction chart of the flat metal particle is set to be 100%, an intensity ratio of at least one diffraction peak of the diffraction peaks of the 3 crystal planes from the low angle side is higher by 10% or more than an intensity ratio of a diffraction peak of a metal particle that lacks a texture.

Preferably, the flat metal particle includes a metal having a hexagonal close-packed structure, and when a total intensity of diffraction peaks at {10-01}, {0002}, and {10-11} in a powder X-ray diffraction chart of the flat metal particle is set to be 100%, an intensity ratio of the diffraction peak at {0002} is 20% or more.

Preferably, the metal having the hexagonal close-packed structure is a metal or an alloy, the metal being selected from the group consisting of Ti, Co, Zn, and Zr, and the alloy including at least one of Ti, Co, Zn, and Zr

A flat metal particle includes a flat metal particle having the above configuration and an insulating film covering the flat metal particle.

A molded article includes flat metal particles having the above configuration, with flat surfaces of the flat metal particles facing a same direction.

To solve the above object, a method of manufacturing a flat metal particle includes performing a mechanochemical treatment on a metal powder containing metal particles having an average particle diameter of 0.1 μm or greater and 1000 μm or less. In the mechanochemical treatment, the flat metal particle is formed from the metal particle(s) through a rolling treatment which includes at least one of: a treatment of deforming and flattening the metal particles; a treatment of laminating the metal particles which are flattened; and a treatment of flattening a lump of the metal particles.

In the method of manufacturing the flat metal particle, it is preferable that an aspect ratio d/t of the flat metal particle is made 2 or more in the mechanochemical treatment, where t represents a thickness of the flat metal particle and d represents a particle diameter which is a size in a direction orthogonal to a thickness direction of the flat metal particle

In the method of manufacturing the flat metal particle, it is preferable that in the mechanochemical treatment, a lubricant is used as a texturization aid for facilitating texturization of the metal particles.

The lubricant is at least one selected from the group consisting of solid carbon compounds and solid molybdenum disulfide, for example. When using a solid lubricant, it is preferable that the mechanochemical treatment is performed under a gas atmosphere of non-rare gas, and more specifically, it is preferable that the mechanochemical treatment is performed under an atmosphere of a gas including at least one of oxygen and nitrogen.

The lubricant may be a carbon compound having fluidity. In this case, it is preferable that after the mechanochemical treatment, the texturization aid adhered to the flat metal particle is dissolved with a solvent to remove the texturization aid from the flat metal particle.

A method of manufacturing a metal plate includes charging metal particles into a mechanochemical treatment container so that the amount of the metal particle will be 0.001 or more and 0.99 or less in terms of a volume ratio based on an inner volume of the mechanochemical treatment container of 1, and then performing a mechanochemical treatment to obtain flat metal particles having a texture.

In the method, the mechanochemical treatment may be performed using a texturization aid, with the total amount of the metal particle and the texturization aid will be 0.99 or less in terms of the volume ratio based on the inner volume of the mechanochemical treatment container of 1.

A method of manufacturing a metal plate includes positioning a metal powder containing the flat metal particles having the above configuration so that the flat surfaces of the flat metal particles are orientated within a certain angle range relative to a reference direction while the flat metal particles are piled up; and rolling, from a reference direction, a group of the metal powder positioned.

### Effects of the Invention

Some aspects of the present invention provides a flat metal particle simultaneously having a texture and a flat shape.

### BRIEF DESCRIPTION OF THE DRAWINGS

FIG. 1 shows an electron micrograph of a cross section of a flat metal particle.

FIG. 2 shows an electron micrograph of iron particles before mechanochemical treatment of Example 1.

FIG. 3 shows an electron micrograph of flat iron particles after mechanochemical treatment of Example 1.

FIG. 4 shows an XRD chart of a pure iron particle before mechanochemical treatment of Example 1 and an XRD chart of a flat iron particle after the mechanochemical treatment of Example 1.

FIG. 5(a) shows a pole figure of a {110} plane of a pure iron particle before mechanochemical treatment according to Example 1.

FIG. 5(b) shows a pole figure of a {002} plane of a pure iron particle before mechanochemical treatment according to Example 1.

FIG. 6(a) shows a pole figure of a {110} plane of a flat iron particle after mechanochemical treatment according to Example 1.

FIG. 6(b) shows a pole figure of a {002} plane of a flat iron particle after mechanochemical treatment according to Example 1.

FIG. 7 shows an electron micrograph of flat metal particles according to Example 2.

FIG. 8 shows XRD charts of flat metal particles according to Example 2.

FIG. 9(a) shows a pole figure of a {110} plane of a flat metal particle according to Example 2.

FIG. 9(b) shows a pole figure of a {002} plane of a flat metal particle according to Example 2.

FIG. 10 illustrates a graph showing transition of the average particle diameter of a flat metal particle versus treatment time for mechanochemical treatment of Example 2.

FIG. 11 shows an electron micrograph of flat metal particles according to Example 3.

FIG. 12 shows XRD charts of flat metal particles according to Example 3.

FIG. 13(a) shows a pole figure of a {110} plane of a flat metal particle according to Example 3.

FIG. 13(b) shows a pole figure of a {002} plane of a flat metal particle according to Example 3.

FIG. 14 illustrates a graph showing transition of the average particle diameter of a flat metal particle versus treatment time for mechanochemical treatment of Example 3.

FIG. 15 shows an electron micrograph of flat metal particles according to Example 4.

FIG. 16 shows XRD charts of flat metal particles according to Example 4.

FIG. 17(a) shows a pole figure of a {110} plane of a flat metal particle according to Example 4.

FIG. 17(b) shows a pole figure of a {002} plane of a flat metal particle according to Example 4.

FIG. 18 illustrates a graph showing transition of the average particle diameter of a flat metal particle versus treatment time for mechanochemical treatment of Example 4.

FIG. 19 shows an electron micrograph of pure copper particles before mechanochemical treatment of Example 5.

FIG. 20 shows an electron micrograph of flat copper particles after mechanochemical treatment of Example 5.

FIG. 21(a) shows a pole figure of a {111} plane of a pure copper particle before mechanochemical treatment according to Example 5.

FIG. 21(b) shows a pole figure of a {002} plane of a pure copper particle before mechanochemical treatment according to Example 5.

FIG. 21(c) shows a pole figure of a {220} plane of a pure copper particle before mechanochemical treatment according to Example 5.

FIG. 22(a) shows a pole figure of a {111} plane of a flat copper particle after mechanochemical treatment according to Example 5.

FIG. 22(b) shows a pole figure of a {002} plane of a flat copper particle after mechanochemical treatment according to Example 5.

FIG. 22(c) shows a pole figure of a {220} plane of a flat copper particle after mechanochemical treatment according to Example 5.

FIG. 23 shows an XRD chart of a pure copper particle before mechanochemical treatment of Example 5 and an XRD chart of a flat copper particle after the mechanochemical treatment of Example 5.

FIG. 24 shows an electron micrograph of flat metal particles according to Example 6.

FIG. 25 shows XRD charts of flat metal particles according to Example 6.

FIG. 26(a) shows a pole figure of a {111} plane of a flat metal particle according to Example 6.

FIG. 26(b) shows a pole figure of a {002} plane of a flat metal particle according to Example 6.

FIG. 26(c) shows a pole figure of a {220} plane of a flat metal particle according to Example 6.

FIG. 27 illustrates a graph showing transition of the average particle diameter of a flat metal particle versus treatment time for mechanochemical treatment of Example 6.

FIG. 28 shows an electron micrograph of flat metal particles according to Example 7.

FIG. 29 shows XRD charts of flat metal particles according to Example 7.

FIG. 30(a) shows a pole figure of a {111} plane of a flat metal particle according to Example 7.

FIG. 30(b) shows a pole figure of a {002} plane of a flat metal particle according to Example 7.

FIG. 30(c) shows a pole figure of a {220} plane of a flat metal particle according to Example 7.

FIG. 31 illustrates a graph showing transition of the average particle diameter of a flat metal particle versus treatment time for mechanochemical treatment of Example 7.

FIG. 32 shows an electron micrograph of flat metal particles according to Example 8.

FIG. 33 shows XRD charts of flat metal particles according to Example 8.

FIG. 34(a) shows a pole figure of a {111} plane of a flat metal particle according to Example 8.

FIG. 34(b) shows a pole figure of a {002} plane of a flat metal particle according to Example 8.

FIG. 34(c) shows a pole figure of a {220} plane of a flat metal particle according to Example 8.

FIG. 35 illustrates a graph showing transition of the average particle diameter of a flat metal particle versus treatment time for mechanochemical treatment of Example 8.

FIG. 36 shows an electron micrograph of pure titanium particles before mechanochemical treatment of Example 9.

FIG. 37 shows an electron micrograph of flat titanium particles after mechanochemical treatment of Example 9.

FIG. 38 shows an XRD chart of a pure titanium particle before mechanochemical treatment of Example 9 and an XRD chart of a flat metal particle after the mechanochemical treatment of Example 9.

FIG. 39 shows an electron micrograph of flat metal particles according to Example 10.

FIG. 40 shows XRD charts of flat metal particles according to Example 10.

FIG. 41(a) shows a pole figure of a {0002} plane of a flat metal particle according to Example 10.

FIG. 41(b) shows a pole figure of a {10-11} plane of a flat metal particle according to Example 10.

FIG. 42 illustrates a graph showing transition of the average particle diameter of a flat metal particle versus treatment time for mechanochemical treatment of Example 10.

FIG. 43 shows an electron micrograph of flat metal particles according to Example 11.

FIG. 44 shows XRD charts of flat metal particles according to Example 11.

FIG. 45(a) shows a pole figure of a {0002} plane of a flat metal particle according to Example 11.

FIG. 45(b) shows a pole figure of a {10-11} plane of a flat metal particle according to Example 11.

FIG. 46 illustrates a graph showing transition of the average particle diameter of a flat metal particle versus treatment time for mechanochemical treatment of Example 11.

FIG. 47 shows an electron micrograph of flat metal particles according to Example 12.

FIG. 48 shows XRD charts of flat metal particles according to Example 12.

FIG. 49(a) shows a pole figure of a {110} plane of a flat metal particle according to Example 12.

FIG. 49(b) shows a pole figure of a {002} plane of a flat metal particle according to Example 12.

FIG. 50 illustrates a graph showing transition of the average particle diameter of a flat metal particle versus treatment time for mechanochemical treatment of Example 12.

FIG. 51 shows an electron micrograph of flat metal particles according to Example 13.

FIG. 52 shows XRD charts of flat metal particles according to Example 13.

FIG. 53(a) shows a pole figure of a {110} plane of a flat metal particle according to Example 13.

FIG. 53(b) shows a pole figure of a {002} plane of a flat metal particle according to Example 13.

FIG. 54 illustrates a graph showing transition of the average particle diameter of a flat metal particle versus treatment time for mechanochemical treatment of Example 13.

FIG. 55 shows an electron micrograph of flat metal particles according to Example 14.

FIG. 56 shows XRD charts of flat metal particles according to Example 14.

FIG. 57(a) shows a pole figure of a {111} plane of a flat metal particle according to Example 14.

FIG. 57(b) shows a pole figure of a {002} plane of a flat metal particle according to Example 14.

FIG. 57(c) shows a pole figure of a {220} plane of a flat metal particle according to Example 14.

FIG. 58 illustrates a graph showing transition of the average particle diameter of a flat metal particle versus treatment time for mechanochemical treatment of Example 14.

FIG. 59 shows an electron micrograph of flat metal particles according to Example 15.

FIG. 60 shows XRD charts of flat metal particles according to Example 15.

FIG. 61(a) shows a pole figure of a {111} plane of a flat metal particle according to Example 15.

FIG. 61(b) shows a pole figure of a {002} plane of a flat metal particle according to Example 15.

FIG. 61(c) shows a pole figure of a {220} plane of a flat metal particle according to Example 15.

FIG. 62 illustrates a graph showing transition of the average particle diameter of a flat metal particle versus treatment time for mechanochemical treatment of Example 15.

FIG. 63 shows treatment time-resolved XRD charts in the case where mechanochemical treatment of Example 16 is performed on a pure iron particle adding graphite.

FIG. 64 shows treatment time-resolved XRD charts in the case where mechanochemical treatment of Example 16 is performed on a pure iron particle without adding graphite.

FIG. 65(a) shows a pole figure of a {110} plane of a flat iron particle according to Example 16 in the case where mechanochemical treatment is performed adding graphite.

FIG. 65(b) shows a pole figure of a {002} plane of a flat iron particle according to Example 16 in the case where mechanochemical treatment is performed adding graphite.

FIG. 66(a) shows a pole figure of a {110} plane of a flat iron particle according to Example 16 in the case where mechanochemical treatment is performed without adding graphite.

FIG. 66(b) shows a pole figure of a {002} plane of a flat iron particle according to Example 16 in the case where mechanochemical treatment is performed without adding graphite.

FIG. 67 shows an electron micrograph of flat metal particles of Example 17 formed without adding graphite.

FIG. 68 shows XRD charts of flat metal particles of Example 17 formed without adding graphite.

FIG. 69(a) shows a pole figure of a {110} plane of a flat metal particle of Example 17 formed without adding graphite.

FIG. 69(b) shows a pole figure of a {002} plane of a flat metal particle of Example 17 formed without adding graphite.

FIG. 70 illustrates a graph showing transition of the average particle diameter of a flat metal particle versus treatment time for mechanochemical treatment of Example 17.

FIG. 71 shows an electron micrograph of flat metal particles of Example 18 formed adding 2 mg of graphite.

FIG. 72 shows XRD charts of flat metal particles of Example 18 formed adding 2 mg of graphite.

FIG. 73(a) shows a pole figure of a {110} plane of a flat metal particle of Example 18 formed adding 2 mg of graphite.

FIG. 73(b) shows a pole figure of a {002} plane of a flat metal particle of Example 18 formed adding 2 mg of graphite.

FIG. 74 illustrates a graph showing transition of the average particle diameter of a flat metal particle versus treatment time for mechanochemical treatment of Example 18.

FIG. 75 shows an electron micrograph of flat metal particles of Example 19 formed adding 140 mg of graphite.

FIG. 76 shows XRD charts of flat metal particles of Example 19 formed adding 140 mg of graphite.

FIG. 77(a) shows a pole figure of a {110} plane of a flat metal particle of Example 19 formed adding 140 mg of graphite.

FIG. 77(b) shows a pole figure of a {002} plane of a flat metal particle of Example 19 formed adding 140 mg of graphite.

FIG. 78 illustrates a graph showing transition of the average particle diameter of a flat metal particle versus treatment time for mechanochemical treatment of Example 19.

FIG. 79 shows an electron micrograph of flat metal particles of Example 20 formed adding carbon fiber.

FIG. 80 shows XRD charts of flat metal particles of Example 20 formed adding carbon fiber.

FIG. 81(a) shows a pole figure of a {110} plane of a flat metal particle of Example 20 formed adding carbon fiber.

FIG. 81(b) shows a pole figure of a {002} plane of a flat metal particle of Example 20 formed adding carbon fiber.

FIG. 82 illustrates a graph showing transition of the average particle diameter of a flat metal particle versus treatment time for mechanochemical treatment of Example 20.

FIG. 83 shows an electron micrograph of flat metal particles of Example 21 formed adding PTFE.

FIG. 84 shows XRD charts of flat metal particles of Example 21 formed adding PTFE.

FIG. 85(a) shows a pole figure of a {110} plane of a flat metal particle of Example 21 formed adding PTFE.

FIG. 85(b) shows a pole figure of a {002} plane of a flat metal particle of Example 21 formed adding PTFE.

FIG. 86 illustrates a graph showing transition of the average particle diameter of a flat metal particle versus treatment time for mechanochemical treatment of Example 21.

FIG. 87 shows an electron micrograph of flat metal particles of Example 22 formed adding mineral oil.

FIG. 88 shows XRD charts of flat metal particles of Example 22 formed adding mineral oil.

FIG. 89(a) shows a pole figure of a {110} plane of a flat metal particle of Example 22 formed adding mineral oil.

FIG. 89(b) shows a pole figure of a {002} plane of a flat metal particle of Example 22 formed adding mineral oil.

FIG. 90 illustrates a graph showing transition of the average particle diameter of a flat metal particle versus treatment time for mechanochemical treatment of Example 22.

FIG. 91 shows an electron micrograph of flat metal particles of Example 23 formed adding MoS₂.

FIG. 92 shows XRD charts of flat metal particles of Example 23 formed adding MoS₂.

FIG. 93(a) shows a pole figure of a {110} plane of a flat metal particle of Example 23 formed adding MoS₂.

FIG. 93(b) shows a pole figure of a {002} plane of a flat metal particle of Example 23 formed adding MoS₂.

FIG. 94 illustrates a graph showing transition of the average particle diameter of a flat metal particle versus treatment time for mechanochemical treatment of Example 23.

FIG. 95 shows an XRD chart of a flat iron particle of Example 24-1 formed in oxygen atmosphere and an XRD chart of a flat iron particle of Example 24-2 formed under argon atmosphere.

FIG. 96 shows an electron micrograph of flat metal particles of Example 25 formed in oxygen atmosphere.

FIG. 97 shows XRD charts of flat metal particles of Example 25 formed in oxygen atmosphere.

FIG. 98(a) shows a pole figure of a {110} plane of a flat metal particle of Example 25 formed in oxygen atmosphere.

FIG. 98(b) shows a pole figure of a {002} plane of a flat metal particle of Example 25 formed in oxygen atmosphere.

FIG. 99 illustrates a graph showing transition of the average particle diameter of a flat metal particle versus treatment time of mechanochemical treatment of Example 25.

FIG. 100 shows an electron micrograph of flat metal particles of Example 26 formed in nitrogen atmosphere.

FIG. 101 shows XRD charts of flat metal particles of Example 26 formed in nitrogen atmosphere.

FIG. 102(a) shows a pole figure of a {110} plane of a flat metal particle of Example 26 formed in nitrogen atmosphere.

FIG. 102(b) shows a pole figure of a {002} plane of a flat metal particle of Example 26 formed in nitrogen atmosphere.

FIG. 103 illustrates a graph showing transition of the average particle diameter of a flat metal particle versus treatment time of mechanochemical treatment of Example 26.

FIG. 104 shows an electron micrograph of flat metal particles of Example 27 formed in argon atmosphere.

FIG. 105 shows XRD charts of flat metal particles of Example 27 formed in argon atmosphere.

FIG. 106(a) shows a pole figure of a {110} plane of a flat metal particle of Example 27 formed in argon atmosphere.

FIG. 106(b) shows a pole figure of a {002} plane of a flat metal particle of Example 27 formed in argon atmosphere.

FIG. 107 illustrates a graph showing transition of the average particle diameter of a flat metal particle versus treatment time of mechanochemical treatment of Example 27.

FIG. 108 shows a schematic diagram illustrating a method for measuring powder X-ray diffraction for a flat metal particle.

### MODES FOR CARRYING OUT THE INVENTION

Hereinafter, a flat metal particle according to an embodiment will be described.

The flat metal particle according to the present embodiment has a texture. Metal members having a texture are known. For example, a rolled metal plate is known as a metal material having a texture. The present inventors have now conducted further diligent studies and found that a flat iron particle having a texture can be obtained through a rolling treatment. Further, the present inventors have found that the orientation property in the texture is weak by only performing the rolling treatment on a metal particle. That is, it is considered that the force of rolling the metal particle does not act or is hard to act as the force to rearrange crystals in the metal particle. In such a situation, the present inventors have conducted further diligent studies and have developed a method of manufacturing a flat iron particle having a texture in which the orientation property is strong. Further, the present inventors have found that the manufacturing method and a method improved therefrom are also effective for other metals. Hereinafter, a structure of a flat metal particle thus obtained, a method of manufacturing a flat metal particle, and a method of manufacturing a metal plate as an application example of the flat metal particle will be described.

[Flat Metal Particle]

The composition of the flat metal particle having the texture is not particularly limited. For example, a metal that constitutes the flat metal particle may be any of a metal having a body-centered cubic lattice structure (referred to as “bcc structure”) or a face-centered cubic lattice structure (hereinafter, referred to as “fcc structure”) and a metal having a hexagonal close-packed structure (hereinafter, referred to as “hcp structure”). Examples of the metal of the bcc structure suitable as the composition of the flat metal particle include iron, vanadium, chromium, niobium, tantalum, and tungsten. In addition, an alloy of the bcc structure that can be the composition of the flat metal particle is an alloy containing at least one of Fe, V, Cr, Nb, Ta, and W. Examples of the alloy having the bcc structure include an iron-cobalt alloy, an iron-cobalt-vanadium alloy, an iron-vanadium alloy, a chromium-iron alloy, iron carbide, and ferrosilicon. Examples of the metal of the fcc structure suitable as the composition of the flat metal particle include aluminum, copper, nickel, lead, silver, platinum, gold, and palladium. In addition, an alloy of the fcc structure that can be the composition of the flat metal particle is an alloy containing at least one of Al, Ni, Cu, Pb, Ag, Pt, Au, and Pd. Examples of the alloy having the fcc structure include an iron-nickel alloy, a nickel-cobalt alloy, and an aluminum-magnesium alloy. Examples of the metal of the hcp structure suitable as the composition of the flat metal particle include titanium, cobalt, zinc, and zirconium. An alloy of the hcp structure that can be the composition of the flat metal particle is an alloy containing at least one of Ti, Co, Zn, and Zr.

When the flat iron particle having the texture is used in an iron core in a transformer, an electrical motor, and a generator, and a filler for a magnetic shield, the loss of the iron core can be reduced, and the magnetic shield performance can be improved.

For example, the flat iron particle including the texture in which the {001} plane and the flat surface are in parallel with each other has a higher magnetic permeability in a direction in parallel with the flat surface than a flat iron particle that lacks the texture and therefore is useful as a material with which hysteresis loss can be reduced. Since the flat iron particle has a flat structure, it is easy to make material powders which are made of the flat iron particle face the same direction when the iron core is molded. The flat iron particle can be arranged so that the flat surfaces of individual flat iron particles can face the same direction, for example, by putting the material powders made of the flat iron particle into a container and then vibrating the container. A molded article formed from the flat iron particle thus arranged can be used usefully as a member having magnetic directionality. In addition, the volume per one flat iron particle is smaller than the volume per one electromagnetic steel plate used in an iron core in an electrical motor and the like, and therefore an eddy current can be reduced. For example, an iron powder made of the flat iron particle having an insulating film can be a material for an iron core in an electrical motor and the like. In this way, the flat iron particle having the texture is useful as a magnetic material that has never existed in the past.

A metal other than the iron particle has applications as follows.

For example, when the flat metal particle having the texture is combined with the powder rolling method, a metal plate having the texture can be obtained. Such a metal plate having the texture makes it easy to perform plasticity processing including bend processing. Accordingly, a metal plate excellent in processability can be obtained.

Hereinafter, the constitution of the flat metal particle will be described.

The flat metal particle has the flat surface. The flat surface refers to a surface that is orthogonal to a thickness direction in a flattened particle. It is preferable that the flat surface be even. Moreover, the flat surface may be a curved surface. Such a flat surface is a formed through a mechanochemical treatment of a metal particle. That is, the flat surface is a surface obtained by rolling a metal particle or by rolling a metal particle while sliding the metal particle with a mold for rolling the metal particle. It is preferable that the average particle diameter of the flat metal particle observed from a direction perpendicular to the flat surface be 0.2 μm or greater and 2000 μm or less. It is to be noted that the particle diameter refers to a diameter of a circle inscribed in an outer edge of the flat surface. The average particle diameter means a median diameter (D50) of particle diameters.

It is preferable that the flat metal particle have a thickness (length of width of flat metal particle in direction orthogonal to flat surface) of 0.05 μm or more and 100 μm or less, further preferably 0.5 μm or more and 20 μm or less. The reason is that when the flat metal particle has a thickness smaller than 0.05 μm, the time required for manufacturing the flat metal particle becomes long, and when the flat metal particle has a thickness larger than 100 μm, the volume per one flat metal particle becomes too large, so that the packing ratio of the flat metal particle into a molding die is lowered when a molded article is made by packing the flat metal particle into the molding die.

Moreover, it is preferable that the flat metal particle have an aspect ratio d/t of 2 or more, where d represents the particle diameter of the flat metal particle, and t represents the thickness of the flat metal particle. The upper limit of the aspect ratio d/t of the flat metal particle is not particularly limited and can be 10000 or less.

When the aspect ratio d/t is 2 or more, the flat metal particle having the texture can contribute to an improvement in the functionality of the metal material. For example, an iron core constituted from the flat metal particle having the texture exhibits an effect of reducing the hysteresis loss due to the texture and flattening of the particle. Therefore, an electric motor or generator provided with such an iron core can be an electric motor or generator having efficiency that is higher than those with a conventional iron core using an electromagnetic steel plate or a conventional iron core manufactured by performing compression molding on a powder.

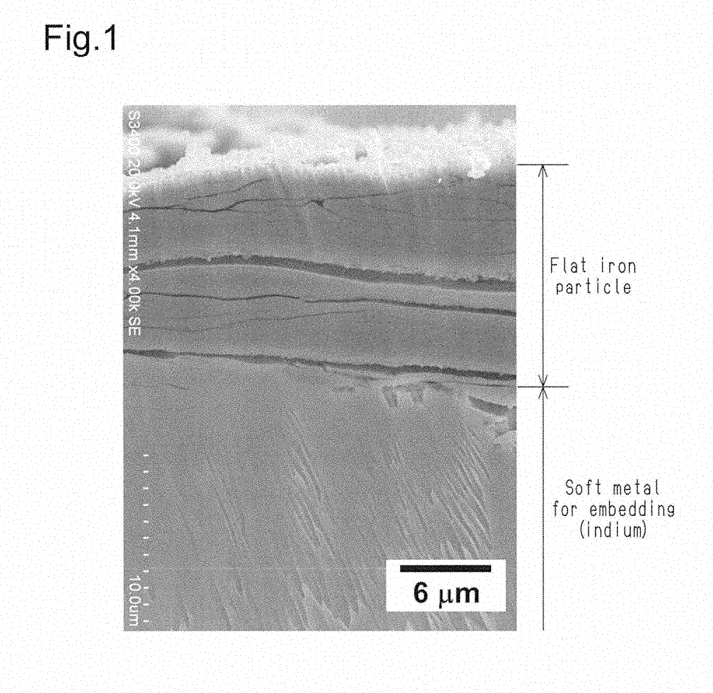

The flat metal particle may have a layered structure as shown in FIG. 1. Each layer is along the flat surface of the flat metal particle. It is considered that each layer is configured through rolling of the metal particle which is a raw material for the flat metal particle. That is, the flat metal particle is a laminated body of rolled metal particle.

The flat iron particle having the layered structure will be described with reference to FIG. 1. The electron micrograph shown in FIG. 1 is obtained in the following manner. That is, the micrograph is obtained in such a way that the flat iron particle is positioned on a soft metal plate for embedding (specifically, indium plate) so that the flat surface of the flat iron particle can be in contact with a surface of the soft metal plate for embedding, the flat metal particle is then cut with an ion beam, and the cut surface is photographed with an electron microscope. The flat iron particle is a particle obtained by performing the mechanochemical treatment on a pure iron particle in the same manner as in Example 1. It is to be noted that the flat iron particle has a thickness of about 10 μm, and each layer has a thickness of 1 g to 3 μm as understood from FIG. 1.

The crystal arrangement structure of the flat metal particle will be described.

The flat metal particle has the texture. That is, in the flat metal particle, metal crystals are not randomly orientated, but crystal planes of at least part of crystals face in the same direction.

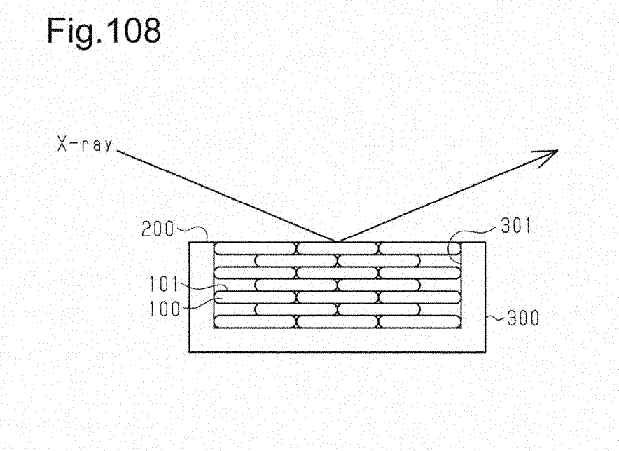

Accordingly, a pole figure obtained by X-ray diffraction in which the flat surface of the flat metal particle is used as a measurement surface (see FIG. 108), and the measurement surface is irradiated with an X-ray has a polar or belt-like intensity distribution. The polar intensity distribution is a distribution in which the orientation strength of the central part in the pole figure is high, the orientation strength of the periphery of the central part is low, and the orientation strength in a direction along the circumference of a circle (hereinafter, referred to as “circumferential direction”) is uniform (no changes). The belt-like intensity distribution is a distribution in which the orientation strength is high in a given range away from the center of the pole figure to radial directions at a given distance, and the orientation strength is uniform (no changes) in the circumferential direction. That is, the polar or belt-like intensity distribution is a distribution in which there are changes in the orientation strength in radial directions of the pole figure. The polar or belt-like intensity distribution is different from an intensity distribution in which the orientation strength is uniform in radial directions, the intensity distribution obtained from the metal particle in which crystals are randomly orientated. The polar or belt-like intensity distribution indicates that the crystal is orientated in a given direction. ND (normal direction) in the pole figures shown in the present examples corresponds to a direction orthogonal to the flat surface of the flat metal particle.

In addition, the flat metal particle having the texture exhibits a powder X-ray diffraction chart (hereinafter, referred to as “XRD chart”) the shape of which is different from that of the metal particle that lacks the texture. It will be apparent to those skilled in the bicycle field from the present disclosure that the XRD chart is a chart obtained when the measurement is conducted using the flat surface of the flat metal particle as the measurement surface (see FIG. 108).

The XRD chart of the flat metal particle will be described.

Hereinafter, the intensity of a diffraction peak of a given crystal plane is defined as the height of the peak from the base line of the chart. In addition, the sum of the diffraction peaks, which will be described later, is the sum of the heights of the peaks. The intensity ratio of a diffraction peak of a given crystal plane is specified as a ratio of the intensity of the diffraction peak of the given crystal plane to the summation of the intensities of the diffraction peaks of the given number of crystal planes from the low angle side in the XRD chart, where the summation is set to be 100%. Specifically, the intensity ratio of a diffraction peak of a given crystal plane in the flat metal particle of the bcc structure or the fcc structure is specified as “(intensity ratio of diffraction peak of given crystal plane)=(intensity of diffraction peak corresponding to given crystal plane)/(summation of intensities of 5 diffraction peaks from low angle side)×100” in the present embodiment. The intensity ratio of a diffraction peak of a given crystal plane in the flat metal particle of the hcp structure is specified as “(intensity ratio of diffraction peak of given crystal plane)=(intensity of diffraction peak corresponding to given crystal plane)/(summation of intensities of 3 diffraction peaks from low angle side)×100”.

The flat metal particle having the texture and the bcc structure (or fcc structure) will be described.

In the XRD chart of the flat metal particle having the texture and the bcc structure (or fcc structure), when the summation of the intensities of diffraction peaks of successive 5 crystal planes from the low angle side is set to be 100%, the intensity ratio of at least one diffraction peak of the diffraction peaks of the 5 crystal planes from the low angle side is higher by 10% or more than the intensity ratio of the diffraction peak of the metal particle that lacks the texture. That is, since the flat metal particle having the texture exhibits an XRD chart that is different from an XRD chart of the metal particle that lacks the texture (namely, metal particle on which mechanochemical treatment is not performed), it is understood that the flat metal particle according to the powder X-ray diffraction has the texture by comparing the charts.

In addition, in the flat metal particle in which the crystal structure is the bcc structure (or fcc structure) and which has a moiety having the texture and a moiety that lacks the texture, it is preferable the XRD chart have the following constitution.

It is preferable that in the XRD chart of the above-described flat metal particle, when the total intensity of the diffraction peaks of the 5 crystal planes from the low angle side is set to be 100%, at least one of intensity ratios of the diffraction peaks of the 5 crystal planes from the low angle side at the moiety having the texture be increased 10% or more or decreased 10% or more than that at the moiety that lacks the texture. Such constitution is the evidence that the flat metal particle has the texture. The increase of 10% or more or decrease of 10% or more in at least one of the intensity ratios of the diffraction peaks of the 5 crystal planes from the low angle side indicates that the texture is remarkable.

The flat metal particle having the texture and the hcp structure will be described.

In the XRD chart of the flat metal particle having the texture and the hcp structure, when the summation of the intensities of diffraction peaks of 3 crystal planes from the low angle side is set to be 100%, the intensity ratio of at least one diffraction peak of the diffraction peaks of the 3 crystal planes from the low angle side is higher by 10% or more than the intensity ratio of the diffraction peak in the metal particle that lacks the texture.

In addition, in the flat metal particle in which the crystal structure is the hcp structure and which has a moiety having the texture and a moiety that lacks the texture, it is preferable the XRD chart have the following constitution.

It is preferable that in the XRD chart of the above-described flat metal particle, when the total intensity of the diffraction peaks of the 3 crystal planes from the low angle side is set to be 100%, at least one of intensity ratios of the diffraction peaks of the 3 crystal planes from the low angle side at the moiety having the texture be increased 10% or more or decreased 10% or more than that at the moiety that lacks the texture. Such constitution is the evidence that the flat metal particle has the texture. The increase of 10% or more or decrease of 10% or more in at least one of intensity ratios of the diffraction peaks of the 3 crystal planes from the low angle side indicates that the texture is remarkable.

The action of the flat metal particle will be described. The flat metal particle has the texture and a flat shape. The crystal orientation of each of the metal particles faces in a given direction relative to the flat surface without exception. Accordingly, when each of the flat metal particles is arranged so that the flat surface thereof faces the same direction, a block constituted by a plurality of the flat metal particles has directionality in terms of the crystal structure.

The effects due to the flat metal particle will be described.

The flat metal particle has the mechanochemical treated texture. That is, the flat metal particle has the flat surface and has directionality in the crystal orientation. The pole figure, obtained by powder X-ray diffractometry, of a crystal plane of the flat metal particle exhibits a polar or belt-like intensity distribution. Such a flat metal particle having the mechanochemical treated texture contributes to the improvement in the functionality of the metal material.

Such a flat metal particle can be constituted as the flat metal particle having a plurality of layers along the flat surface. Moreover, it is preferable that the flat metal particle have a thickness of 0.05 μm or more and 100 μm or less. Furthermore, it is preferable that the flat metal particle have an aspect ratio d/t of 2 or more. The reason is that when a powder made of the flat metal particle is used as a material, it is easy to orientate each of the flat metal particles. The respective flat metal particles, when positioned so that the flat surfaces thereof are made to face the same direction, have a structural directionality as a whole. For example, in an iron-containing flat metal particle, the block of the flat metal particles the flat surfaces of which are made to face the same direction has a magnetic directionality and can be used suitably as an iron core.

It is preferable that in the flat metal particle having the bcc structure, when the total intensity of the diffraction peaks of the 5 crystal planes from the low angle side in the XRD chart of the flat metal particle is set to be 100%, the intensity ratio of at least one diffraction peak of the diffraction peaks of the 5 crystal planes from the low angle side be higher by 10% or more than the intensity ratio of the diffraction peak of the metal particle that lacks the texture.

Alternatively, it is preferable that in the flat metal particle having the bcc structure, when the total intensity of diffraction peaks at {110}, {002}, {211}, {220}, and {310} in the XRD chart is set to be 100%, the intensity ratio of the diffraction peak at {002} be 20% or more, and the intensity ratio of the diffraction peak at {002} be further preferably 40% or more.

It is preferable that in the flat metal particle having the fcc structure, when the total intensity of the diffraction peaks of the 5 crystal planes from the low angle side in the XRD chart of the flat metal particle is set to be 100%, the intensity ratio of at least one diffraction peak of diffraction peaks of the 5 crystal planes from the low angle side be higher by 10% or more than the intensity ratio of the diffraction peak of the metal particle that lacks the texture.

Alternatively, it is preferable that in the flat metal particle having the fcc structure, when the total intensity of diffraction peaks at {111}, {002}, {220}, {311}, and {222} is set to be 100%, the intensity ratio of the diffraction peak at {220} be 10% or more.

For example, it is preferable that in the flat metal particle having the hcp structure, when the total intensity of the diffraction peaks of the 3 crystal planes from the low angle side in the XRD chart of the flat metal particle is set to be 100%, the intensity ratio of at least one diffraction peak of the diffraction peaks of the 3 crystal planes from the low angle side be higher by 10% or more than the intensity ratio of the diffraction peak of the metal particle that lacks the texture.

It is preferable that in the flat metal particle having the hcp structure, when the total intensity of diffraction peaks at {10-01}, {0002}, and {10-11} in the XRD chart is set to be 100%, the intensity ratio of the diffraction peak at {0002} be 20% or more.

[Method for Manufacturing Flat Metal Particle]

Next, the manufacturing method will be described.

The flat metal particle having the texture is obtained through the mechanochemical treatment (which will be described later).

The metal particle on which the mechanochemical treatment is to be performed is not limited as described above but is preferably a metal particle that is easily flattened. It is preferable that the metal particle on which the mechanochemical treatment is to be performed have an average particle diameter of 0.1 μm or greater and 1000 μm or less, more preferably 1 μm or greater and 500 μm or less.

In the method of manufacturing the flat metal particle in the present embodiment, the metal particle that is a raw material is charged into a mechanochemical treatment container so that the amount of the metal particle will be 0.001 or more and 0.99 or less in terms of a volume ratio based on an inner volume of the mechanochemical treatment container of 1, and then the mechanochemical treatment is performed. In the case where a spherical medium such as a ball is used with the mechanochemical treatment container, the total amount of the metal particle and the spherical medium is adjusted to be 0.001 or more and 0.99 or less in terms of the volume ratio. Thereby, the flat metal particle having the texture is obtained.

It is preferable that the treatment time for the mechanochemical treatment be limited. The reason is that, as will be described later, when the treatment time for the mechanochemical treatment is too long, the aspect ratio becomes too small or alloying occurs. The treatment time for the mechanochemical treatment can be set appropriately according to the apparatus for the mechanical treatment (for example, a ball mill apparatus) and the conditions thereof (size and mass of ball, number of revolutions of container).

It is preferable that the atmosphere in the mechanochemical treatment container be a gas atmosphere of non-rare gas. Particularly, it is preferable that the atmosphere in the mechanochemical treatment container be an oxygen atmosphere, a nitrogen atmosphere, or a mixed gas atmosphere of oxygen and nitrogen (for example, air atmosphere). For example, when the mechanochemical treatment is performed on a given metal, such as, for example, pure iron and pure copper, in an atmosphere containing oxygen, the flat metal particle having the texture in which the orientation property is strong can be obtained. In addition, as for the pure iron, when the mechanochemical treatment is performed on the pure iron particle in the nitrogen atmosphere, the flat metal particle having the texture in which the orientation property is strong can be obtained. On the other hand, even when the mechanochemical treatment is performed on the pure iron particle using a texturization aid under argon atmosphere, it is difficult to obtain the flat metal particle having a strong orientation property (see Examples 24 to 27). To sum up, it is preferable not only to add the texturization aid but also to perform the mechanochemical treatment under the atmosphere containing oxygen or nitrogen for facilitating texturization of the metal particle in the mechanochemical treatment.

It is preferable that the metal particle be processed so that the flat metal particle will have an aspect ratio d/t of 2 or more in the mechanochemical treatment. The aspect ratio d/t is preferably 2 or more and 10000 or less, further preferably 4 or more and 1000 or less.

In addition, it is preferable to use the texturization aid in the mechanochemical treatment.

The texturization aid facilitates the texturization of the metal particle through the mechanochemical treatment. It is preferable that the texturization aid be a substance that lowers the friction coefficient between the metal particle on which the mechanochemical treatment is to be performed and a material body with which the mechanochemical treatment is to be performed (for example, steel ball in Examples, which will be described later). As one example, a lubricant is used as the texturization aid. The lubricant used as the texturization aid may be solid or liquid (fluid). As the solid lubricant, carbon compounds are suitably used. Examples of the solid lubricant include graphite (represented by “Gp” in Drawings), graphite fluoride, polytetrafluoroethylene (hereinafter, “PTFE”), and carbon fibers. In addition, examples of non-carbon solid lubricants include molybdenum disulfide. Examples of the liquid lubricant include fatty acid esters, and mineral oils (liquid substances derived from petroleum). A plurality of these lubricants are combined and used as the texturization aid.

When such a texturization aid is used, the flat metal particle having the texture in which the orientation property is strong can be obtained. Particularly, with respect to the metal particle of the bcc structure and the metal particle of the fcc structure, when the mechanochemical treatment is performed using the texturization aid, it is easier to obtain the flat metal particle having the texture than in the case where the texturization aid is not used. On the other hand, with respect to the metal particle of the hcp structure, the flat metal particle having the texture can be obtained through the mechanochemical treatment irrespective of whether the texturization aid exists or not. That is, to orientate the crystals inside the metal particle in the metal particle of the bcc structure and the metal particle of the fcc structure, it is preferable to perform the mechanochemical treatment using the texturization aid. On the other hand, to orientate the crystals inside the metal particle in the metal particle of the hcp structure, it is sufficient to perform the mechanochemical treatment, and the texturization aid can be used as necessary.

In the case where the mechanochemical treatment is performed using the texturization aid, the metal particle and the texturization aid are charged into the mechanochemical treatment container so that the total amount of the metal particle and the texturization aid will be 0.99 or less in terms of the volume ratio based on the inner volume of the mechanochemical treatment container of 1. In the case where the spherical medium is used in the mechanochemical treatment, the metal particle and the spherical medium are charged into the mechanochemical treatment container so that the total amount of the metal particle, the texturization aid, and the spherical medium will be 0.99 or less in terms of the volume ratio based on the inner volume of the mechanochemical treatment container of 1.

The mechanochemical treatment is a treatment method in which mechanical and/or chemical interactions between materials are induced and the particle shape is deformed by applying mechanical energy such as compressive force and frictional force to a material in a particle form. Specific means of the mechanochemical treatment is not particularly limited, and a mill and a mechanical pulverizing apparatus intended for a powder can be used. Specific examples of the apparatus for performing the mechanochemical treatment include a bead mill, a planetary type, a rolling motion type, or a vibration type ball mill, a rocking mill, a tower mill, mechano-fusion, a jet mill, a hybridizer, a Henschel mixer, and a homomixer.

With respect to the mechanochemical treatment container (hereinafter, also written as “treatment container”), such as a mill, which is used in the mechanochemical treatment, the material is not particularly limited but is preferably made of a metal or a metal oxide. The reason is that when the mechanochemical treatment container is made of a material as described above, a sufficient mechanical energy can be given to the metal particle in performing the mechanochemical treatment.

In the case where an apparatus, such as Attritor (NIPPON COKE & ENGINEERING COMPANY, LIMITED, trade name), which does not use the spherical medium is selected as the above-described apparatus for performing the mechanochemical treatment, there is no need to mix the spherical medium and the amount of the spherical medium to be introduced can be 0.

In the case where an apparatus which uses the spherical medium is selected, the material of the spherical medium is not limited and can be selected according to the size and material of the treatment container. In the case where the spherical medium made of a metal or a metal oxide is used, a sufficient mechanical energy can be given to a powder material in performing the mechanochemical treatment.

With respect to the amount of the spherical medium to be introduced, it is preferable to charge the spherical medium into the treatment container so that the volume ratio will be more than 0 and 0.99 or less, and particularly preferably the spherical medium is charged into the treatment container so that the volume ratio will be more than 0 and 0.5 or less based on the inner volume of the mechanochemical treatment container of 1.

This is because when the amount of the spherical medium to be charged is in such a range, a sufficient mechanical energy can be applied to the metal particle in performing the mechanochemical treatment. The inner volume of the mechanochemical treatment container as referred to herein means the volume of the portion into which a sample such as the metal particle and the spherical medium are charged. In addition, the size of the spherical medium to be used in the mechanochemical treatment is not particularly limited and can be selected according to the size and the like of the treatment container.

Hereinafter, the effects due to the method of manufacturing the flat metal particle will be described.

The method of manufacturing the flat metal particle includes a step of performing a mechanochemical treatment on a metal powder containing the metal particles having an average particle diameter of 0.1 μm or greater and 1000 μm or less. The mechanochemical treatment includes at least one of (a) a treatment of deforming and flattening the metal particles, (b) a treatment of laminating the metal particle which are flattened, and (c) a treatment of shaping a lump of a plurality of metal particles into a flat shape. That is, when the metal particle is rolled through any one the treatments (a) to (c), the flat metal particle having the texture is obtained. To allow the flat metal particle to have the texture, it is preferable that the treatment time for the mechanochemical treatment be specified in a given time as will be shown in each Example. The reason is that when the treatment time is too long, the aspect ratio of the flat metal particle becomes too small or alloying progresses in the flat metal particle. The treatment time for the mechanochemical treatment can be specified based on changes in the XRD chart.

In addition, the rolling is performed so that the aspect ratio d/t of the flat metal particle will be 2 or more in the method of manufacturing the flat metal particle. Thereby, it becomes easier to make the flat surfaces of the flat metal particles face the same direction when compared with the case of the aspect ratio d/t of the flat metal particle having an aspect ratio of less than 2.

In addition, it is preferable that the mechanochemical treatment be performed under an atmosphere of a gas containing at least one of oxygen and nitrogen. The reason is that the texturization of the metal particle is facilitated by oxygen, nitrogen, or a mixed gas thereof (for example, air). Moreover, it is preferable that the texturization aid be used in the mechanochemical treatment. The reason is that the texturization of the metal particle is facilitated by the mechanochemical treatment using the texturization aid. It is preferable that the texturization aid be at least one selected from the group consisting of various carbon compounds and molybdenum disulfide. A liquid carbon compound (for example, mineral oil) may be used as the texturization aid. In this case, it is preferable that the texturization aid be removed from the flat metal particle by dissolving the texturization aid adhered to the flat metal particle with a solvent after the mechanochemical treatment.

In addition, in the method of manufacturing the flat metal particle, the metal particle is charged into the mechanochemical treatment container so that the volume will be 0.001 or more and 0.99 or less based on the inner volume of the mechanochemical treatment container of 1, and then the mechanochemical treatment is performed. Thereby, the flat metal particle having the texture is obtained.

Moreover, the manufacturing method may be performed in such a way that the metal particle including the texturization aid is charged into the mechanochemical treatment container in the mechanochemical treatment so that the total amount (volume) of the metal particle and the texturization aid will be a volume of 0.99 or less of the inner volume of the mechanochemical treatment container.

[Method for Manufacturing Metal Plate]

The method of manufacturing the metal plate having the texture will be described.

The metal plate having the texture is obtained, for example, from an ingot via hot rolling, cold rolling, and a thermal treatment; however, the metal plate having the texture can be manufactured using the flat metal particle having the texture in place of such a conventional manufacturing method. That is, the above-described flat metal particle having the texture can be a raw material for the metal plate having the texture. For example, the flat particles having the texture are positioned so that the flat surfaces face the same direction (direction within a given angle range relative to reference direction), and the flat metal particles are piled up (positioning step) as described and shown above. The metal plate having the texture can be obtained by treating the positioned flat particle by the powder rolling method (rolling step). This manufacturing method is excellent in that it does not include a heat treatment. It will be apparent to those skilled in the bicycle field from the present disclosure that the metal plate obtained can be heat-treated appropriately according to the application.

### EXAMPLES

The apparatuses and measurement conditions used in Examples shown below will be described.

As an electron microscope for obtaining an electron micrograph, type JCM-6000/manufactured by JEOL Ltd. was used. A secondary electron image was obtained setting the acceleration voltage at 15 kV, the probe current at a standard value, the filament luminance at a standard value, and the mode as a high vacuum mode.

As an X-ray diffraction apparatus for obtaining an XRD chart, type Smartlab/manufactured by Rigaku Corporation was used. Measurement was conducted by a focusing method using Cu as an X-ray source, and setting the tube voltage at 40 kV and the tube current at 30 mA. On the X-ray source side, the Soller slit was set at 5.0 deg, and the longitudinal width of the incidence slit (IS) was set at 10.0 mm. On the detector side, the Soller slit was set at 5.0 deg, the incidence slit was set at ½ deg, the width of the first slit on the light-receiving side (RS1) was set at 20.0 mm, and the width of the second slit on the light-receiving side (RS2) was set at 20.0 mm. In addition, the measurement was conducted setting the attenuator as open (not used) and the speed counting time at 5 deg/min, and inserting a Kβ filter.

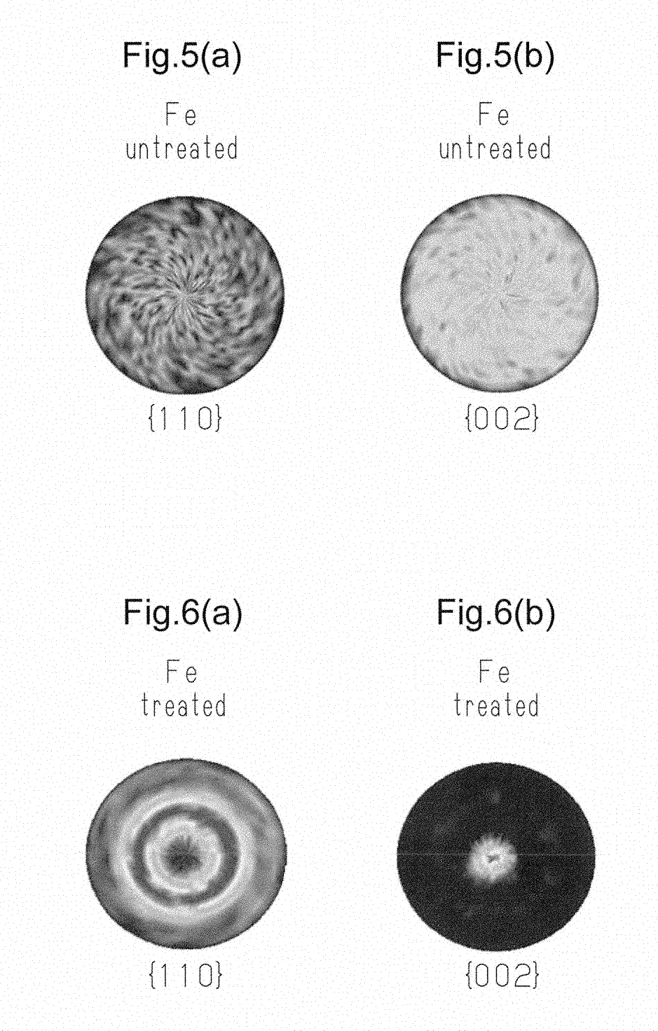

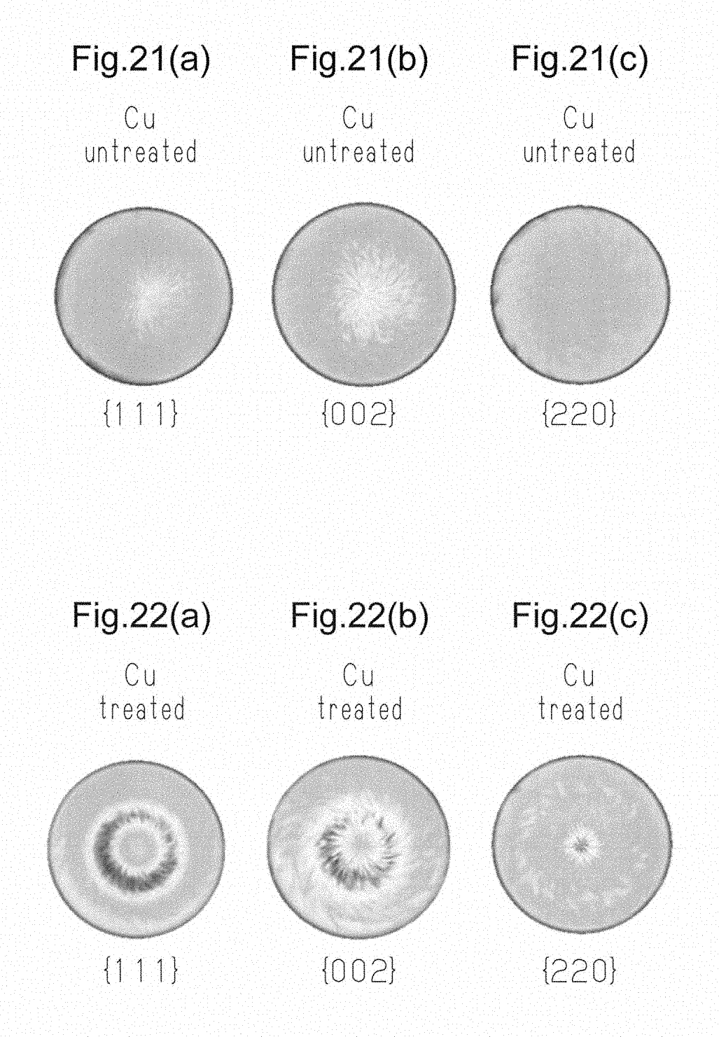

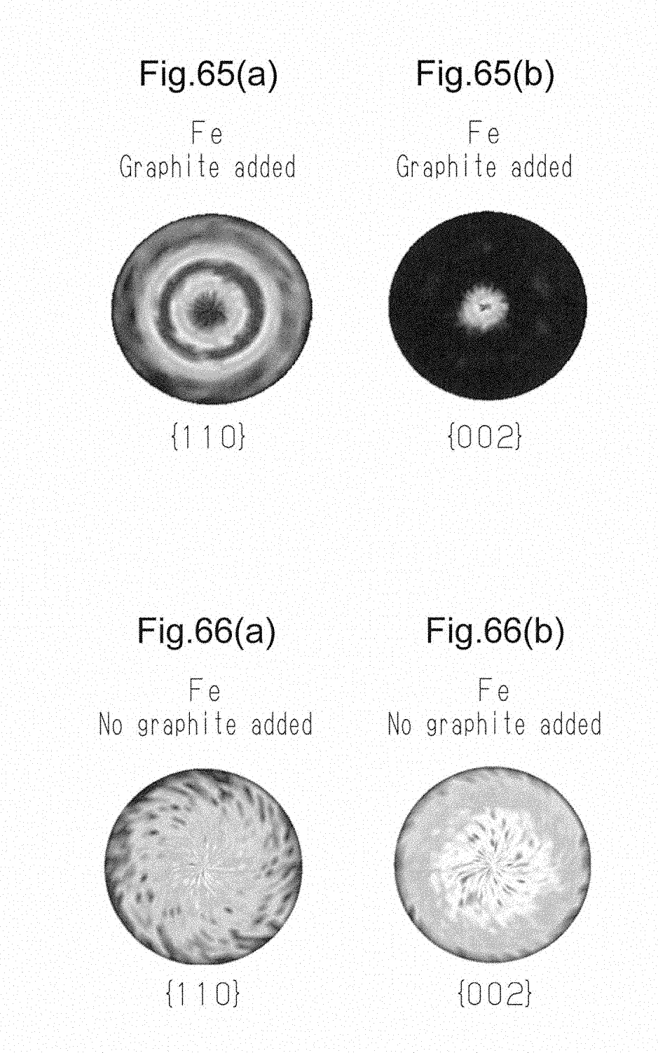

As an X-ray diffraction apparatus for obtaining a pole figure, type Smartlab/manufactured by Rigaku Corporation was used. Measurement was conducted by an in-plane pole measuring method using Cu as an X-ray source, and setting the tube voltage at 40 kV and the tube current at 30 mA. On the X-ray source side, the Soller slit was set at 0.5 deg, and the longitudinal width of the incidence slit (IS) was set at 10.0 mm. On the detector side, the Soller slit was set at 0.5 deg, the incidence slit (IS) was set at 1.0 mm, the width of the first slit on the light-receiving side (RS1) was set at 2.0 mm, and the width of the second slit on the light-receiving side (RS2) was set at 2.0 mm. The attenuator was set as open (not used), and the speed counting time was set at 50 deg/min. The measurement range was made different according to Examples. The measurement range is defined by a scanning range for an angle to an axis perpendicular to a measurement surface (hereinafter, referred to as “α angle”) and a scanning range for an angle in a direction of rotation around an axis perpendicular to the measurement surface as a central axis of rotation (hereinafter, referred to as “β angle”). In making pole figures (FIGS. 5 and 6) in Example 1, pole figures (FIGS. 21 and 22) in Example 5, and pole figures (FIGS. 65 and 66) in Example 16, a range of 0 to 90 deg was scanned for the α angle, and a range of 0 to 360 deg was scanned for the β angle.

In making pole figures of the other Examples, a range of 0 to 90 deg was scanned for the α angle, and a range of 0 to 10 deg was scanned for the β angle. The pole figures of the other Examples were obtained by expanding (namely, copying) map data measured in a range of 0 to 90 deg for the α angle and in a range of 0 to 10 deg for the β angle to 360 deg in a direction of the β angle. It is considered that the pole figure expanded in such a manner is substantially the same as a pole figure obtained by scanning 360 deg in the β angle from the following reason. That is, the object of the measurement is an aggregate of many flat metal particles. The flat surface of each of the flat metal particles is made to face the same direction so as to be along the measurement surface (see FIG. 108), but the flat particles are not made to face the direction of rotation around the axis (ND direction) perpendicular to the measurement surface as a central axis. As calculation software for obtaining a pole figure based on the data obtained by the measurement with Smartlab, 3D Explore or OriginPro was used.

As shown in FIG. 108, a sample used for the measurement conducted using the X-ray diffraction apparatus was put into a container 300 having a recessed portion 301 for accommodating the flat metal particle 100 to give the container 300 vibration, thereby making the flat surfaces 101 of the flat metal particles 100 face the same direction. The flat surfaces 101 (actually, there is variation in direction which flat surfaces face) made to face the same direction in such a manner was used as the measurement surface 200.

As an apparatus for performing the mechanochemical treatment, type: NEV-MA-8 type centrifugal ball mill/manufactured by NISSIN GIKEN Corporation was used. The revolving speed of the ball mill was set at 6 (setting according to scale of apparatus, number of revolution of 6.4 rps). In addition, as the spherical medium (steel ball) used in the mechanochemical treatment, a steel ball using SUJ-2 as a steel ball material and having a steel ball diameter of 9.52 mm (nominal diameter ⅜) was used to set the number of balls to be charged at 20.

### Example 1

A pure iron particle (manufactured by Kobe Steel, Ltd., item number: Atmel 300M) and a graphite particle (manufactured by Nippon Graphite Industries, Co., Ltd., trade name: UCP) were put into a centrifugal ball mill (NEV-MA-8) to perform a mechanochemical treatment under an air atmosphere. As the treatment conditions, the amount of the pure iron particle charged into the centrifugal ball mill was 2.0 g, the amount of the graphite particle added was 0.017 g, 20 steel balls with ϕ 9.52 mm were used as a spherical medium, the number of revolutions was 6.4 rps, and the treatment time was 1 hour. In this case, the amount of the pure iron particle charged (volume ratio) is 0.00363, the amount of the graphite particle charged (volume ratio) is 0.00009, and the amount of the steel ball as the spherical medium charged (volume ratio) is 0.12786 to the inner volume of a mechanochemical treatment container in the centrifugal ball mill of 1.

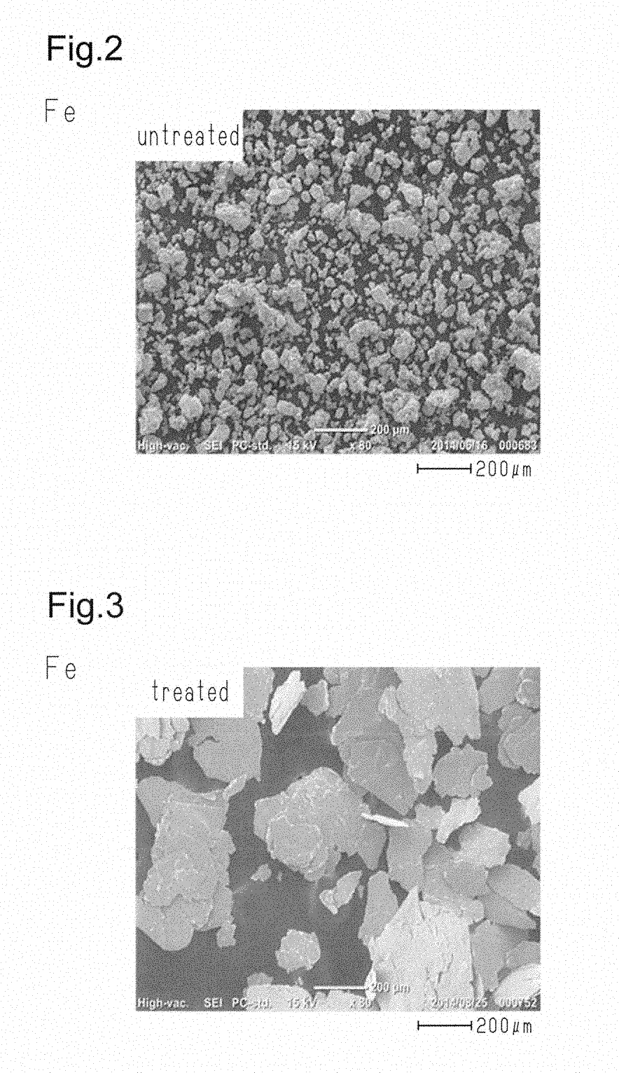

The obtained flat iron particle was analyzed with the electron microscope and by the powder X-ray diffractometry. The results are shown in FIGS. 2 to 6. As shown in FIGS. 2 and 3, an iron particle having a flat shape (see FIG. 3) was obtained from the iron particle in a granular form (see FIG. 2) through the mechanochemical treatment. The average of the lengths in a longitudinal direction of the particles was 280 μm. Moreover, the average of the thicknesses was 2 μm. Accordingly, the aspect ratio defined as the ratio of the length in the longitudinal direction and the thickness of a particle was 140.

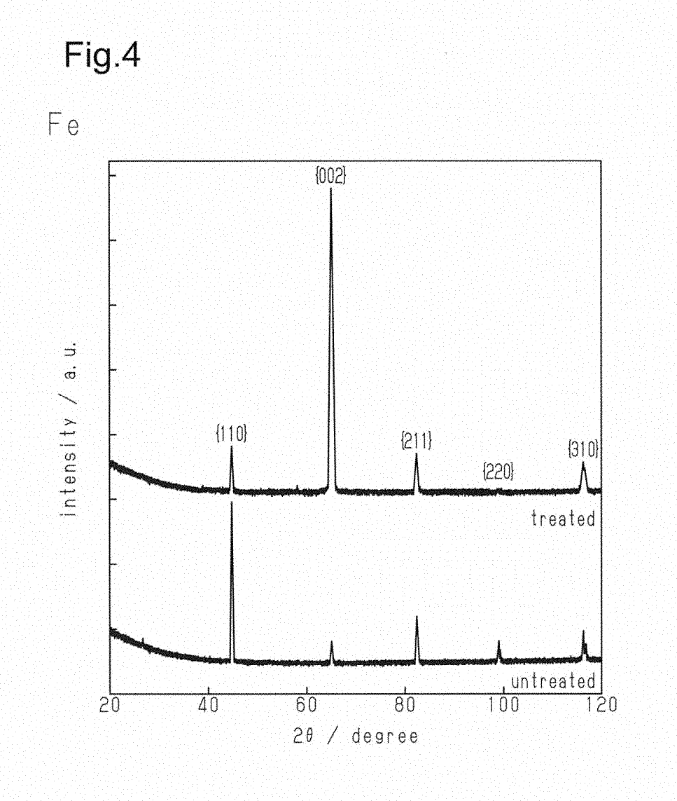

The XRD chart of the iron particle on which the mechanochemical treatment was performed is shown in FIG. 4. In addition, the XRD chart of the iron particle before the mechanochemical treatment is shown together for comparison.

According to these charts, the intensity ratios of each diffraction peak of the iron particle before and after the mechanochemical treatment when the sum of the intensities of the diffraction peaks of the 5 crystal planes from the low angle side of the iron particle is set to be 100% were as shown in Table 1. From the changes in the intensity ratio of each diffraction peak (rate of change in intensity ratio of diffraction peak before and after treatment in Table 1), it was confirmed that the texture is formed in the iron particle after the mechanochemical treatment. The “rate of change in intensity ratio of diffraction peak before and after treatment” is defined as (intensity ratio of diffraction peak after treatment)−(intensity ratio of diffraction peak before treatment)/(intensity ratio of diffraction peak before treatment)×100. A crystal plane is sometimes referred to as a “diffraction plane” in the description of Examples.

TABLE 1

| | Intensity ratio of | | Rate of change in |
|---|---|---|---|
| | diffraction peak (%) | | intensity ratio of |
| Diffraction | Before | After | diffraction peak before |
| plane | treatment | treatment | and after treatment (%) |
| {110} | 49.5 | 13.0 | −73.8 |
| {002} | 10.1 | 60.7 | +503.2 |
| {211} | 17.2 | 11.7 | −32.1 |
| {220} | 10.1 | 5.0 | −50.5 |
| {310} | 13.1 | 9.6 | −26.7 |

As shown in Table 1, it was confirmed the intensity ratio of a diffraction peak is increased or decreased by 10% or more in any of {110}, {002}, {211}, {220}, and {310} crystal planes (diffraction planes). Particularly, in the diffraction plane {002}, it was confirmed that the diffraction peak is increased by +503.2%.

The pole figures of the iron particle on which the mechanochemical treatment was performed are shown in FIG. 6. In addition, the pole figures of the iron particle before the mechanochemical treatment are shown together for comparison in FIG. 5. A random pattern is recognized in the pole figure of the iron particle before the mechanochemical treatment in {110} as shown in FIG. 5(a) and in {002} as shown in FIG. 5(b) and it is understood that the texture does not exist.

On the other hand, only a single pole was recognized in the center of the pole figure obtained by the diffraction peak for the {002} plane of the iron particle after the mechanical treatment as shown in FIG. 6(b), and a belt-like intensity distribution was recognized at a position of around 45° in the pole figure obtained by the diffraction peak for the {110} plane as shown in FIG. 6(a). The {002} plane and the {001} plane are in parallel with each other, and therefore it was confirmed that the texture in which the {001} plane and the flat surface are in parallel with each other are formed in the flat iron particle.

### Example 2

Flat metal particles of pure iron were formed in the same manner as in Example 1. The amount of the graphite particle added into the centrifugal ball mill was 0.014 g. In Example 2, the properties of each flat metal particle obtained by changing the treatment time for the mechanochemical treatment were investigated.

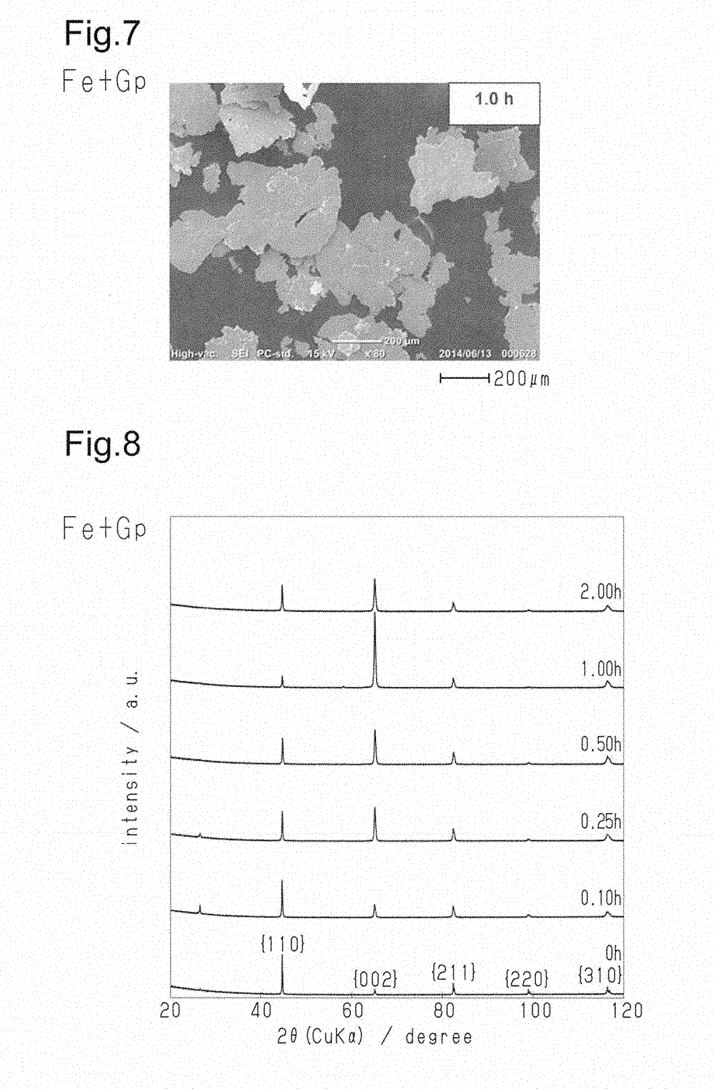

As shown in FIG. 7, a flat metal particle obtained by performing the mechanochemical treatment for 1 hour has a flat surface. The flat metal particle has an aspect ratio of 133.2.

As shown in FIG. 8, the intensity of the diffraction peak for the {002} plane is higher than the intensity of the diffraction peak for the {110} plane for a flat metal particle obtained by performing the mechanochemical treatment for 0.5 hours.

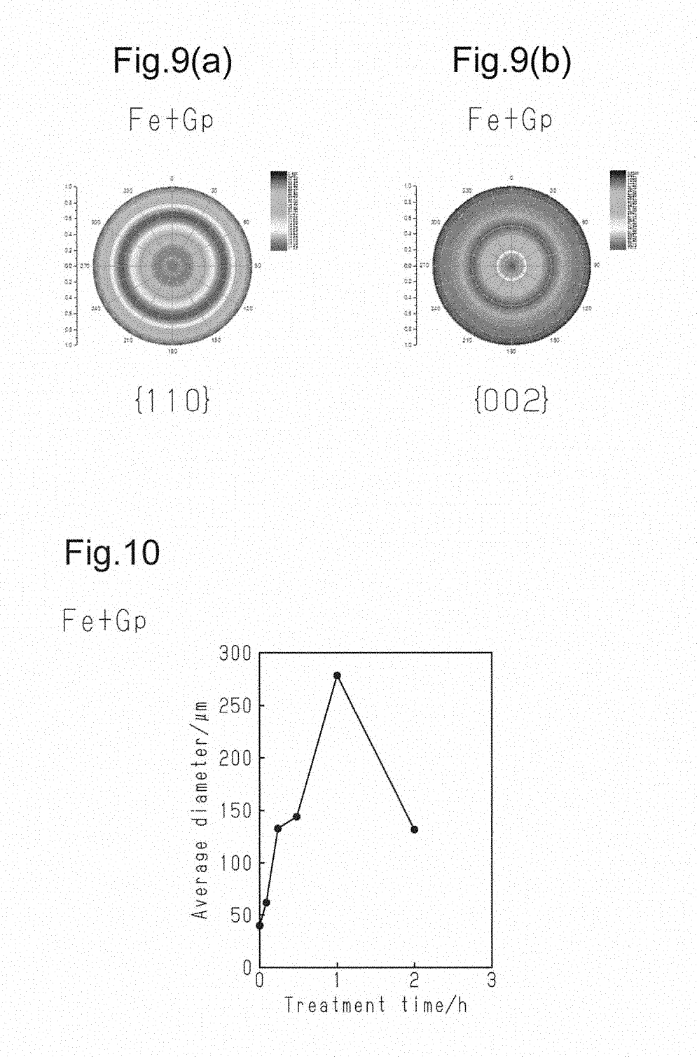

In addition, as shown in FIGS. 9(a) and 9(b), the pole figure of the {110} plane and the pole figure of the {002} plane of the flat metal particle obtained by performing the mechanochemical treatment for 1 hour are concentric. That is, the texture is formed in the flat metal particle. As shown in FIG. 10, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of a flat metal particle becomes small according to the treatment time.

### Example 3

Flat metal particles of pure vanadium (manufactured by Kojundo Chemical Laboratory Co., Ltd., item number: VVE01PB) were formed in the same manner as in Example 1. The amount of the graphite particle added into the centrifugal ball mill was 0.014 g. As a texturization aid, the graphite particle (manufactured by Nippon Graphite Industries, Co., Ltd., trade name: UCP) was used. In Example 3, the properties of each flat metal particle obtained by changing the treatment time for the mechanochemical treatment were investigated.

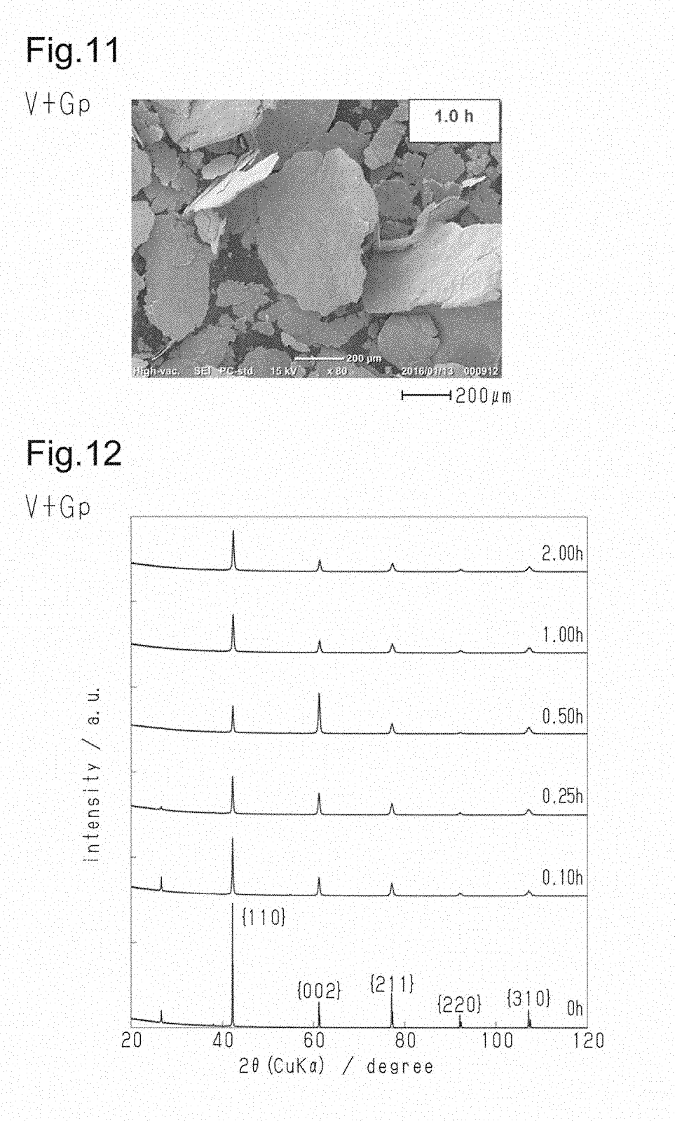

As shown in FIG. 11, a flat metal particle obtained by performing the mechanochemical treatment for 1 hour has a flat surface. The flat metal particle has an aspect ratio of 492.0.

As shown in FIG. 12, the intensity of the diffraction peak for the {002} plane is higher than the intensity of the diffraction peak for the {110} plane for a flat metal particle obtained by performing the mechanochemical treatment for 0.5 hours.

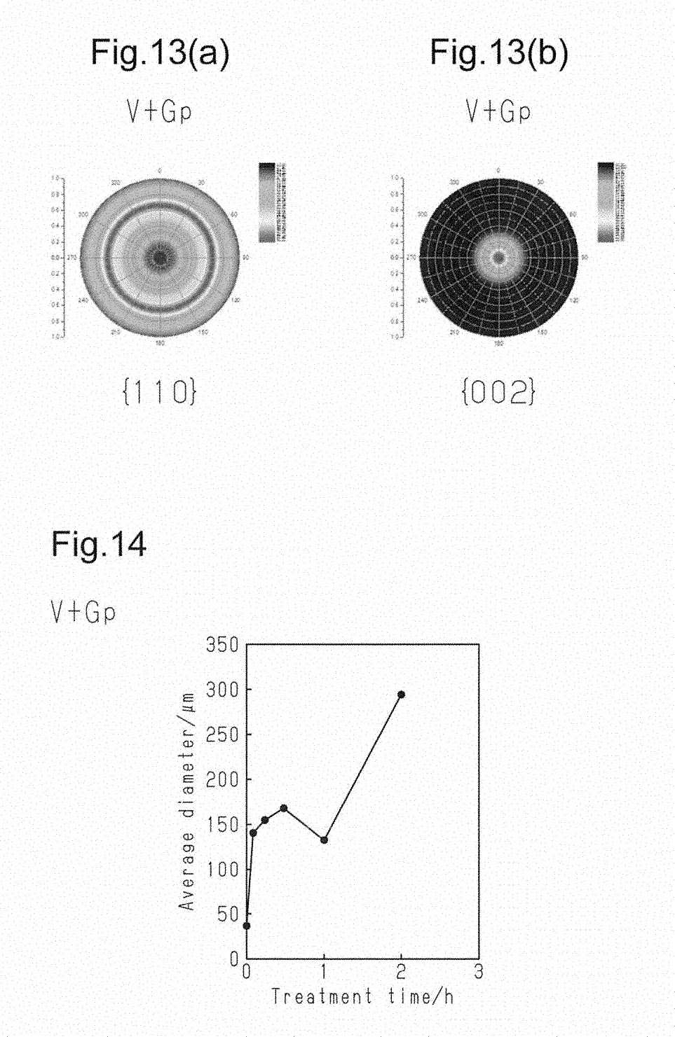

In addition, as shown in FIGS. 13(a) and 13(b), the pole figure of the {110} plane and the pole figure of the {002} plane of the flat metal particle obtained by performing the mechanochemical treatment for 0.5 hours are concentric. That is, the texture is formed in the flat metal particle. As shown in FIG. 14, there is a tendency that the average particle diameter of a flat metal particle becomes large according to the treatment time until the mechanochemical treatment time reaches 2 hours.

### Example 4

Flat metal particles of pure niobium (manufactured by Kojundo Chemical Laboratory Co., Ltd., item number: NBE05PB) were formed in the same manner as in Example 1. The amount of the graphite particle added into the centrifugal ball mill was 0.014 g. As the texturization aid, the graphite particle (manufactured by Nippon Graphite Industries, Co., Ltd., trade name: UCP) was used. In Example 4, the properties of each flat metal particle obtained by changing the treatment time for the mechanochemical treatment were investigated.

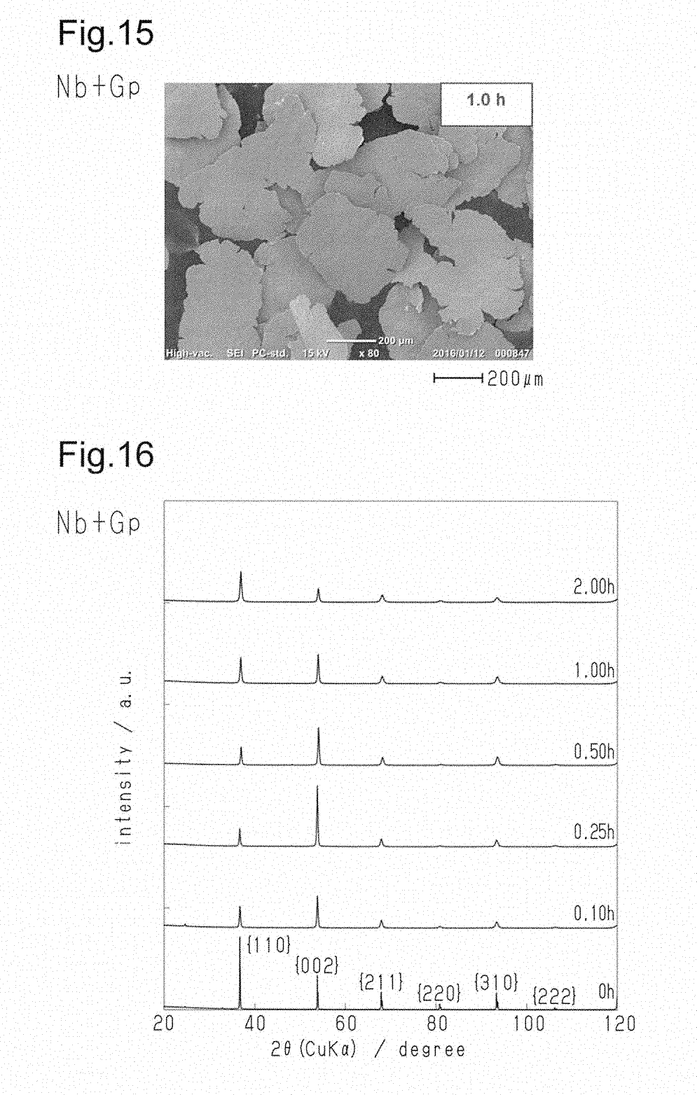

As shown in FIG. 15, a flat metal particle obtained by performing the mechanochemical treatment for 1 hour has a flat surface. The flat metal particle has an aspect ratio of 213.3.

As shown in FIG. 16, the intensity of the diffraction peak for the {002} plane is higher than the intensity of the diffraction peak for the {110} plane for a flat metal particle obtained by performing the mechanochemical treatment for 0.1 hours.

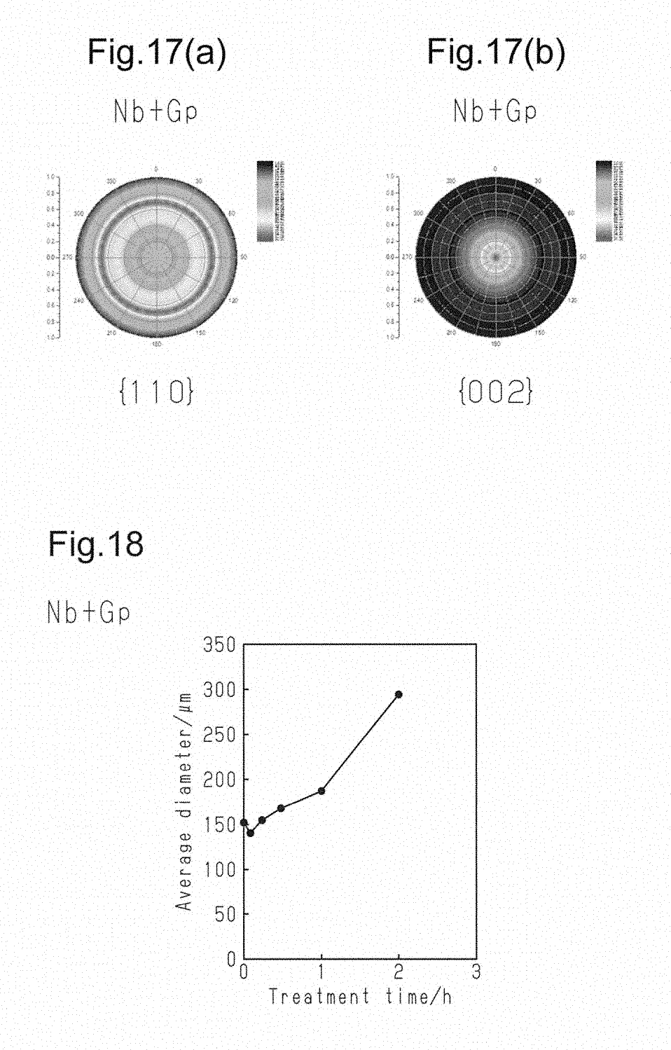

In addition, as shown in FIGS. 17(a) and 17(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 18, there is a tendency that the average particle diameter of a flat metal particle becomes large according to the treatment time until the mechanochemical treatment time reaches 2 hours.

As understood from Example 1 to Example 4 and Table 4 (see FIGS. 2 to 18), the texture is obtained through the mechanochemical treatment from any of the metals of the bcc structure. In addition, it is understood that the average particle diameter of a flat metal particle changes according to the treatment time for the mechanochemical treatment. Moreover, the average particle diameter becomes gradually larger at an initial stage of the mechanochemical treatment. Furthermore, when the time for the mechanochemical treatment is long, the average particle diameter may become small. These indicate that the average particle diameter of the flat particle can be controlled by the treatment time for the mechanochemical treatment. In addition, the intensity ratio of the diffraction peak for the {002} plane in the XRD chart gradually increases at the initial stage of the treatment time for the mechanochemical treatment but decreases thereafter. The reason is that when the treatment time for the mechanochemical treatment becomes long, the aspect ratio becomes small, so that the flat metal particles, when filled in the container in the measurement of the pole figure, do not face the same direction to disperse the direction which each flat metal particle faces. On the other hand, even though the aspect ratio gradually becomes larger with the mechanochemical treatment time, the intensity ratio of the diffraction peak for the {002} plane may become large once and then become small (see Example 4). From these facts, it is necessary that the treatment time for the mechanochemical treatment be set at an appropriate time in order to obtain the flat metal particle having the texture and an appropriate aspect ratio. That is, the texturization rate (ratio of number of crystals orientated in the same direction to total number of crystals in flat metal particle) and the aspect ratio can be controlled by the treatment time for the mechanochemical treatment.

### Example 5

A pure copper particle (manufactured by Kojundo Chemical Laboratory Co., Ltd., item number: 293770) and the graphite particle (manufactured by Nippon Graphite Industries, Co., Ltd., trade name: UCP) were put into the centrifugal ball mill (NEV-MA-8) to perform a mechanochemical treatment under the air atmosphere. As the treatment conditions, the amount of the pure copper particle charged into the centrifugal ball mill was 2.0 g, the amount of the graphite particle added was 0.017 g, 20 steel balls (made of SUJ-2) with ϕ 9.52 mm were used as the spherical medium, the number of revolutions was 6.4 rps, and the treatment time was 1 hour. In this case, the amount of the pure copper particle charged (volume ratio) is 0.00319, the amount of the graphite particle charged (volume ratio) is 0.00009, and the amount of the steel ball as the spherical medium charged (volume ratio) is 0.12786 to the inner volume of a treatment container in the centrifugal ball mill of 1.

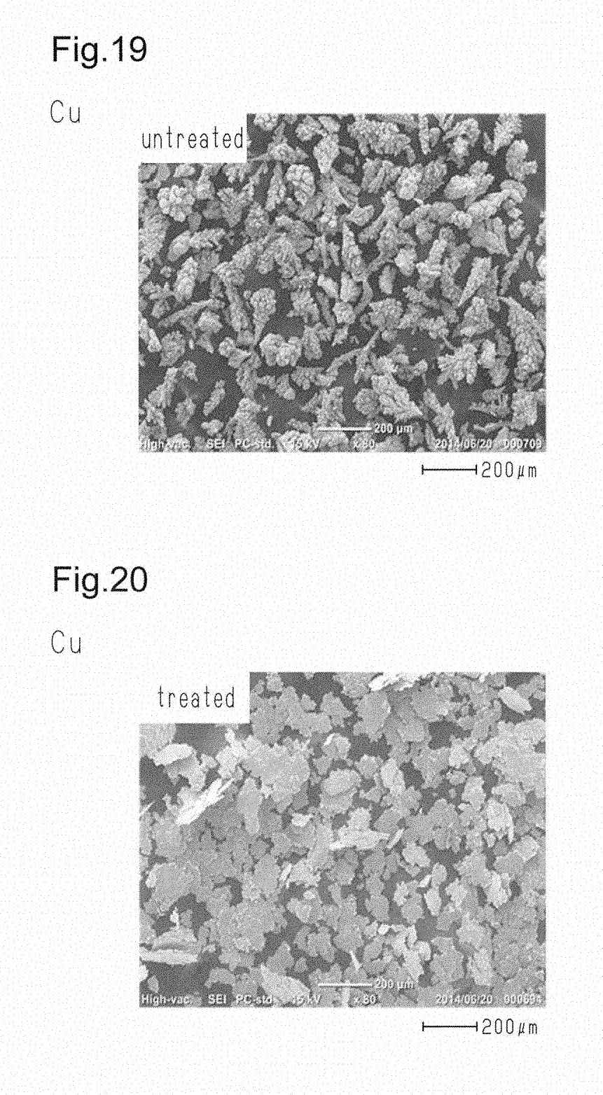

The obtained flat copper particle was analyzed with the electron microscope and by the powder X-ray diffractometry. The results are shown in FIGS. 19 to 23.

A copper particle having a flat shape as shown in FIG. 20 was obtained from a copper particle in a granular form as shown in FIG. 19 through the mechanochemical treatment. The average of the lengths in a longitudinal direction of the flat metal particles of Example 5 was 78 μm. Moreover, the average of the thicknesses was 1 μm. Accordingly, the aspect ratio defined as the ratio of the length in the longitudinal direction and the thickness of a flat metal particle was 78.

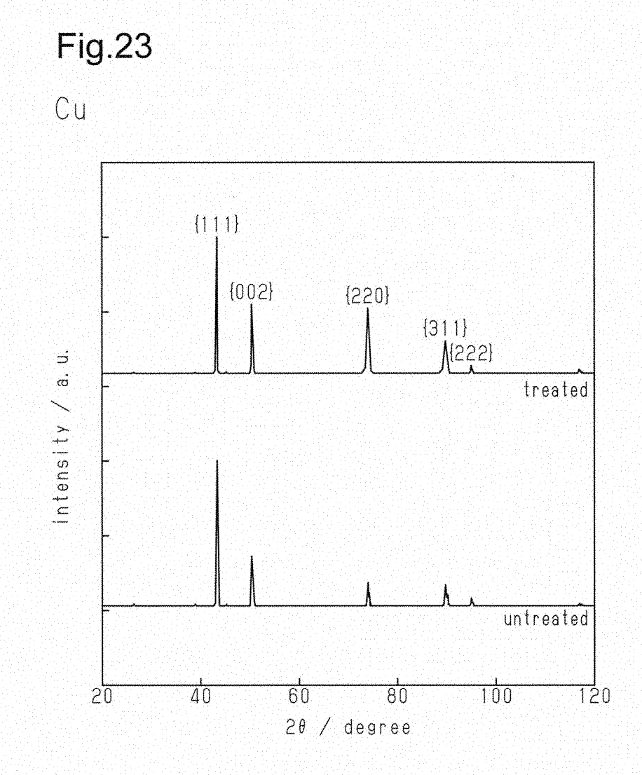

In FIG. 23, the XRD chart of the copper particle on which the mechanochemical treatment was performed is shown. In addition, the XRD chart of the iron particle before the mechanochemical treatment is shown together for comparison. The intensity ratios of each diffraction peak of the iron particle before and after the mechanochemical treatment when the sum of the intensities of the diffraction peaks of the 5 crystal planes from the low angle side of the iron particle is set to be 100% are shown in Table 2. As shown in Table 2, from a change in the intensity ratio of a diffraction peak (rate of change in intensity ratio of diffraction peak before and after treatment in Table 2) of 10% or more in the {111}, {220}, {311}, and {222} planes, it was confirmed that the texture is formed in the copper particle after the mechanochemical treatment.

TABLE 2

| | Intensity ratio of | | Rate of change in |
|---|---|---|---|
| | diffraction peak (%) | | intensity ratio of |
| Diffraction | Before | After | diffraction peak before |
| plane | treatment | treatment | and after treatment (%) |
| {111} | 55.8 | 40.1 | −28.1 |
| {002} | 20.2 | 22.0 | +8.8 |
| {220} | 10.4 | 20.7 | +98.7 |
| {311} | 9.6 | 11.9 | +27.2 |
| {222} | 4.3 | 5.4 | +26.1 |

The pole figures of the copper particle on which the mechanochemical treatment was performed for 1.0 hour are shown in FIGS. 22(a) to 22(c). In addition, the pole figures of the copper particle before the mechanochemical treatment are shown together for comparison in FIGS. 21(a) to 21(c).

A random pattern is recognized in the pole figures of the copper particle before the mechanochemical treatment as shown in the pole figure of {111} in FIG. 21(a), the pole figure of {002} in FIG. 21(b), and the pole figure of {220} in FIG. 21(c) and it was confirmed that the texture does not exist.

On the other hand, with respect to the copper particle on which the mechanochemical treatment was performed, one clear pole was recognized at the center and a thin belt-like intensity distribution at a position around 60° was recognized for the diffraction peak for the {222} plane as shown in the pole figure in FIG. 22(c). Moreover, with respect to the copper particle on which the mechanochemical treatment was performed, a belt-like intensity distribution was recognized at a position around 45° in the pole figure of the {111} plane as shown in FIG. 22(a) and the pole figure of the {002} plane as shown in FIG. 22(b). From these facts, it was confirmed that the texture in which the {220} plane and the flat surface are mainly in parallel with each other is formed in the flat copper particle. In addition, it was confirmed that the flat metal particles are randomly orientated in the directions included in the {220} plane. From above, it was confirmed that the present method is not limited to the metal having the bcc structure (example: iron) and can be applied to the metal having the fcc structure (example: copper).

### Example 6

Flat metal particles of pure copper were formed in the same manner as in Example 5. The amount of the graphite particle added into the centrifugal ball mill was 0.014 g. In Example 6, the properties of each flat metal particle obtained by changing the treatment time for the mechanochemical treatment were investigated.

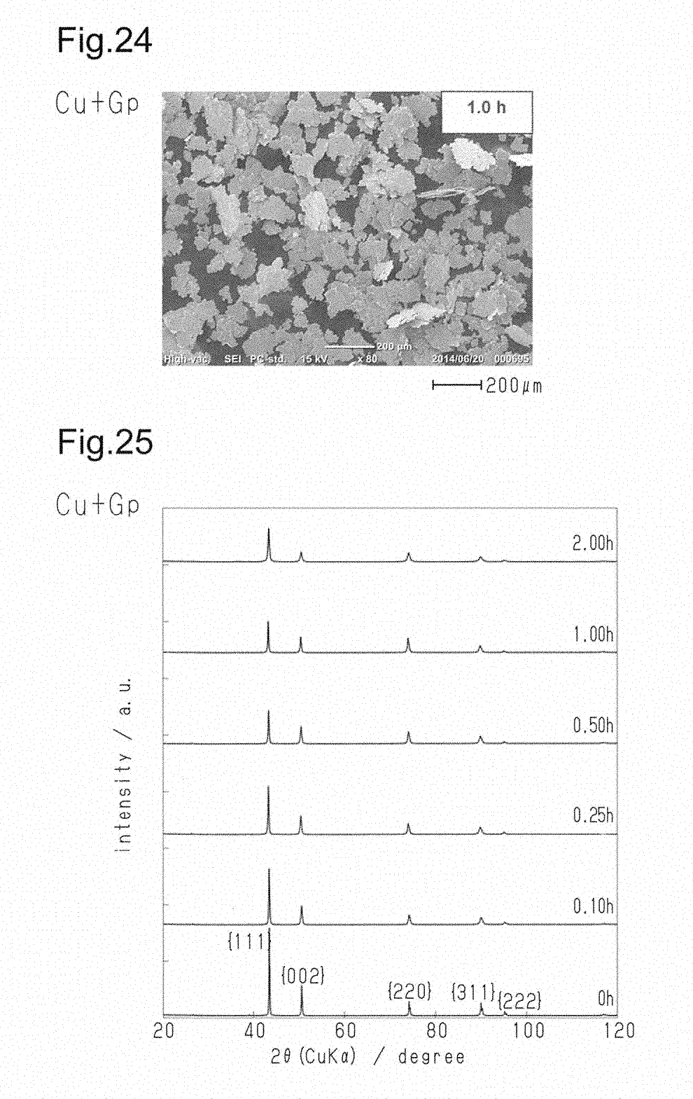

As shown in FIG. 24, a flat metal particle obtained by performing the mechanochemical treatment for 1 hour has a flat surface. The flat metal particle has an aspect ratio of 277.9.

As shown in FIG. 25, the intensity ratio of the diffraction peak for the {220} plane for a flat metal particle obtained by performing the mechanochemical treatment for 0.25 hours is higher than that for the metal particle with the mechanochemical treatment time being 0 hours.

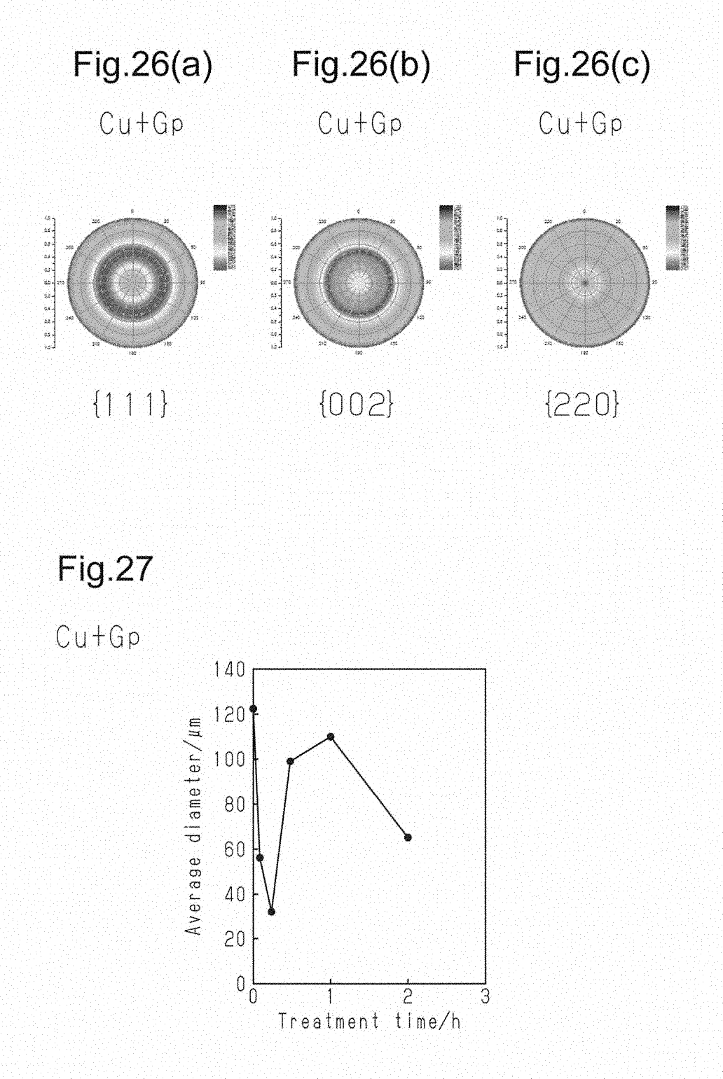

In addition, as shown in FIGS. 26(a), 26(b), and 26(c), the pole figure of the {111} plane, the pole figure of the {002} plane, and the pole figure of the {220} plane of the flat metal particle obtained by performing the mechanochemical treatment for 1.0 hour are concentric. That is, the texture is formed in the flat metal particle. As shown in FIG. 27, there is a tendency that the average particle diameter of a flat metal particle becomes small according to the treatment time when the mechanochemical treatment time exceeds 1 hour.

### Example 7

Flat metal particles of pure aluminum (manufactured by HIKARI MATERIAL INDUSTRY CO., LTD., item number: Al-4N) were formed in the same manner as in Example 5. The amount of the graphite particle added into the centrifugal ball mill was 0.014 g. As the texturization aid, the graphite particle (manufactured by Nippon Graphite Industries, Co., Ltd., trade name: UCP) was used. In Example 7, the properties of each flat metal particle obtained by changing the treatment time for the mechanochemical treatment were investigated.

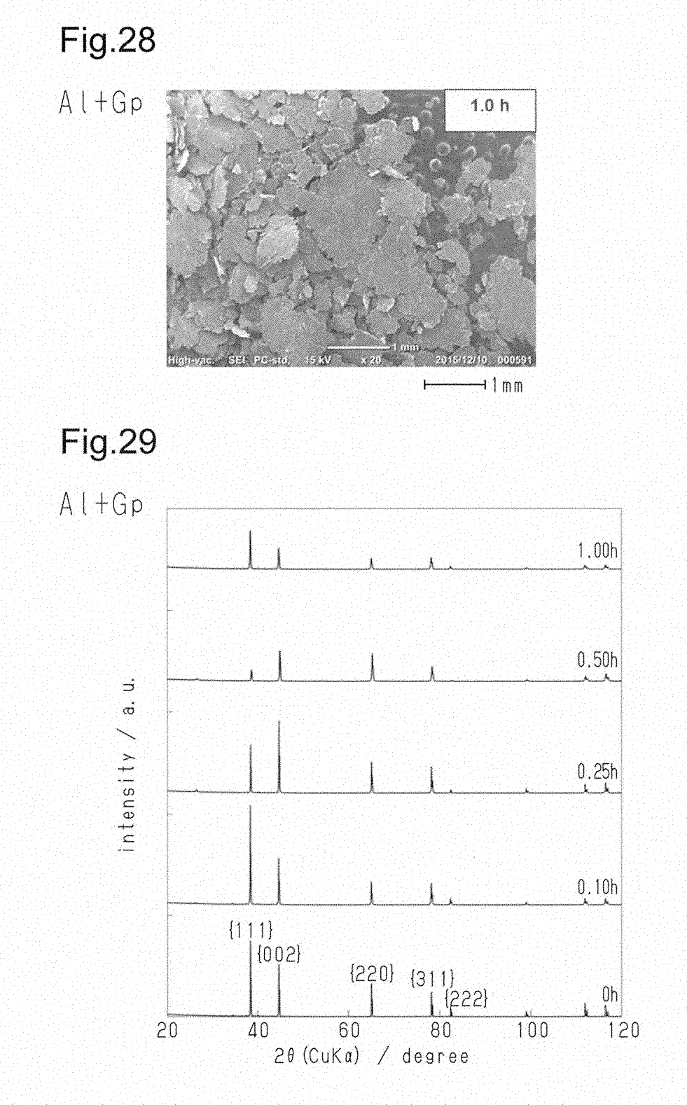

As shown in FIG. 28, a flat metal particle obtained by performing the mechanochemical treatment for 1 hour has a flat surface. The flat metal particle has an aspect ratio of 1108.8.

As shown in FIG. 29, the intensity ratio of the diffraction peak for the {220} plane is higher than the intensity ratio of the diffraction peak for the {111} plane for a flat metal particle obtained by performing the mechanochemical treatment for 0.5 hours.

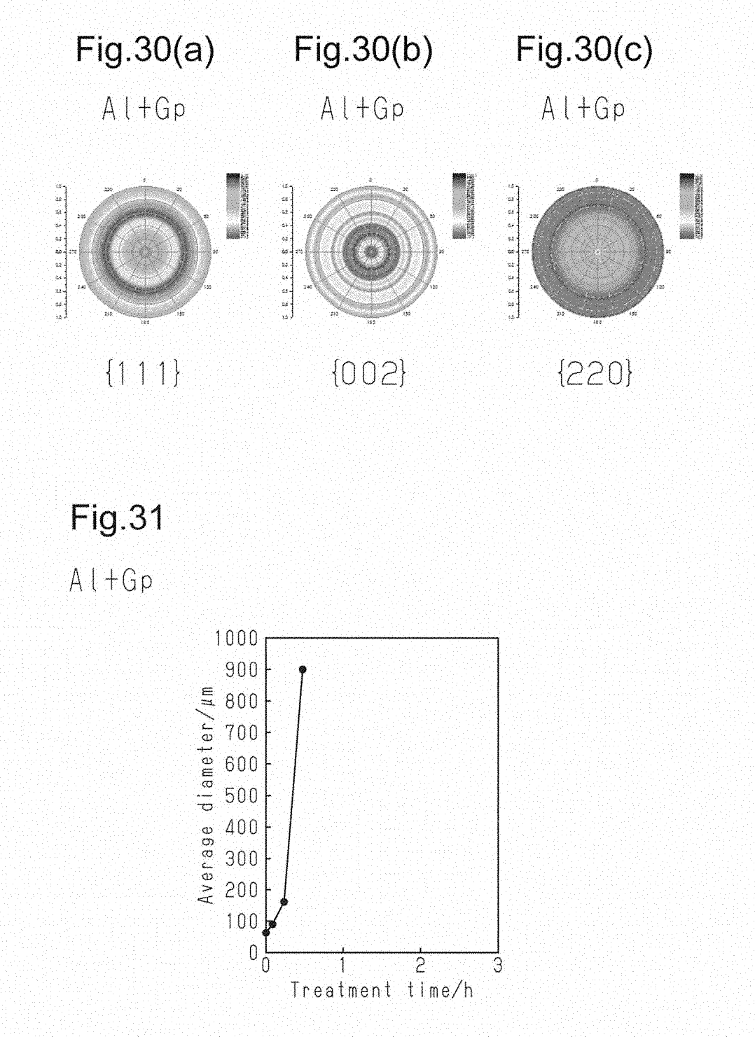

In addition, as shown in FIGS. 30(a), 30(b), and 30(c), the pole figure of the {111} plane, the pole figure of the {002} plane, and the pole figure of the {220} plane of the flat metal particle obtained by performing the mechanochemical treatment for 0.5 hours are concentric. That is, the texture is formed in the flat metal particle. As shown in FIG. 31, the average particle diameter at a certain point of time in the mechanochemical treatment time becomes larger with the treatment time.

### Example 8

Flat metal particles of pure nickel (manufactured by Kojundo Chemical Laboratory Co., Ltd., item number: 304091) were formed in the same manner as in Example 5. The amount of the graphite particle added into the centrifugal ball mill was 0.014 g. As the texturization aid, the graphite particle (manufactured by Nippon Graphite Industries, Co., Ltd., trade name: UCP) was used. In Example 8, the properties of each flat metal particle obtained by changing the treatment time for the mechanochemical treatment were investigated.

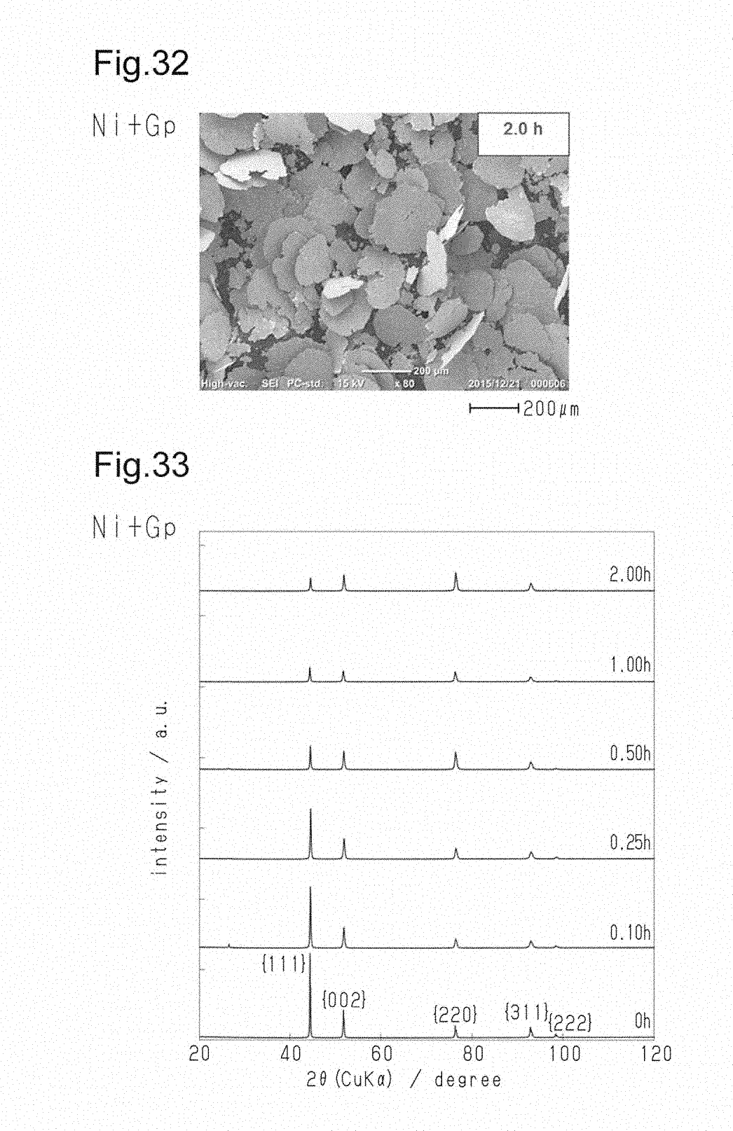

As shown in FIG. 32, a flat metal particle obtained by performing the mechanochemical treatment for 2 hours has a flat surface. The flat metal particle has an aspect ratio of 398.3.

As shown in FIG. 33, the intensity ratio of the diffraction peak for the {220} plane for a flat metal particle obtained by performing the mechanochemical treatment for 0.50 hours is higher than that for the metal particle with the mechanochemical treatment time being 0 hours.

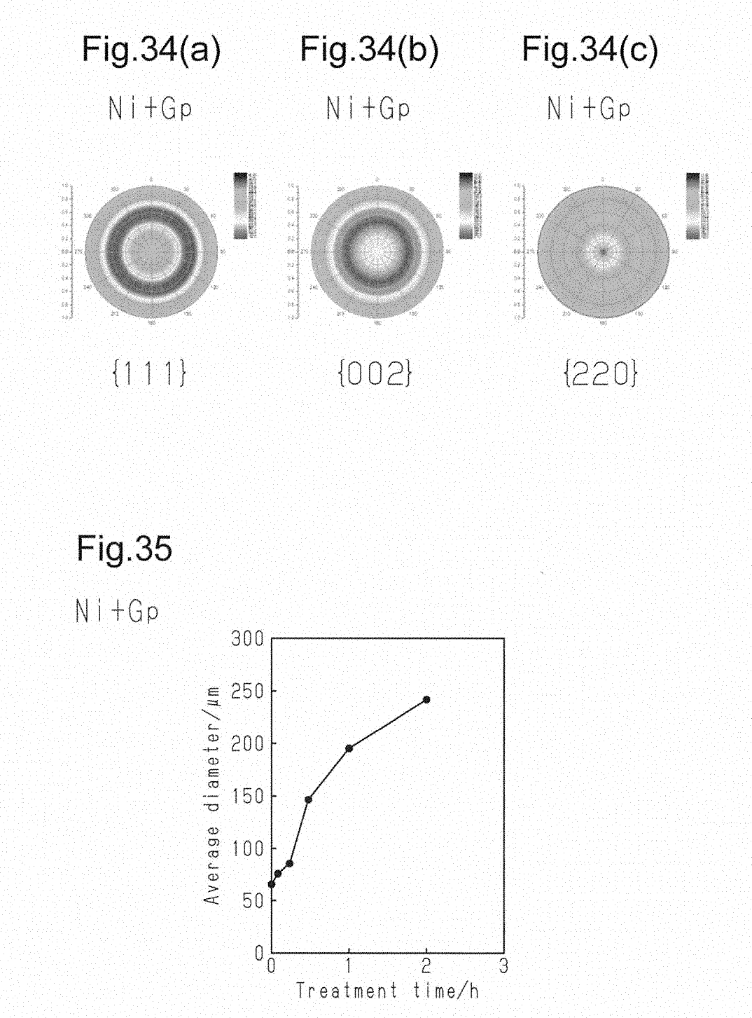

In addition, as shown in FIGS. 34(a), 34(b), and 34(c), the pole figure of the {111} plane, the pole figure of the {002} plane, and the pole figure of the {220} plane of the flat metal particle obtained by performing the mechanochemical treatment for 2 hours are concentric. That is, the texture is formed in the flat metal particle. As shown in FIG. 35, the average particle diameter at a certain point in time in the mechanochemical treatment time becomes larger with the treatment time.

As understood from Example 5 to Example 8 (see FIGS. 19 to 35), the texturization of a metal particle occurs in any of the metals of the fcc structure through the mechanochemical treatment. The flat metal particles of the fcc structure exhibit the same effects as the flat metal particles of the bcc structure. It is understood that the metal particle is texturized in the copper-containing flat metal particles and in the nickel-containing flat metal particle because the polar or belt-like intensity distribution is obtained in any of the pole figures even though the changes in the intensity ratio of each diffraction peak in the XRD chart are poorer than those of the flat metal particles of the bcc structure. On the other hand, the changes in the intensity ratio of each diffraction peak in the XRD chart are remarkable for the aluminum-containing flat metal particle in the same manner as for the flat metal particles of the bcc structure.

### Example 9

A pure titanium particle (manufactured by Kojundo Chemical Laboratory Co., Ltd., item number: 304092) was put into the centrifugal ball mill (NEV-MA-8) to perform a mechanochemical treatment under the air atmosphere. The texturization aid is not used in Example 9. As the treatment conditions, the amount of the pure titanium particle charged into the centrifugal ball mill was 1.0 g, 20 steel balls (made of SUJ-2) with ϕ 9.52 mm were used as the spherical medium, the number of revolutions was 6.4 rps, and the treatment time was 1 hour. In this case, the amount of the pure titanium particle charged (volume ratio) is 0.00317, and the amount of the steel ball as the spherical medium charged (volume ratio) is 0.12786 to the inner volume of the treatment container in the centrifugal ball mill of 1.

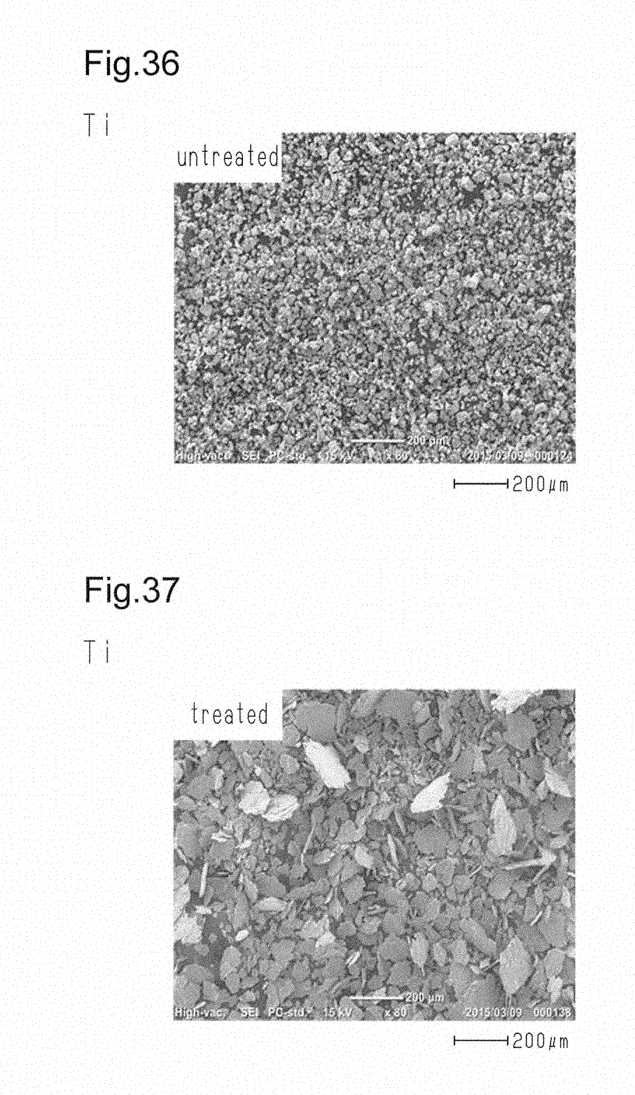

The obtained flat titanium particle was analyzed with the electron microscope and by the powder X-ray diffractometry. The results are shown in FIGS. 36 to 38.

A titanium particle having a flat shape as shown in FIG. 37 was obtained from a titanium particle in a granular form before the mechanochemical treatment as shown in FIG. 36 through the mechanochemical treatment.

The average of the lengths in a longitudinal direction of the flat metal particles was 58 μm. Moreover, the average of the thicknesses was 7 μm. Accordingly, the aspect ratio defined as the ratio of the length in the longitudinal direction and the thickness of a flat metal particle was 8.3.

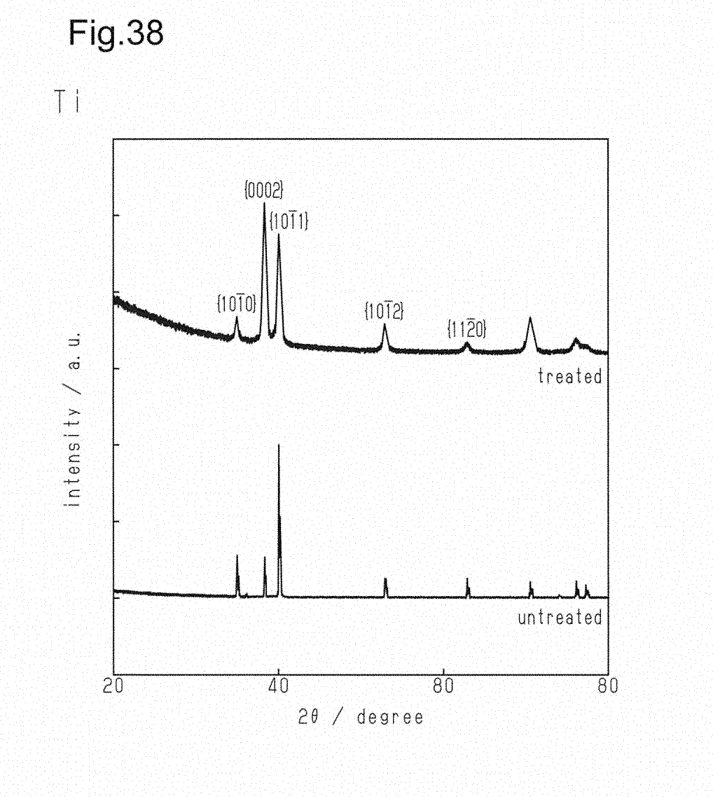

In FIG. 38, the XRD chart of the titanium particle on which the mechanochemical treatment was performed is shown. In addition, the XRD chart of the titanium particle before the mechanochemical treatment is shown together for comparison.

The intensity ratios of each diffraction peak of the iron particle before and after the mechanochemical treatment when the sum of the intensities of the diffraction peaks of the 5 crystal planes from the low angle side of the titanium particle as shown in FIG. 38 is set to be 100% are shown in Table 3. As shown in Table 3, from a change in the intensity ratio of a diffraction peak of 10% or more in the {10-10}, {0002}, {10-11}, {10-12}, and {11-20} crystal planes, it was confirmed that the texture is formed in the titanium particle after the mechanochemical treatment. The character “−” in some miller indices herein is a substitute for the overline or bar that stands for negative quantities in the Miller index notation.

From this fact, it was confirmed that the present manufacturing method is not limited to the metal having the bcc structure (example: iron) and the metal having the fcc structure (example: copper) and can also be applied to the metal having the hcp structure (example: titanium).

In addition, it was confirmed that a suitable flat metal particle can also be obtained by performing the mechanochemical treatment without using a solid lubricant such as the graphite particle.

TABLE 3

| | Intensity ratio of | | Rate of change in |
|---|---|---|---|
| | diffraction peak (%) | | intensity ratio of |
| Diffraction | Before | After | diffraction peak before |
| plane | treatment | treatment | and after treatment (%) |
| {10-10} | 15.5 | 11.6 | −25.5 |
| {0002} | 14.8 | 36.6 | +147.0 |
| {10-11} | 55.6 | 39.8 | −28.4 |
| {10-12} | 7.0 | 8.3 | +19.2 |
| {11-20} | 7.1 | 3.7 | −47.9 |

### Example 10

Flat metal particles of pure titanium were formed in the same manner as in Example 9. The texturization aid is not used. In Example 10, the properties of each flat metal particle obtained by changing the treatment time for the mechanochemical treatment were investigated.

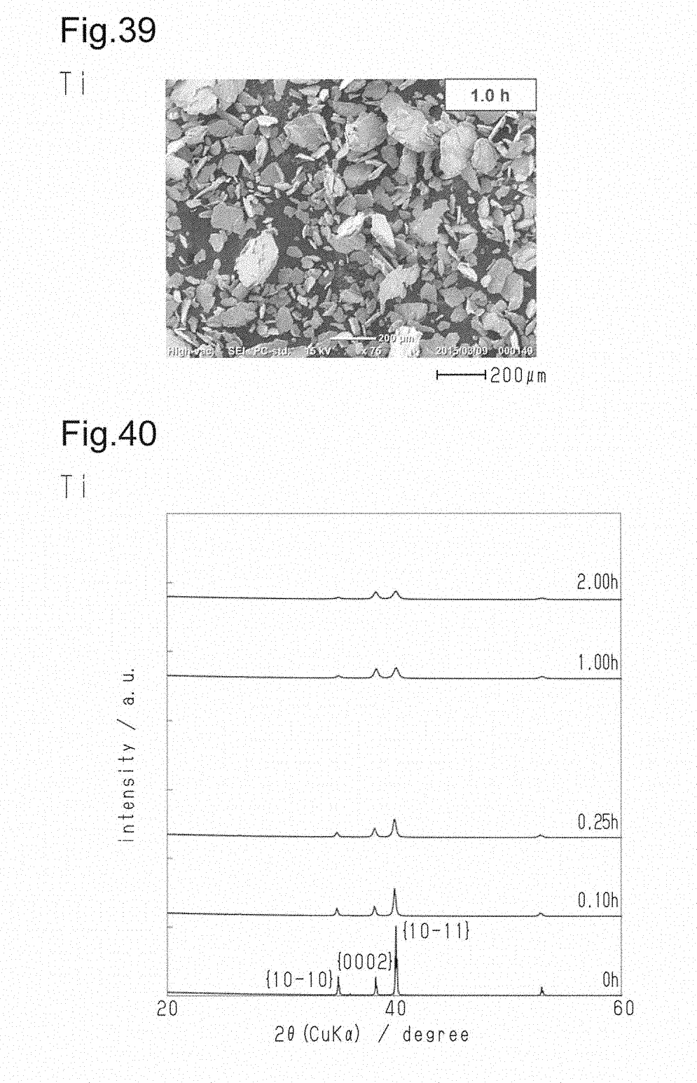

As shown in FIG. 39, a flat metal particle obtained by performing the mechanochemical treatment for 1 hour has a flat surface. The flat metal particle has an aspect ratio of 16.6.

As shown in FIG. 40, the intensity ratio of the diffraction peak for the {0002} plane for a flat metal particle obtained by performing the mechanochemical treatment for 0.25 hours is higher than that for the metal particle with the mechanochemical treatment time being 0 hours.

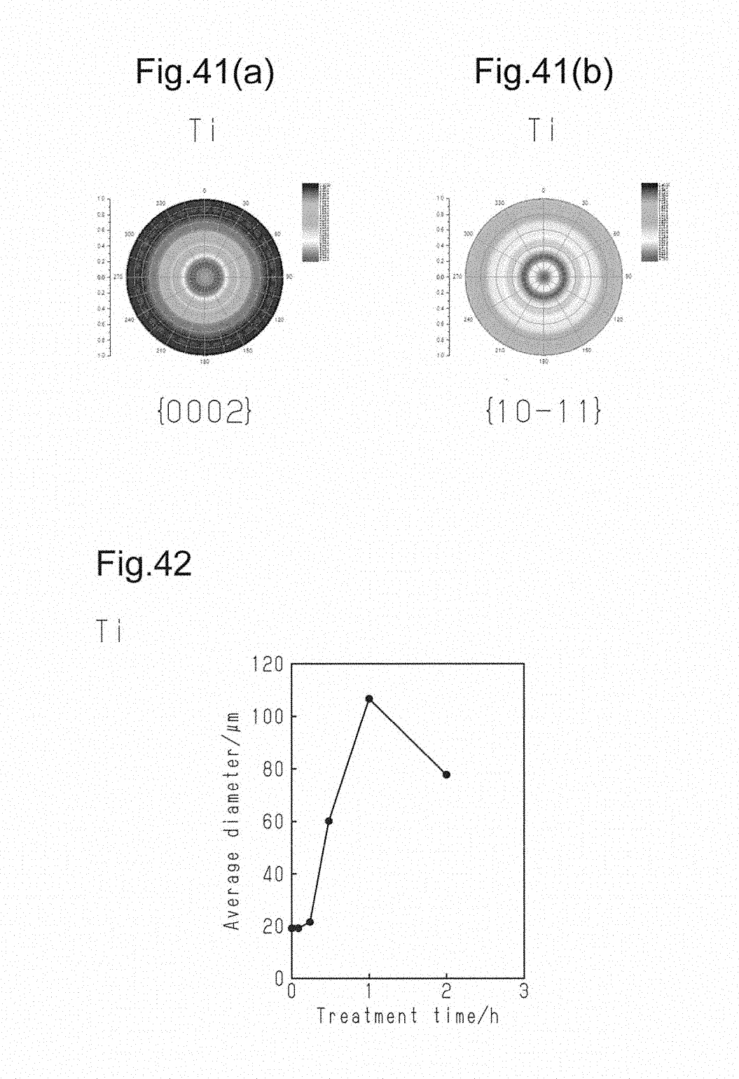

In addition, as shown in FIGS. 41(a) and 41(b), the pole figure of the {0002} plane and the pole figure of the {10-11} plane of the flat metal particle obtained by performing the mechanochemical treatment for 1.0 hour are concentric. That is, the texture is formed in the flat metal particle. As shown in FIG. 42, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of a flat metal particle becomes small according to the treatment time.

### Example 11

Flat metal particles of pure zinc (manufactured by Kojundo Chemical Laboratory Co., Ltd., item number: ZNE06PB) were formed in the same manner as in Example 9. The texturization aid is not used. In Example 11, the properties of each flat metal particle obtained by changing the treatment time for the mechanochemical treatment were investigated.

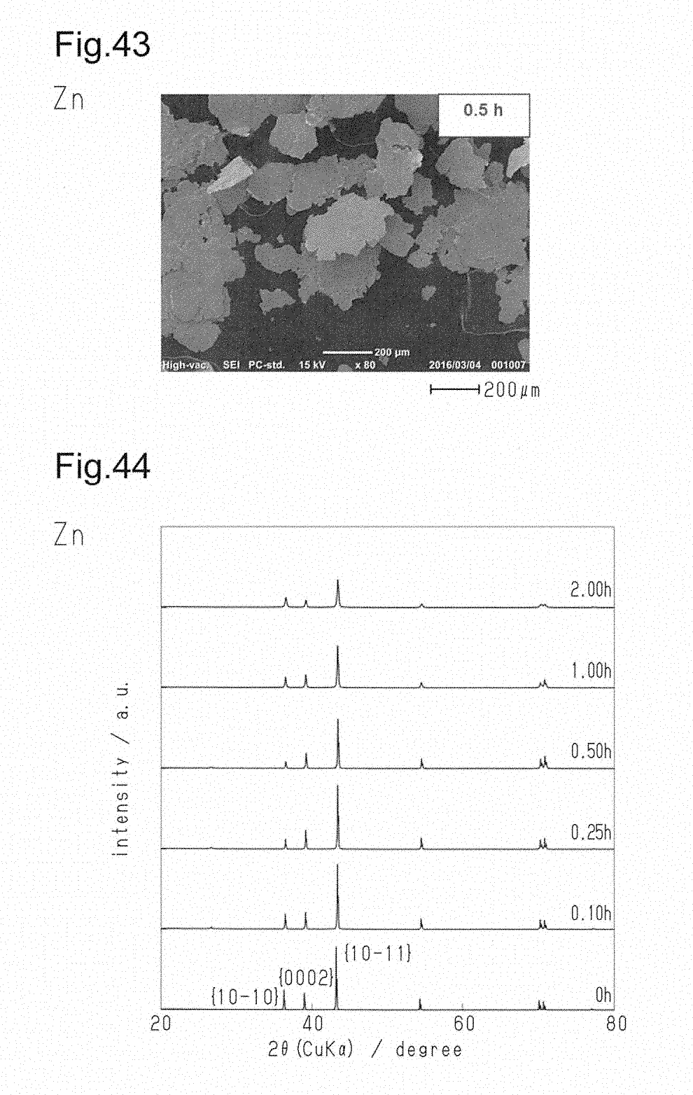

As shown in FIG. 43, a flat metal particle obtained by performing the mechanochemical treatment for 0.5 hours has a flat surface. The flat metal particle has an aspect ratio of 135.6.

As shown in FIG. 44, the intensity ratio of the diffraction peak for the {0002} plane for a flat metal particle obtained by performing the mechanochemical treatment for 0.25 hours is higher than that for the metal particle with the mechanochemical treatment time being 0 hours.

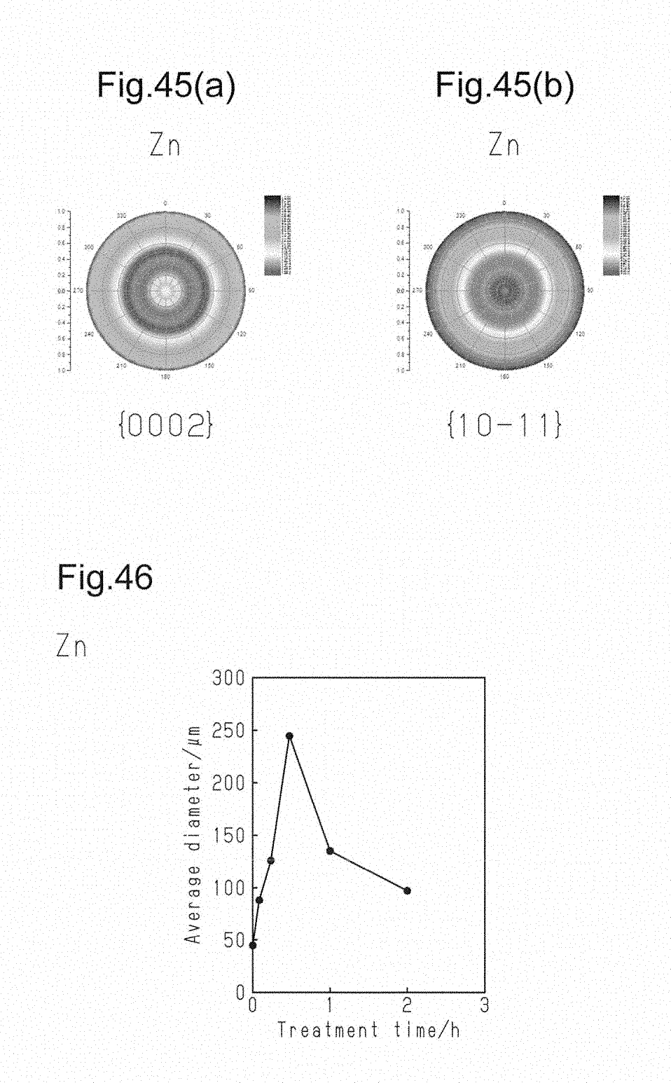

In addition, as shown in FIGS. 45(a) and 45(b), the pole figure of the {0002} plane and the pole figure of the {10-11} plane of the flat metal particle obtained by performing the mechanochemical treatment for 0.5 hours are concentric. That is, the texture is formed in the flat metal particle. As shown in FIG. 46, there is a tendency that the average particle diameter of a flat metal particle becomes large according to the treatment time until the mechanochemical treatment time reaches 0.5 hours, but when the mechanochemical treatment time exceeds 0.5 hours, there is a tendency that the average particle diameter of the flat metal particle becomes small according to the treatment time.

As understood from Example 9 to Example 11 (see FIGS. 36 to 46), the texture is obtained from any of the metals of the hcp structure through the mechanochemical treatment. The flat metal particles of the hcp structure exhibit the same effects as the flat metal particles of the bcc structure. It is to be noted that it is understood that the metal particle is texturized in the titanium-containing flat metal particles and in the zinc-containing flat metal particle because the polar or belt-like intensity distribution is obtained in any of the pole figures even though the changes in the intensity ratio of each diffraction peak in the XRD chart are poorer than those of the flat metal particles of the bcc structure.

Moreover, almost the same properties, which are not shown in Examples, were obtained in the flat metal particles obtained by performing the mechanochemical treatment on the pure titanium using graphite as the texturization aid and the flat metal particles obtained by performing the mechanochemical treatment on the pure titanium not using the graphite. Furthermore, almost the same properties were obtained in the flat metal particles obtained by performing the mechanochemical treatment on the pure zinc using the graphite as the texturization aid and the flat metal particles obtained by performing the mechanochemical treatment on the pure zinc not using the graphite.

### Example 12

Flat metal particles of an iron cobalt alloy (Fe-48Co-2V, permendur) were formed in the same manner as in Example 1. The amount of the graphite particle added into the centrifugal ball mill was 0.014 g. In Example 12, the properties of each flat metal particle obtained by changing the treatment time for the mechanochemical treatment were investigated.

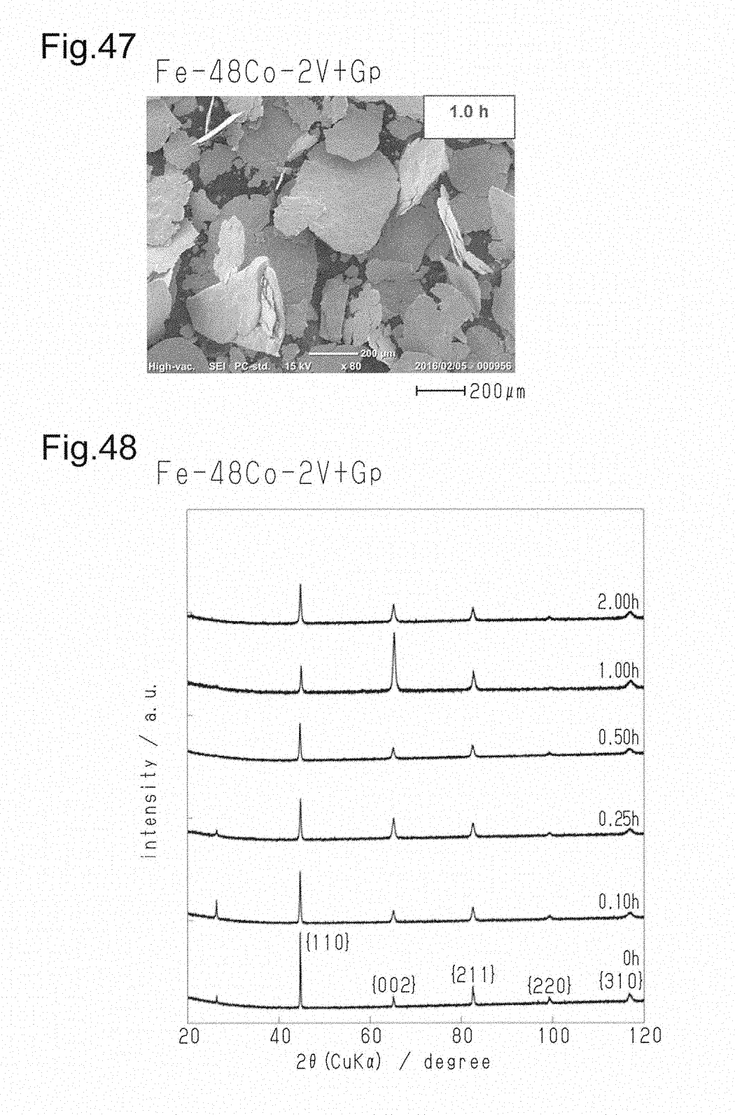

As shown in FIG. 47, a flat metal particle obtained by performing the mechanochemical treatment for 1 hour has a flat surface. The flat metal particle has an aspect ratio of 195.2.

As shown in FIG. 48, the intensity ratio of the diffraction peak for the {002} plane is higher than the intensity ratio of the diffraction peak for the {110} plane for the flat metal particle obtained by performing the mechanochemical treatment for 1 hour.

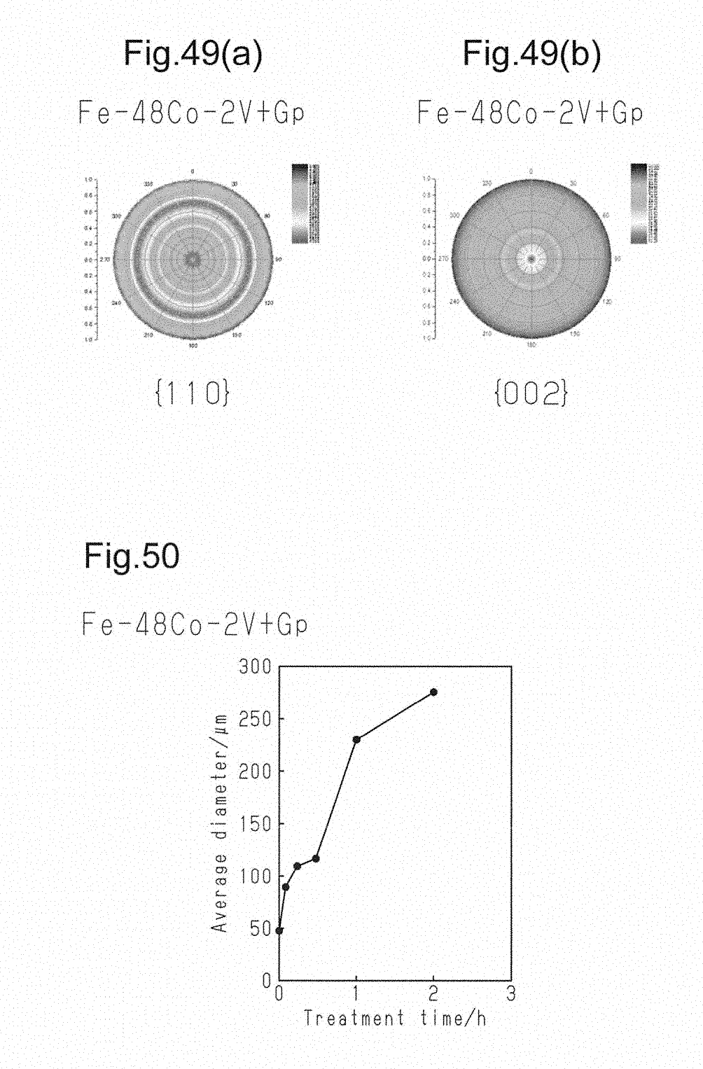

In addition, as shown in FIGS. 49(a) and 49(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 50, there is a tendency that the average particle diameter of a flat metal particle becomes large according to the treatment time until the mechanochemical treatment time reaches 2 hours.

### Example 13

Flat metal particles of ferrosilicon (Fe-3Si, manufactured by EPSON ATMIX Corporation, item number: 3.5% Si Steel Powder) were formed in the same manner as in Example 1. The amount of the graphite particle added into the centrifugal ball mill was 0.014 g. In Example 13, the properties of each flat metal particle obtained by changing the treatment time for the mechanochemical treatment were investigated.

As shown in FIG. 51, a flat metal particle obtained by performing the mechanochemical treatment for 1.0 hour has a flat surface. The flat metal particle has an aspect ratio of 134.1.

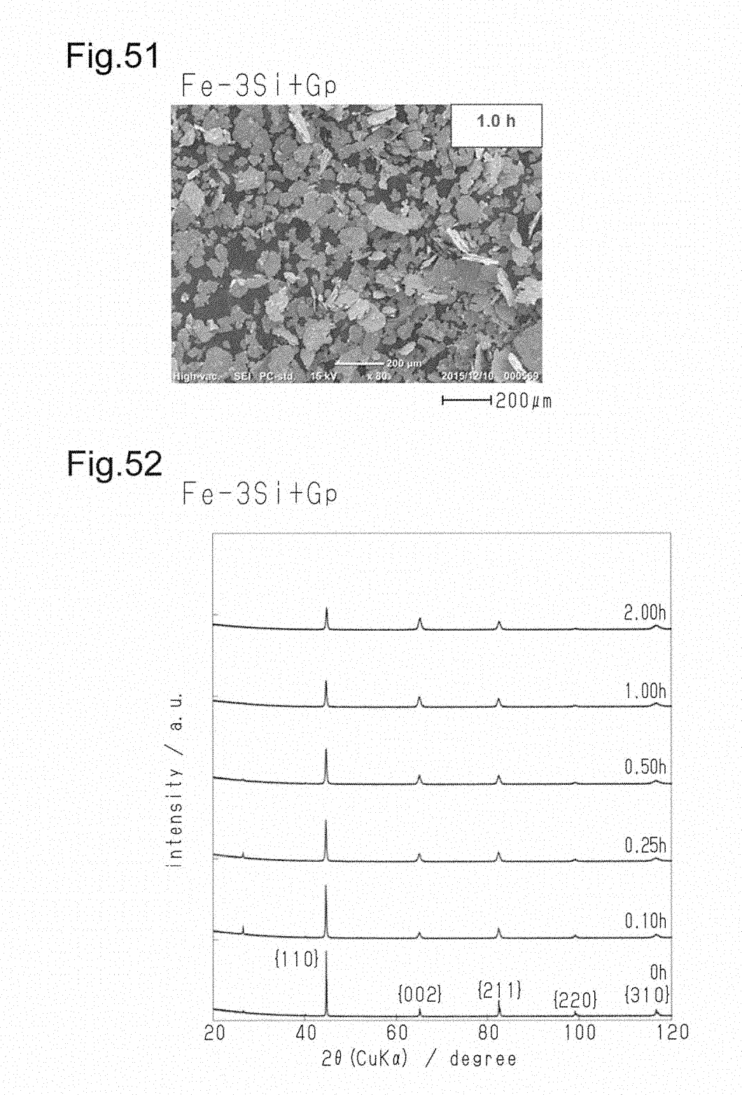

As shown in FIG. 52, the intensity ratio of the diffraction peak for the {002} plane for the flat metal particle obtained by performing the mechanochemical treatment for 1 hour is higher than that for the metal particle with the mechanochemical treatment time being 0 hours.

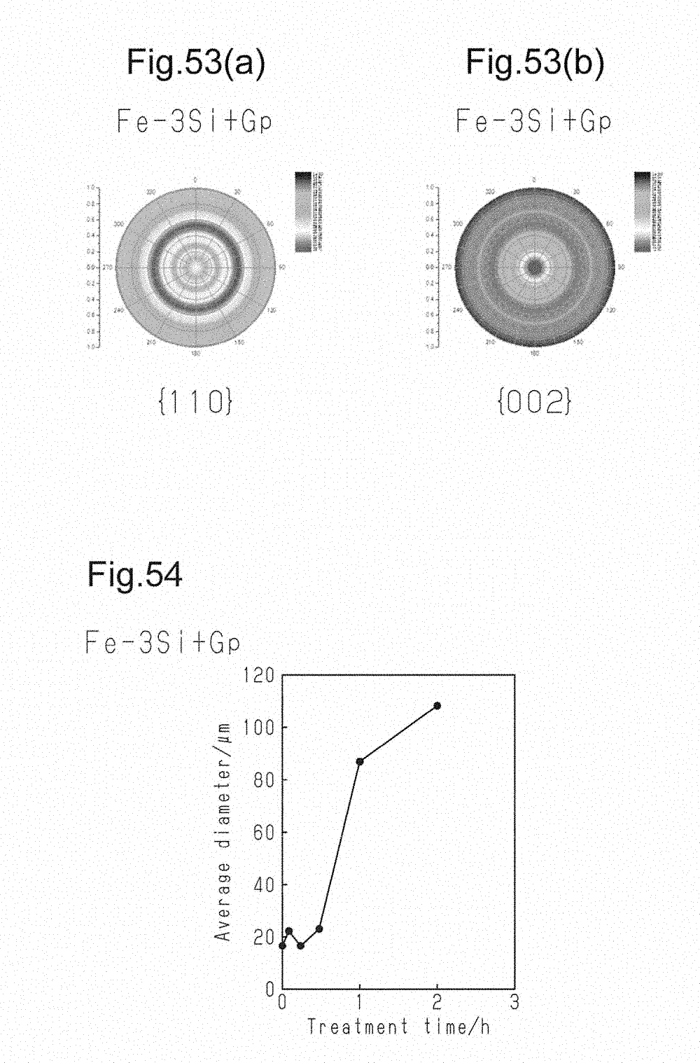

In addition, as shown in FIGS. 53(a) and 53(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 54, there is a tendency that the average particle diameter of a flat metal particle becomes large according to the treatment time until the mechanochemical treatment time reaches 2 hours.

### Example 14

Flat metal particles of a nickel iron alloy (Fe-47Ni, permalloy, manufactured by Daido Steel Co., Ltd., item number: Fe-47Ni) were formed in the same manner as in Example 1. The amount of the graphite particle added into the centrifugal ball mill was 0.014 g. In Example 14, the properties of each flat metal particle obtained by changing the treatment time for the mechanochemical treatment were investigated.

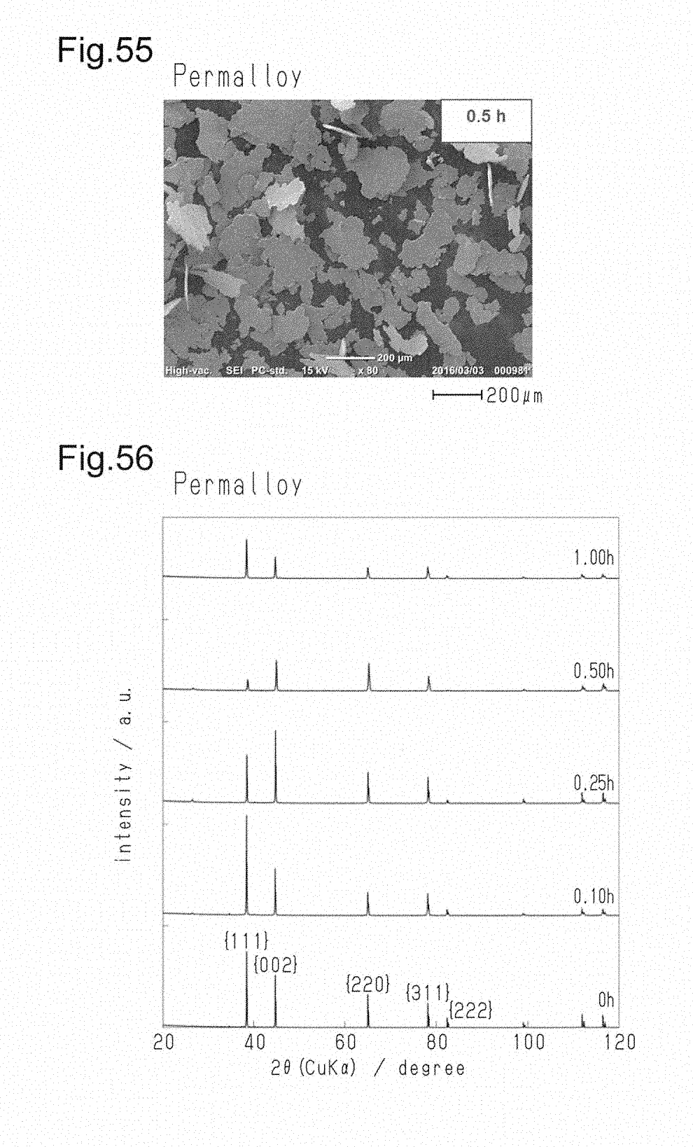

As shown in FIG. 55, a flat metal particle obtained by performing the mechanochemical treatment for 0.5 hours has a flat surface. The flat metal particle has an aspect ratio of 57.4.

As shown in FIG. 56, the intensity ratio of the diffraction peak for the {220} plane for the flat metal particle obtained by performing the mechanochemical treatment for 0.50 hours is higher than that for the metal particle with the mechanochemical treatment time being 0 hours.

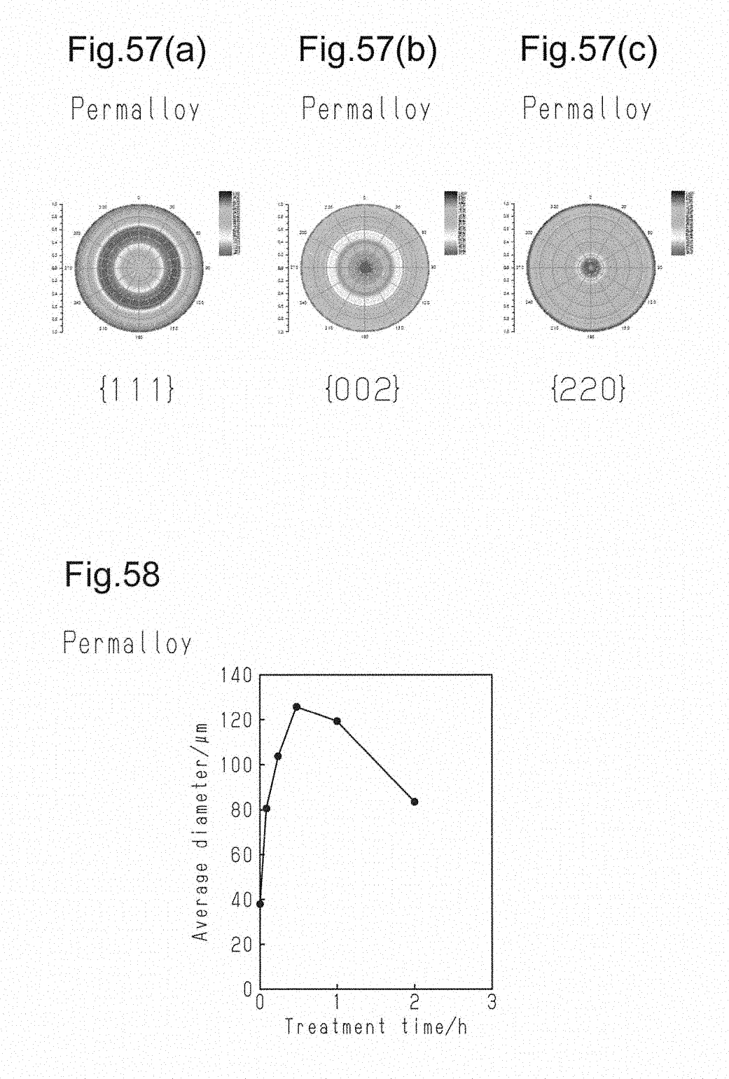

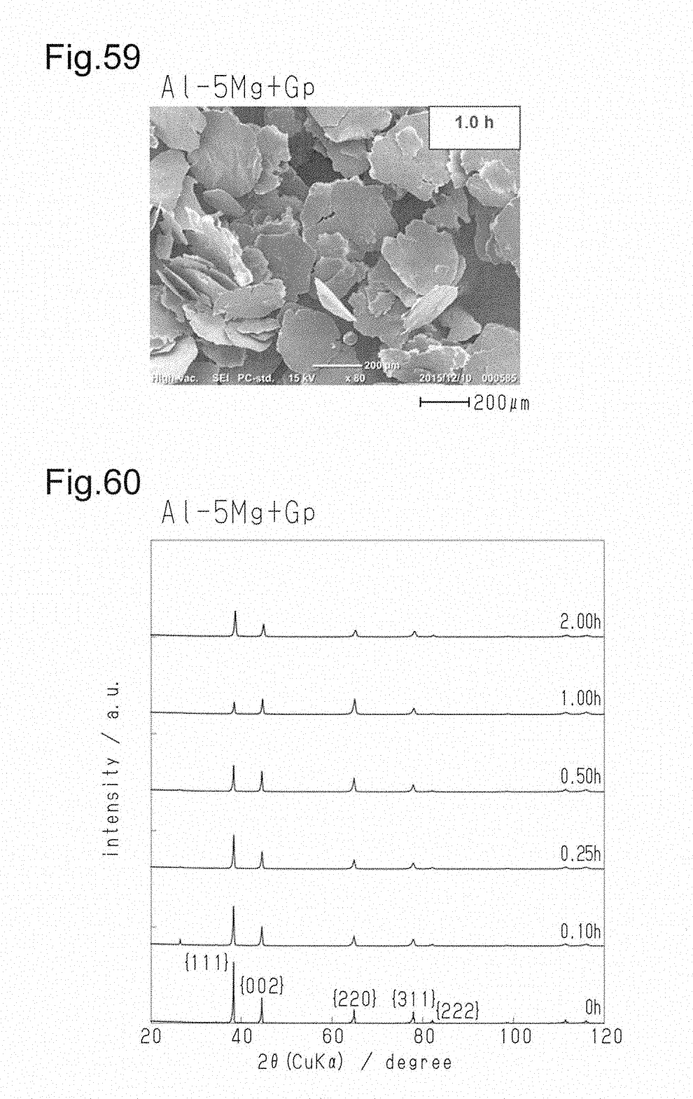

In addition, as shown in FIGS. 57(a), 57(b), and 57(c), the pole figure of the {111} plane, the pole figure of the {002} plane, and the pole figure of the {220} plane of the flat metal particle obtained by performing the mechanochemical treatment for 0.5 hours are concentric. That is, the texture is formed in the flat metal particle. As shown in FIG. 58, there is a tendency that the average particle diameter of a flat metal particle becomes large according to the treatment time until the mechanochemical treatment time reaches 0.25 hours, but when the mechanochemical treatment time exceeds 0.25 hours, there is a tendency that the average particle diameter of a flat metal particle becomes small according to the treatment time.

### Example 15

Flat metal particles of a magnesium-containing aluminum alloy (Al-5Mg, manufactured by HIKARI MATERIAL INDUSTRY CO., LTD., item number: Al-5Mg) were formed in the same manner as in Example 1. The amount of the graphite particle added into the centrifugal ball mill was 0.014 g. In Example 15, the properties of each flat metal particle obtained by changing the treatment time for the mechanochemical treatment were investigated.

As shown in FIG. 59, a flat metal particle obtained by performing the mechanochemical treatment for 1.0 hour has a flat surface. The flat metal particle has an aspect ratio of 488.7.

As shown in FIG. 60, the intensity ratio of the diffraction peak for the {220} plane for the flat metal particle obtained by performing the mechanochemical treatment for 1.00 hour is higher than that for the metal particle with the mechanochemical treatment time being 0 hours.

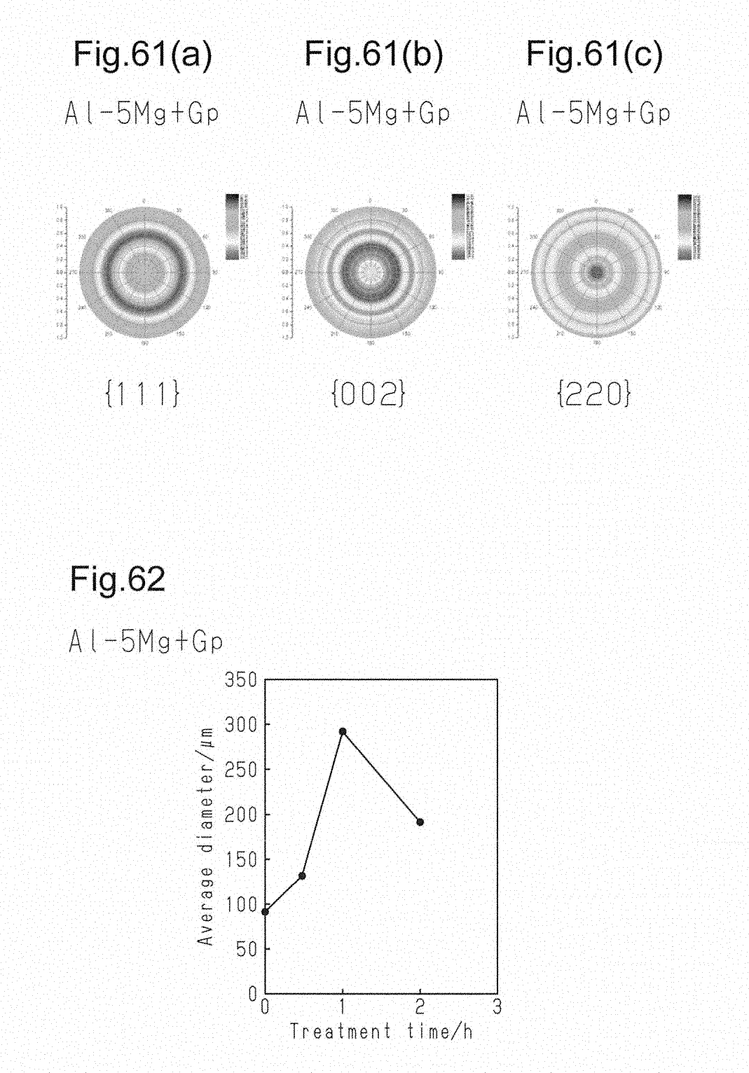

In addition, as shown in FIGS. 61(a), 61(b), and 61(c), the pole figure of the {111} plane, the pole figure of the {002} plane, and the pole figure of the {220} plane of the flat metal particle obtained by performing the mechanochemical treatment for 1.0 hour are concentric. That is, the texture is formed in the flat metal particle. As shown in FIG. 62, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of a flat metal particle becomes small according to the treatment time.

As understood from Example 12 to Example 15 (see FIGS. 47 to 62), the metal particle is texturized through the mechanochemical treatment in any of the iron alloy having the bcc structure, the iron alloy having the fcc structure, and the aluminum alloy having the fcc structure. It is to be noted that it is understood that the metal particle is texturized in the ferrosilicon-containing flat metal particle because the polar or belt-like intensity distribution is obtained in any of the pole figures even though the changes in the intensity ratio of each diffraction peak in the XRD chart are poorer than those of the flat metal particles of the bcc structure.

TABLE 4

| | Metal species | | | | Texturization aid | | | |
|---|---|---|---|---|---|---|---|---|
| | | | Average | | | Average | | |
| | | | particle | Amount | | particle | Amount | |
| | Main | Crystal | diameter | charged | | diameter | charged | |
| Example | component | structure | (um) | (mg) | | (um) | (mg) | Atmosphere |
| 1 | Fe | bcc | 39 | 2000 | Graphite | 10 | 17 | Air |
| 2 | Fe | | 39 | 2000 | Graphite | 10 | 14 | Air |
| 3 | V | | 35.1 | 2000 | Graphite | 10 | 14 | Air |
| 4 | Nb | | 152.3 | 2000 | Graphite | 10 | 14 | Air |
| 5 | Cu | fcc | 122.8 | 2000 | Graphite | 10 | 17 | Air |
| 6 | Cu | | 122.8 | 2000 | Graphite | 10 | 14 | Air |
| 7 | Al | | 62.1 | 2000 | Graphite | 10 | 14 | Air |
| 8 | Ni | | 64.3 | 2000 | Graphite | 10 | 14 | Air |
| 9 | Ti | hcp | 18.7 | 1000 | — | — | — | Air |
| 10 | Ti | | 18.7 | 2000 | — | — | — | Air |
| 11 | Zn | | 45 | 2000 | — | — | — | Air |
| 12 | Fe—CO | bcc | 45.1 | 2000 | Graphite | 10 | 14 | Air |
| 13 | Fe—Si | bcc | 16.6 | 2000 | Graphite | 10 | 14 | Air |
| 14 | Fe—Ni | fcc | 38.2 | 2000 | Graphite | 10 | 14 | Air |
| 15 | Al—Mg | fcc | 91.7 | 2000 | Graphite | 10 | 14 | Air |

| | Flat metal particle | | | | | | |
|---|---|---|---|---|---|---|---|
| | Average | | | | | | |
| | particle | | | Treatment | | | Rate |
| | diameter | | Aspect | time | Before | After | of |
| Example | (um) | Thickness | ratio | (hour) | treatment | treatment | change |
| | | | | Intensity change of diffraction peak at {002} | | | |
| 1 | 280.0 | 2.0 | 140.0 | 1 | 10.1 | 60.7 | 503.2 |
| 2 | 282.4 | 2.1 | 133.2 | 1 | 6.6 | 73.1 | 1007.6 |
| 3 | 292.3 | 0.59 | 492.0 | 0.5 | 11.7 | 47.3 | 304.3 |
| 4 | 292.3 | 1.37 | 213.3 | 0.25 | 23.4 | 64.6 | 176.1 |
| | | | | Intensity change of diffraction peak at {220} | | | |
| 5 | 78.0 | 1.0 | 78.0 | 1 | 11.2 | 18.7 | 68.4 |
| 6 | 110.3 | 0.4 | 277.9 | 0.25 | 20.1 | 22.6 | 12.4 |
| 7 | 902.6 | 0.8 | 1108.8 | 0.25 | 27.6 | 42.4 | 53.6 |
| 8 | 239.3 | 0.6 | 398.3 | 0.5 | 20.0 | 29.0 | 45.0 |
| | | | | Intensity change of diffraction peak at {0002} | | | |
| 9 | 58.0 | 7.0 | 8.0 | 1 | 14.8 | 36.6 | 147.0 |
| 10 | 106.4 | 6.4 | 16.6 | 1 | 16.7 | 41.6 | 149.1 |
| 11 | 244.0 | 1.80 | 135.6 | 0.5 | 16.5 | 21.3 | 29.1 |
| | | | | Intensity change of diffraction peak at {002} | | | |
| 12 | 273.3 | 1.4 | 195.2 | 1.0 | 9.0 | 62.5 | 594.4 |
| 13 | 107.3 | 0.8 | 134.1 | 2.0 | 8.0 | 35.6 | 345.0 |
| | | | | Intensity change of diffraction peak at {220} | | | |
| 14 | 127.0 | 2.2 | 57.4 | 0.25 | 20.4 | 31.5 | 54.4 |
| 15 | 293.2 | 0.6 | 488.7 | 0.5 | 22.3 | 34.8 | 56.1 |

### Example 16

The pure iron particle (manufactured by Kobe Steel, Ltd., item number: Atmel 300M) was put into the centrifugal ball mill (NEV-MA-8) to perform a mechanochemical treatment under the air atmosphere. As the treatment conditions, the amount of the pure iron particle charged into the centrifugal ball mill was 2.0 g, the amount of the graphite particle added was 0.017 g. An iron particle on which the mechanochemical treatment was performed without adding the graphite particle was also prepared for comparison. As the spherical medium, 20 steel balls (made of SUJ-2) with ϕ 9.52 mm were used to perform the treatment with a number of revolutions of 6.4 rps, and the treatment time (h) was set at 0.10, 025, 0.50, 1.00, 2.00, 4.00, and 8.00. In this case, the amount of the pure iron particle charged (volume ratio) is 0.00363, the amount of the graphite particle charged (volume ratio) is 0.00009, and the amount of the steel ball as the spherical medium charged (volume ratio) is 0.12786 to the inner volume of the mechanochemical treatment container in the centrifugal ball mill of 1.

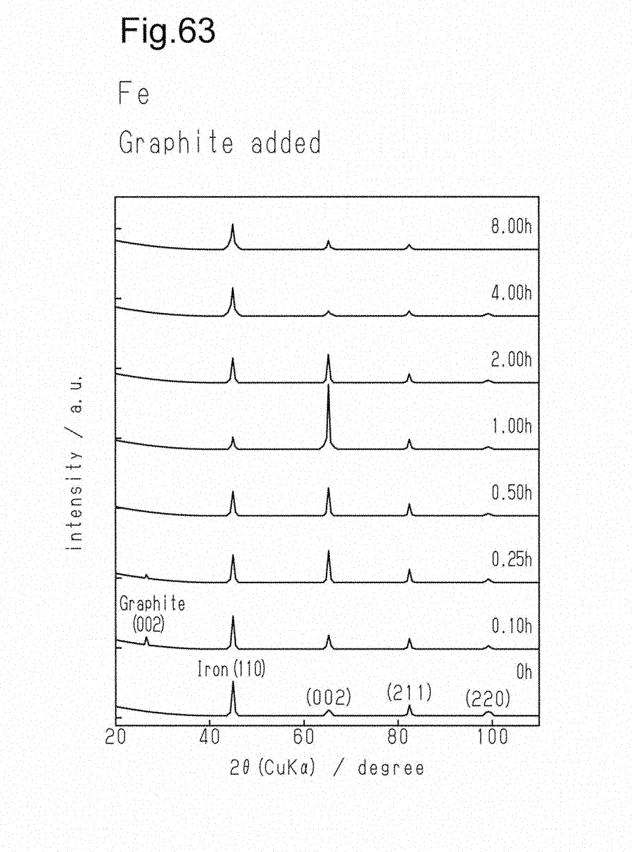

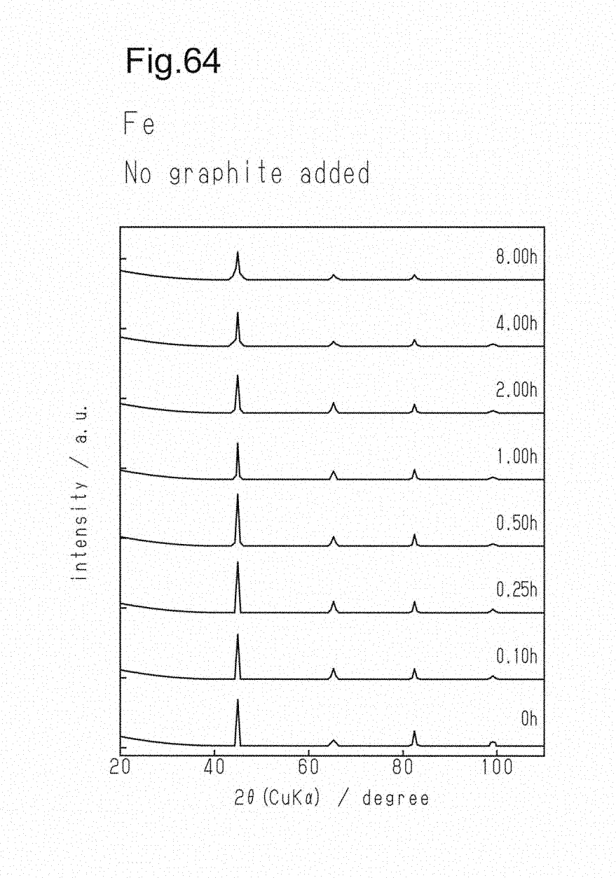

Flat iron particles similar to the flat iron particle of Example 1 were obtained through the mechanochemical treatment and was analyzed by the powder X-ray diffractometry to obtain XRD charts. The results are shown in FIGS. 63 and 64.

As shown in FIG. 63, according to the results, in the XRD charts of the iron particle on which the mechanochemical treatment was performed adding the graphite, the intensity ratio of the diffraction peak of each of a plurality of crystal planes changes as the treatment time becomes longer. From this fact, it is understood that the texture is formed in the iron particle.

On the other hand, as shown in FIG. 64, in the XRD charts of the iron particle on which the mechanochemical treatment was performed without adding the graphite, the intensity ratio of the diffraction peak of each of a plurality of crystal planes slightly changes as the treatment time becomes longer. From this fact, the texture slightly occurs in the iron particle.

The intensity ratio of each diffraction peak of the iron particle (Example 16) on which the mechanochemical treatment was performed adding the graphite at the treatment time of 1 h and of the iron particle (comparative example) on which the mechanochemical treatment was performed without adding the graphite at the treatment time of 1 h, the intensity ratios obtained when the sum of the intensities of the diffraction peaks of the 5 crystal planes from the low angle side of the iron particle is set to be 100%, are shown in Table 5.

Moreover, in Table 5, the rate of change in the intensity ratio of each diffraction peak based on the intensity ratio of each diffraction peak of the iron particle before the mechanochemical treatment is shown together for each of the iron particles (Example 16 and comparative example) on which the mechanochemical treatment was performed. When the rates of change in the intensity ratio of each diffraction peak are compared, the rate of change in intensity ratio of each diffraction peak for the iron particle (Example 16) on which the mechanochemical treatment was performed adding the graphite is larger than that for the iron particle (comparative example) on which the mechanochemical treatment was performed without adding the graphite. It was confirmed that in the example where the graphite is added, the rate of change shows an increase or decrease of 10% or more in any of the {110}, {002}, {211}, {220}, and {310} crystal planes (diffraction planes).

It is to be noted that in the comparative example where the graphite was not added, a rate of change in the intensity ratio of 10% or more was observed in the {002} crystal plane (diffraction plane), and a rate of change in the intensity ratio of −10% or more was observed in the {211}, {220}, and {310} crystal planes (diffraction planes), but the rate of change in the intensity ratio of the {110} crystal plane was −1.7%. It is understood that the orientation property in the texture is weak in the comparative example where such changes in the intensity ratios were observed.

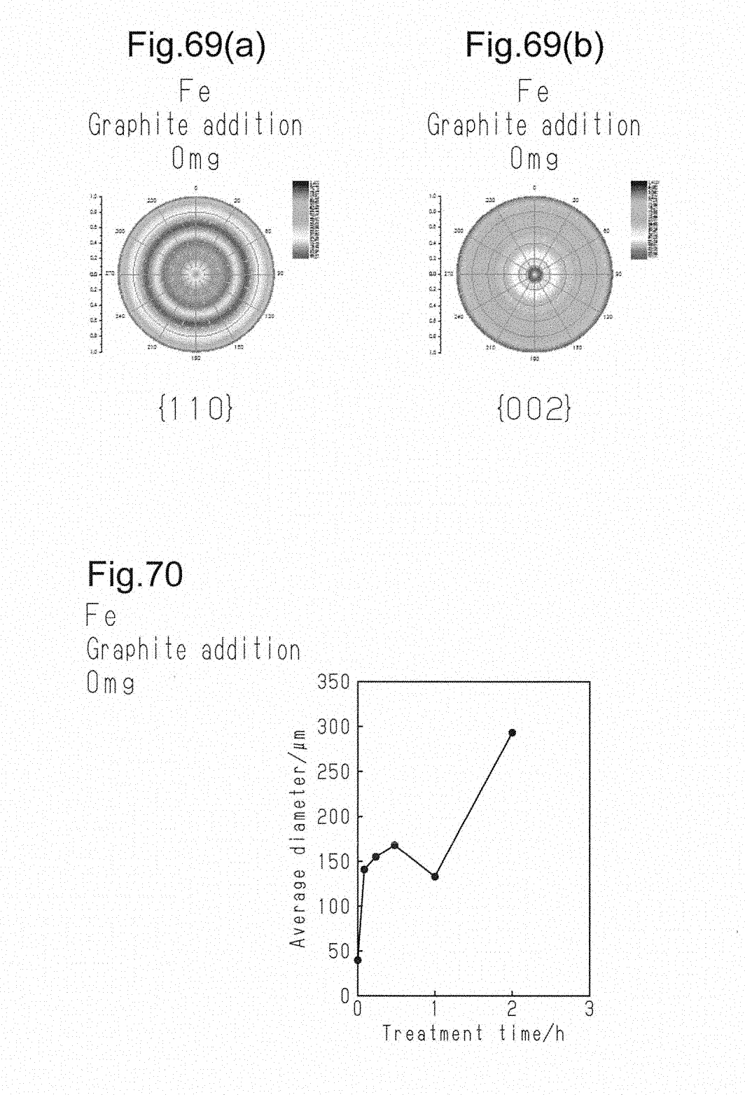

In FIGS. 65 and 66, the pole figures of the iron particles in the two examples where the above-described treatments were performed. These pole figures are pole figures of respective crystal planes of the flat metal particles obtained by performing the mechanochemical treatment for 1.0 hour. As shown in FIGS. 66(a) and 66(b), a random pattern is recognized in the pole figure of the iron particle on which the treatment was performed without adding the graphite, and therefore the texture is not formed. However, when the pole figures were measured precisely, it was found that even in the case where the mechanochemical treatment was performed on the iron particle without adding the graphite, the texturization occurred as shown in Example 17 (FIGS. 69 and 70), which will be described later. In the XRD charts, the change in the intensity ratio of each diffraction peak is poor. That is, it is considered that the texturization is smaller in the case where a mechanochemical treatment is performed without using the texturization aid than in the case where the mechanochemical treatment is performed using the texturization aid.

On the other hand, only a single pole was recognized in the center of the pole figure obtained by the diffraction peak for the {002} plane of the iron particle on which the treatment was performed adding the graphite as shown in FIG. 65(b), and a belt-like intensity distribution was recognized at a position of around 45° in the pole figure obtained by the diffraction peak for the {110} plane of the iron particle on which the treatment was performed adding the graphite as shown in FIG. 65(a). Thereby, it was confirmed that the texture in which the {001} plane and the flat surface are in parallel with each other are formed in the flat iron particle of Example 16.

In addition, it was confirmed that the iron particles are randomly orientated in the directions included in the {001} plane. From this fact, it was confirmed that the graphite is suitable as the texturization aid for obtaining the texture having a high orientation property.

TABLE 5

| | | | Rate of change in | |
|---|---|---|---|---|
| | | | intensity ratio of | |
| | | | diffraction peak based | |
| | Intensity ratio of | | on intensity ratio | |
| | diffraction peak (%) | | before treatment (%) | |
| Diffraction | Graphite | No Graphite | Graphite | No Graphite |
| plane | added | added | added | added |
| {110} | 30.4 | 48.7 | −38.7 | −1.7 |
| {002} | 36.5 | 16.9 | +261.4 | +67.8 |
| {211} | 14.5 | 15.0 | −15.8 | −12.7 |
| {220} | 7.1 | 8.3 | −30.3 | −18.2 |
| {310} | 11.5 | 11.1 | −11.7 | −14.9 |

### Example 17

Flat metal particles of pure iron were formed in the same manner as in Example 16 setting the amount of the graphite particle added as 0 mg (namely, without adding graphite particle). In Example 17, the properties of each flat metal particle obtained by changing the treatment time for the mechanochemical treatment were investigated.

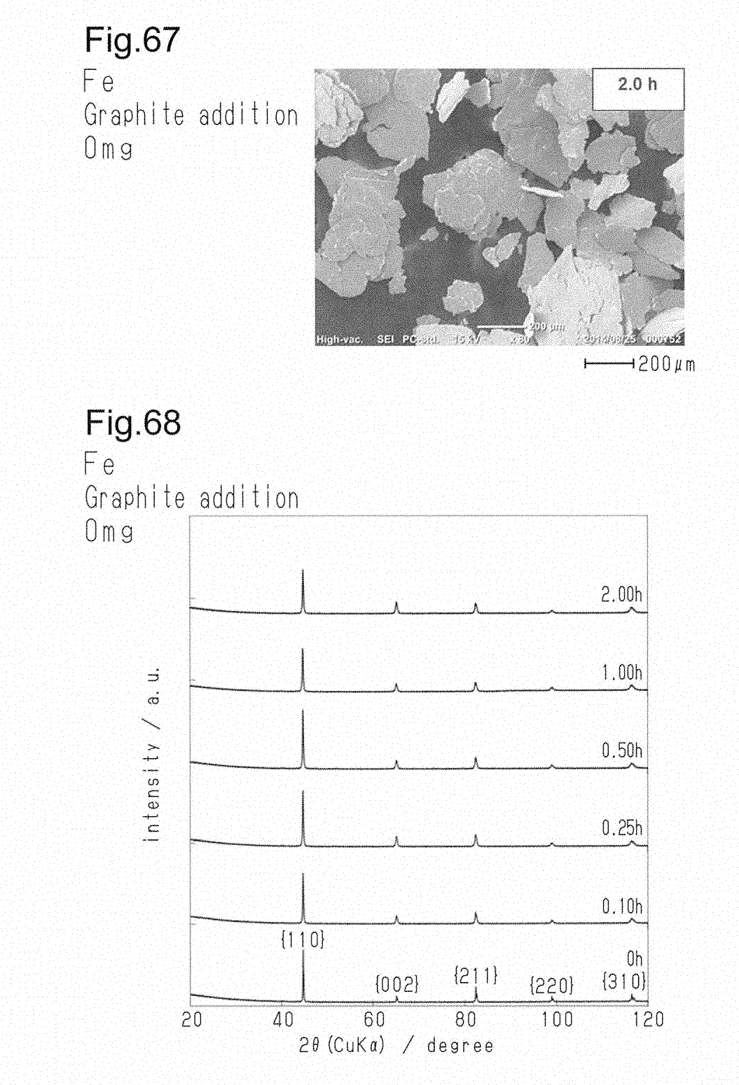

As shown in FIG. 67, a flat metal particle obtained by performing the mechanochemical treatment for 2 hours has a flat surface. The flat metal particle has an aspect ratio of 194.9.

As shown in FIG. 68, the intensity ratio of the diffraction peak for the {002} plane for the flat metal particle obtained by performing the mechanochemical treatment for 1 hour is higher than that for the metal particle with the mechanochemical treatment time being 0 hours.

In addition, as shown in FIGS. 69(a) and 69(b), the pole figure of the {110} plane and the pole figure of the {002} plane of the flat metal particle obtained by performing the mechanochemical treatment for 2.0 hours are concentric. That is, the texture is formed in the flat metal particle. As shown in FIG. 70, there is a tendency that the average particle diameter of a flat metal particle becomes large according to the treatment time until the mechanochemical treatment time reaches 2 hours.

### Example 18

Flat metal particles of pure iron were formed in the same manner as in Example 16 setting the amount of the graphite particle added as 2 mg. In Example 18, the properties of each flat metal particle obtained by changing the treatment time for the mechanochemical treatment were investigated.

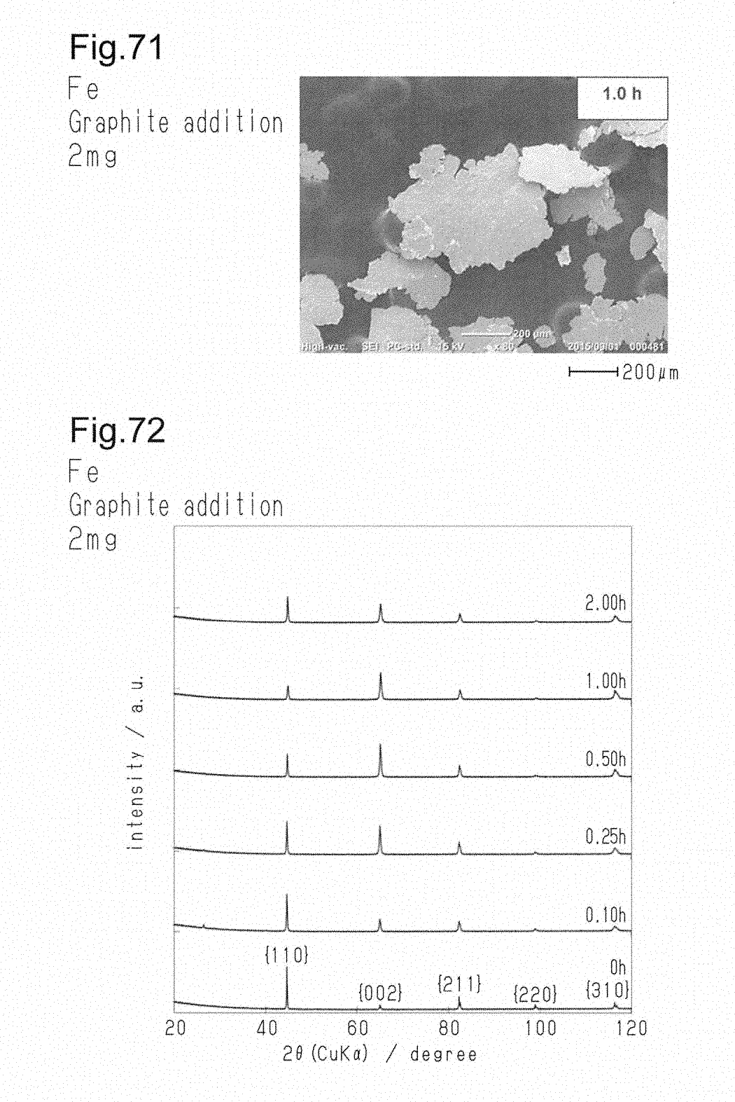

As shown in FIG. 71, a flat metal particle obtained by performing the mechanochemical treatment for 1 hour has a flat surface. The flat metal particle has an aspect ratio of 543.1.

As shown in FIG. 72, the intensity of the diffraction peak for the {002} plane is higher than the intensity of the diffraction peak for the {110} plane for a flat metal particle obtained by performing the mechanochemical treatment for 0.5 hours.

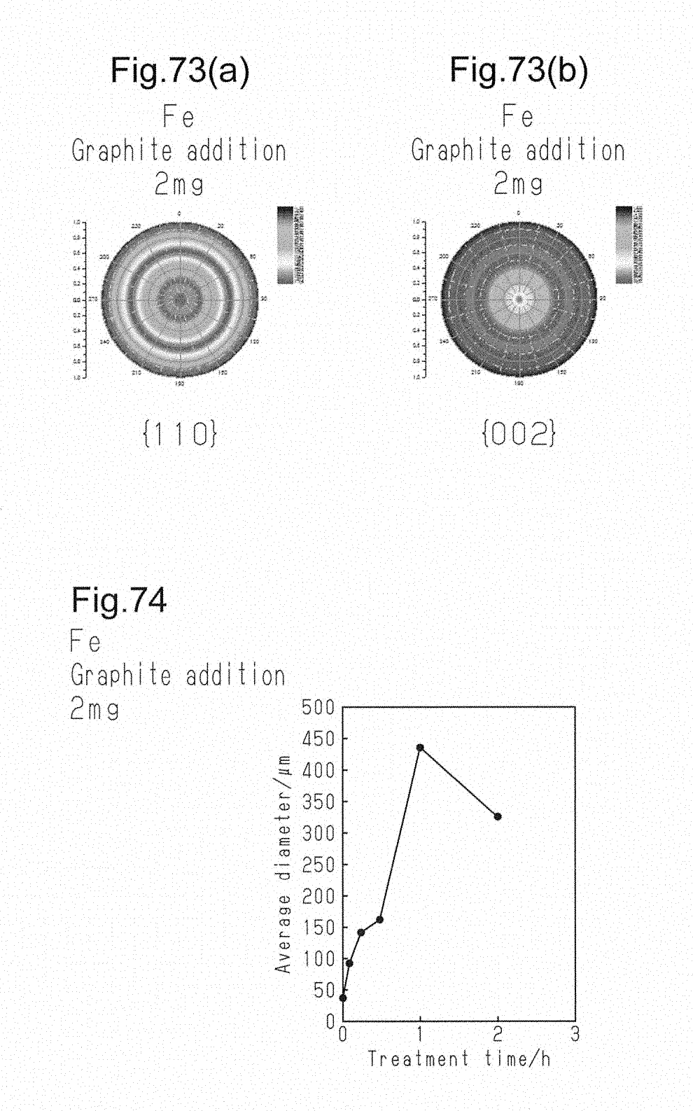

In addition, as shown in FIGS. 73(a) and 73(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 74, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of a flat metal particle becomes small according to the treatment time.

### Example 19

Flat metal particles of pure iron were formed in the same manner as in Example 16 setting the amount of the graphite particle added as 140 mg. In Example 19, the properties of each flat metal particle obtained by changing the treatment time for the mechanochemical treatment were investigated.

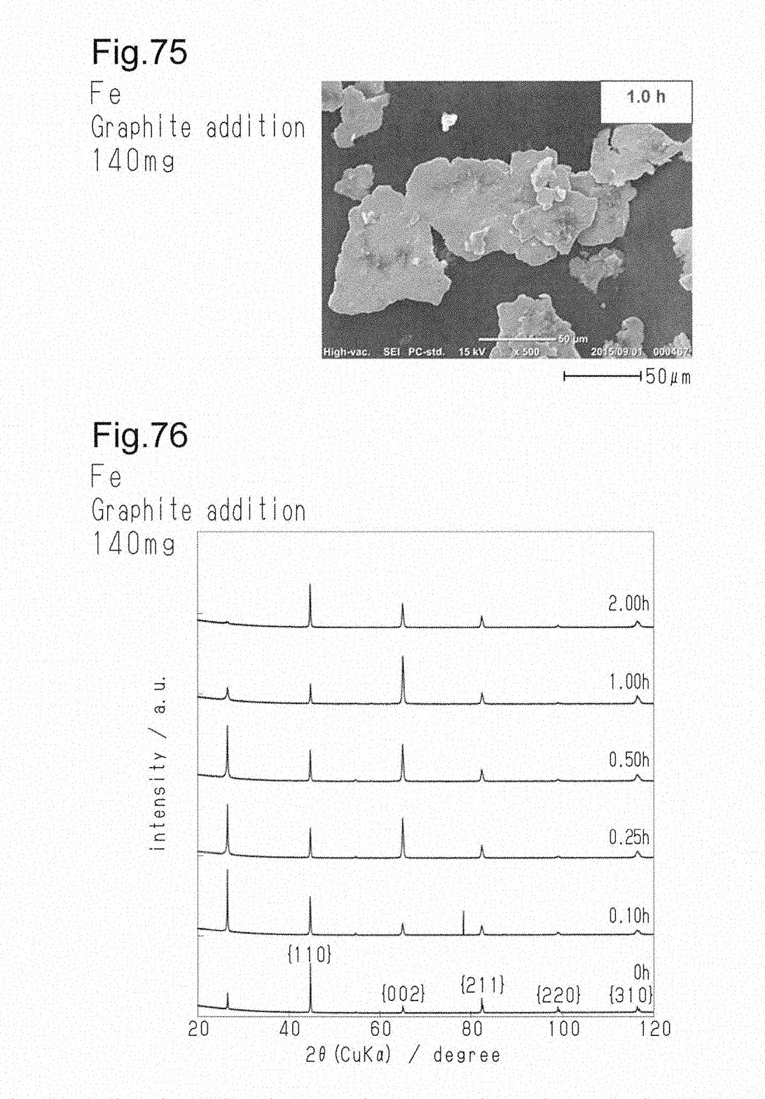

As shown in FIG. 75, a flat metal particle obtained by performing the mechanochemical treatment for 1.0 hour has a flat surface. The flat metal particle has an aspect ratio of 49.8.

As shown in FIG. 76, the intensity of the diffraction peak for the {002} plane is higher than the intensity of the diffraction peak for the {110} plane for a flat metal particle obtained by performing the mechanochemical treatment for 0.25 hours.

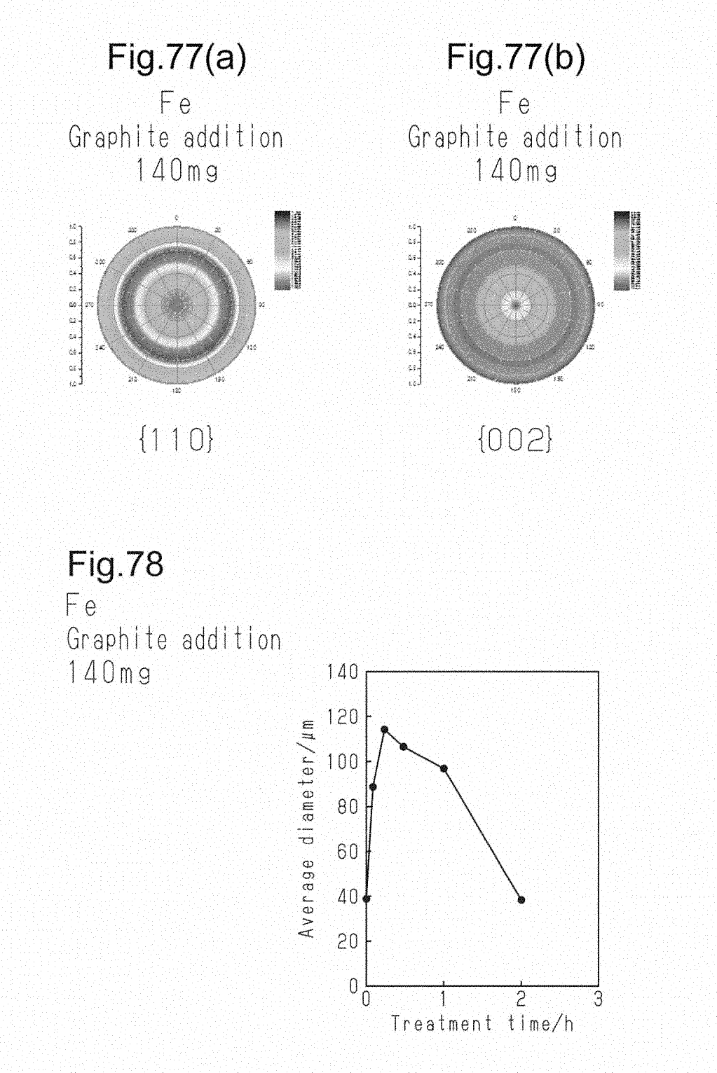

In addition, as shown in FIGS. 77(a) and 77(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 78, there is a tendency that the average particle diameter of a flat metal particle becomes large according to the treatment time until the mechanochemical treatment time reaches 0.25 hours, but when the mechanochemical treatment time exceeds 0.25 hours, there is a tendency that the average particle diameter of a flat metal particle becomes small according to the treatment time.

As understood from Example 16 to Example 19 (see FIGS. 63 to 78), when the graphite is used as the texturization aid, the texturization of aggregated metal particles are facilitated.

The texturization slightly occurs through the mechanochemical treatment even if the texturization aid is not used when compared with the case of the metal particle on which the mechanochemical treatment is not performed, but when the mechanochemical treatment is performed adding the graphite as the texturization aid, the texturization is facilitated greatly. The action of the graphite is not clear, but it is considered that the lubricating effect due to the graphite adhered to the surface of the metal particle facilitates the rearrangement of the metal crystals on the surface of the metal particle.

### Example 20

In Example 20, the texturization aid used in Example 1 is changed in the mechanochemical treatment. In Example 20 to Example 23, the property of facilitating the texturization was tested for texturization aids other than the graphite.

In Example 20, flat metal particles of pure iron were formed in the same manner as in Example 1 for the conditions excluding the texturization aid. As the texturization aid, carbon fiber (manufacturer: Toray Industries, Inc., type; MLD 300, amount added of 14 mg) was used. Moreover, the properties of each flat metal particle obtained by changing the treatment time for the mechanochemical treatment were investigated.

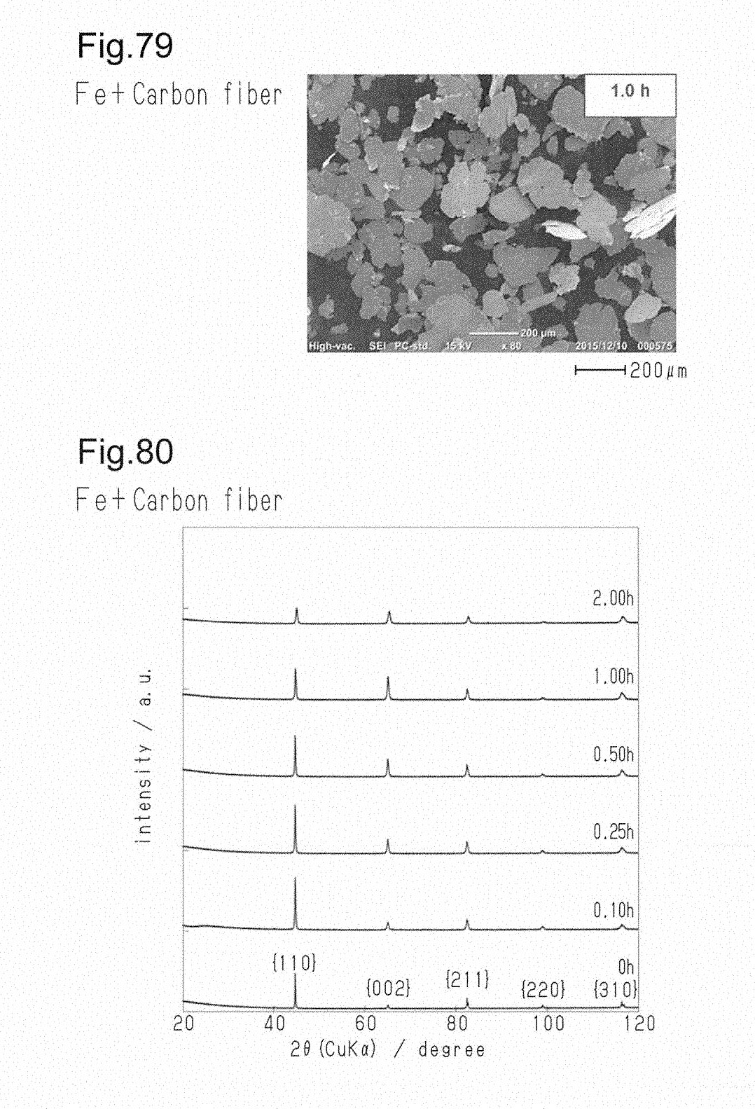

As shown in FIG. 79, a flat metal particle obtained by performing the mechanochemical treatment for 1 hour has a flat surface. The flat metal particle has an aspect ratio of 184.7.

As shown in FIG. 80, the intensity ratio of the diffraction peak for the {002} plane for the flat metal particle obtained by performing the mechanochemical treatment for 1 hour is higher than that for the metal particle with the mechanochemical treatment time being 0 hours.

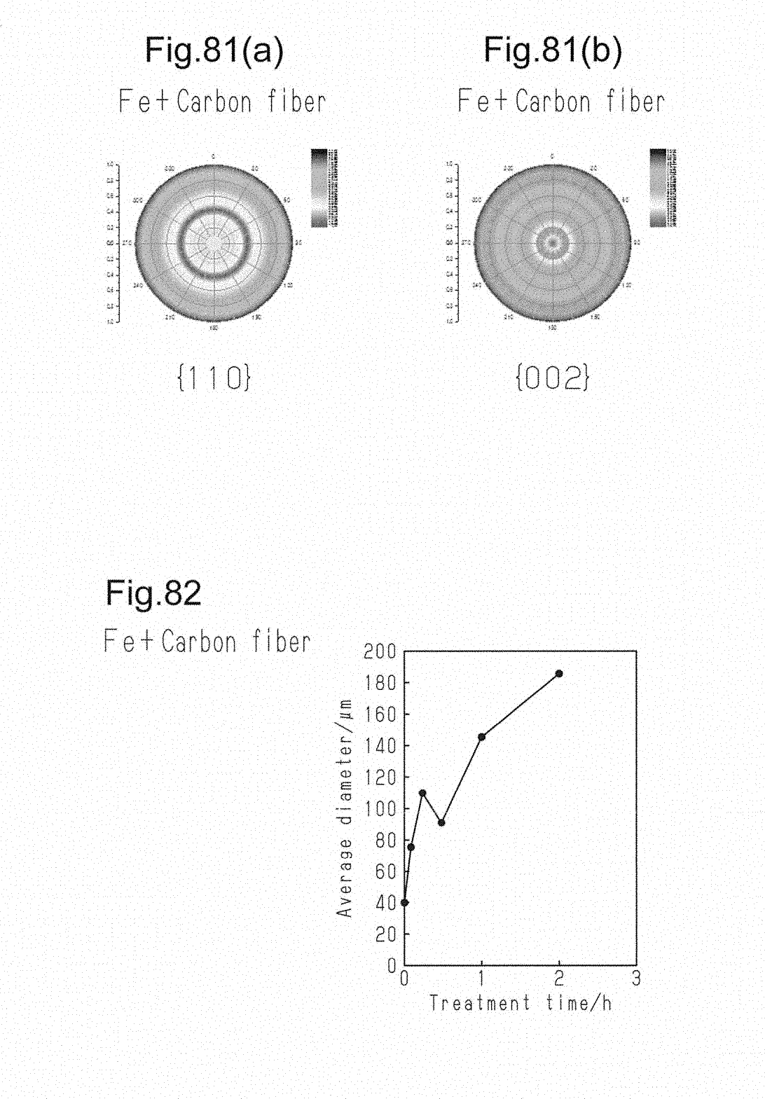

In addition, as shown in FIGS. 81(a) and 81(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 82, there is a tendency that the average particle diameter of a flat metal particle becomes large according to the treatment time until the mechanochemical treatment time reaches 2 hours.

### Example 21

In Example 21, the texturization aid used in Example 1 is changed in the mechanochemical treatment.

Flat metal particles of pure iron were formed in the same manner as in Example 1 for the conditions excluding the texturization aid. As the texturization aid, PTFE (SEISHIN ENTERPRISES CO., LTD., type; TFW-3000F, amount added of 14 mg) was used. In Example 21, the properties of each flat metal particle obtained by changing the treatment time for the mechanochemical treatment were investigated.

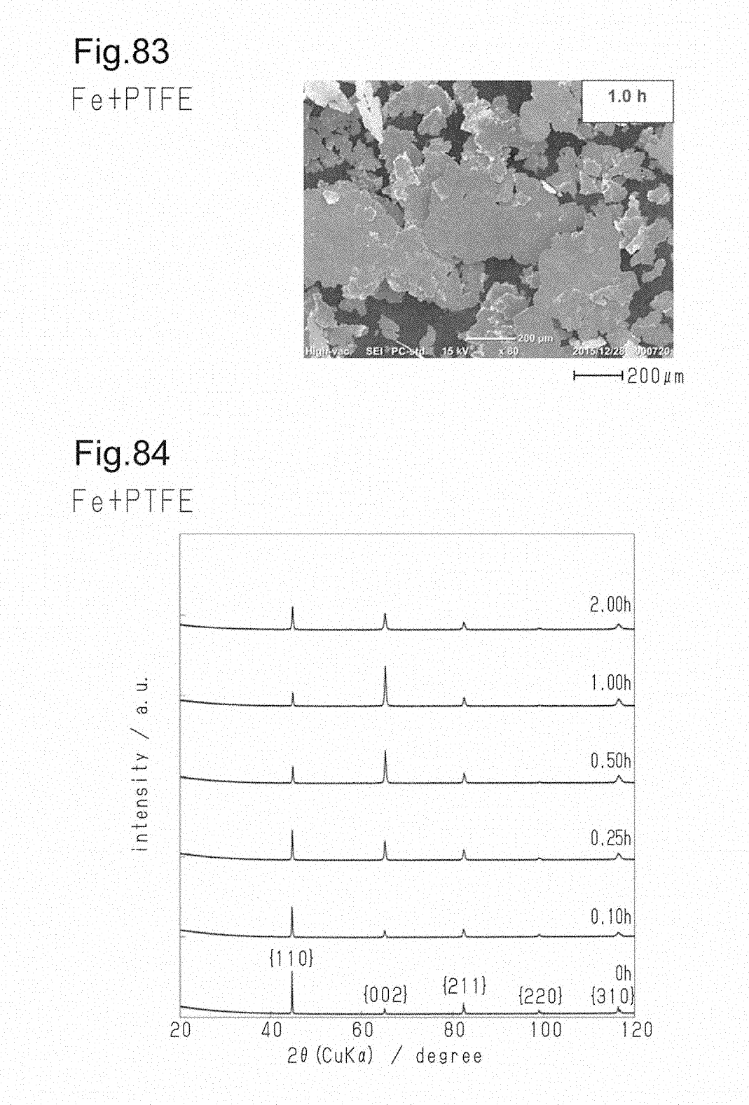

As shown in FIG. 83, a flat metal particle obtained by performing the mechanochemical treatment for 1 hour has a flat surface. The flat metal particle has an aspect ratio of 273.3.

As shown in FIG. 84, the intensity of the diffraction peak for the {002} plane is higher than the intensity of the diffraction peak for the {110} plane for a flat metal particle obtained by performing the mechanochemical treatment for 0.5 hours.

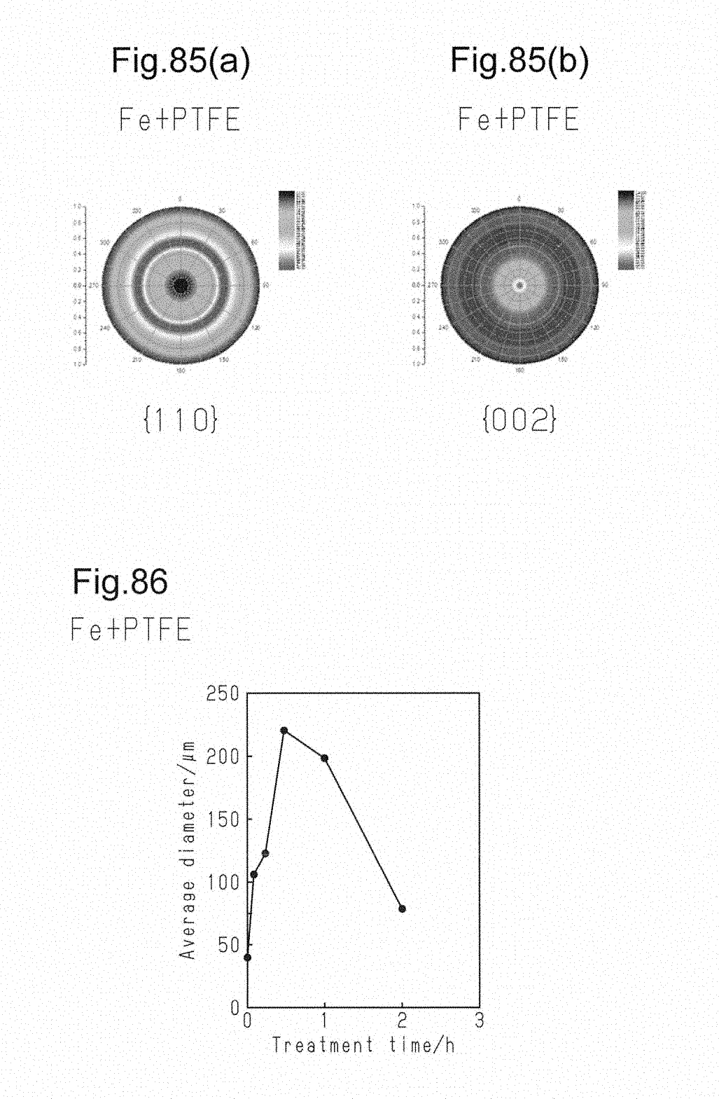

In addition, as shown in FIGS. 85(a) and 85(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 86, there is a tendency that the average particle diameter of a flat metal particle becomes large according to the treatment time until the mechanochemical treatment time reaches 0.5 hours, but when the mechanochemical treatment time exceeds 0.5 hours, there is a tendency that the average particle diameter of the flat metal particle becomes small according to the treatment time.

### Example 22

In Example 22, the texturization aid used in Example 1 is changed in the mechanochemical treatment.

Flat metal particles of pure iron were formed in the same manner as in Example 1 for the conditions excluding the texturization aid. As the texturization aid, a mineral oil (KURE Engineering Ltd., type; 5-56, amount added of 10 ml) was used. In Example 22, the properties of each flat metal particle obtained by changing the treatment time for the mechanochemical treatment were investigated. It is to be noted that the mineral oil dissolves in an alcohol and therefore can be removed from the flat metal particle easily in the case where the mineral oil is used as the texturization aid.

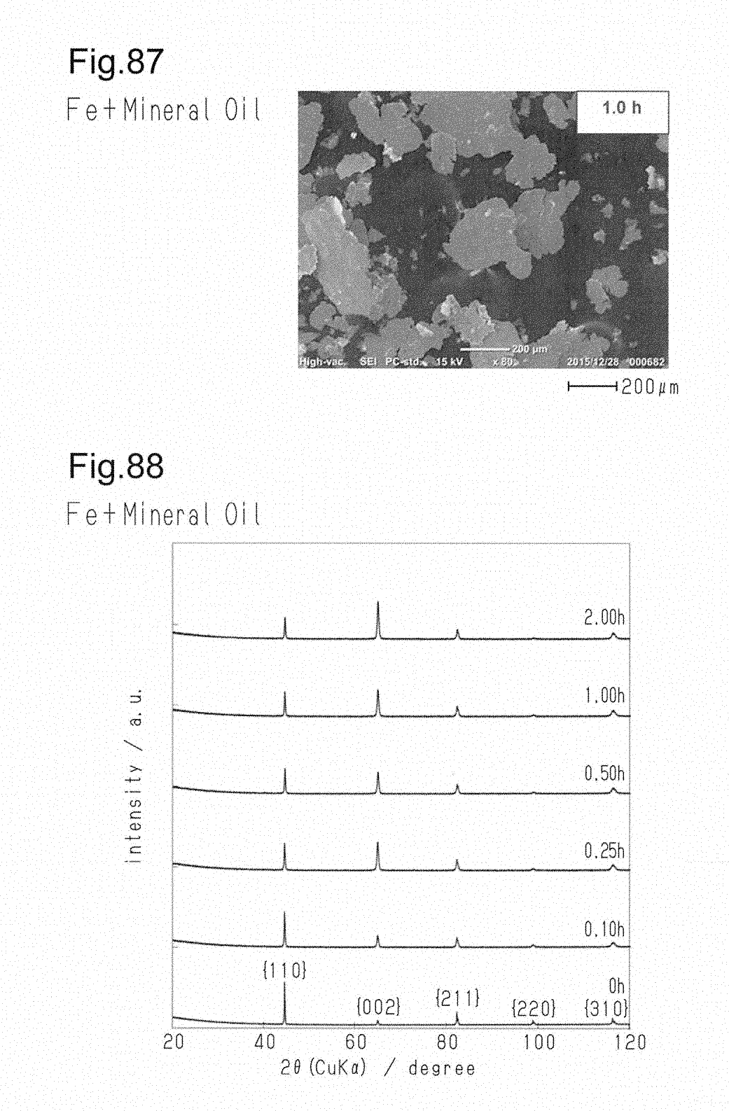

As shown in FIG. 87, a flat metal particle obtained by performing the mechanochemical treatment for 1 hour has a flat surface. The flat metal particle has an aspect ratio of 20.5.

As shown in FIG. 88, the intensity of the diffraction peak for the {002} plane is higher than the intensity of the diffraction peak for the {110} plane for the flat metal particle obtained by performing the mechanochemical treatment for 1.0 hour.

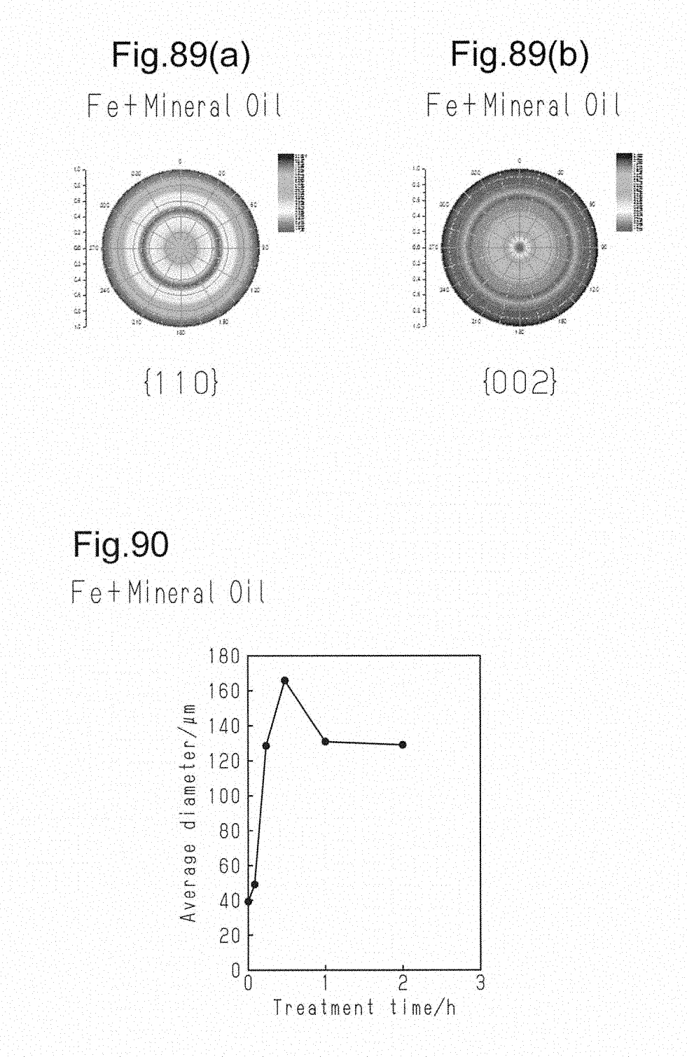

In addition, as shown in FIGS. 89(a) and 89(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 90, there is a tendency that the average particle diameter of a flat metal particle becomes large according to the treatment time until the mechanochemical treatment time reaches 0.5 hours, but when the mechanochemical treatment time exceeds 0.5 hours, there is a tendency that the average particle diameter of a flat metal particle becomes small according to the treatment time.

### Example 23

In Example 23, the texturization aid used in Example 1 is changed in the mechanochemical treatment.

Flat metal particles of pure iron were formed in the same manner as in Example 1 for the conditions excluding the texturization aid. As the texturization aid, molybdenum disulfide (STREM CHEMICALS, type; 93-4247, amount added of 14 mg), which is a non-carbon-based substance, was used. In Example 23, the properties of each flat metal particle obtained by changing the treatment time for the mechanochemical treatment were investigated.

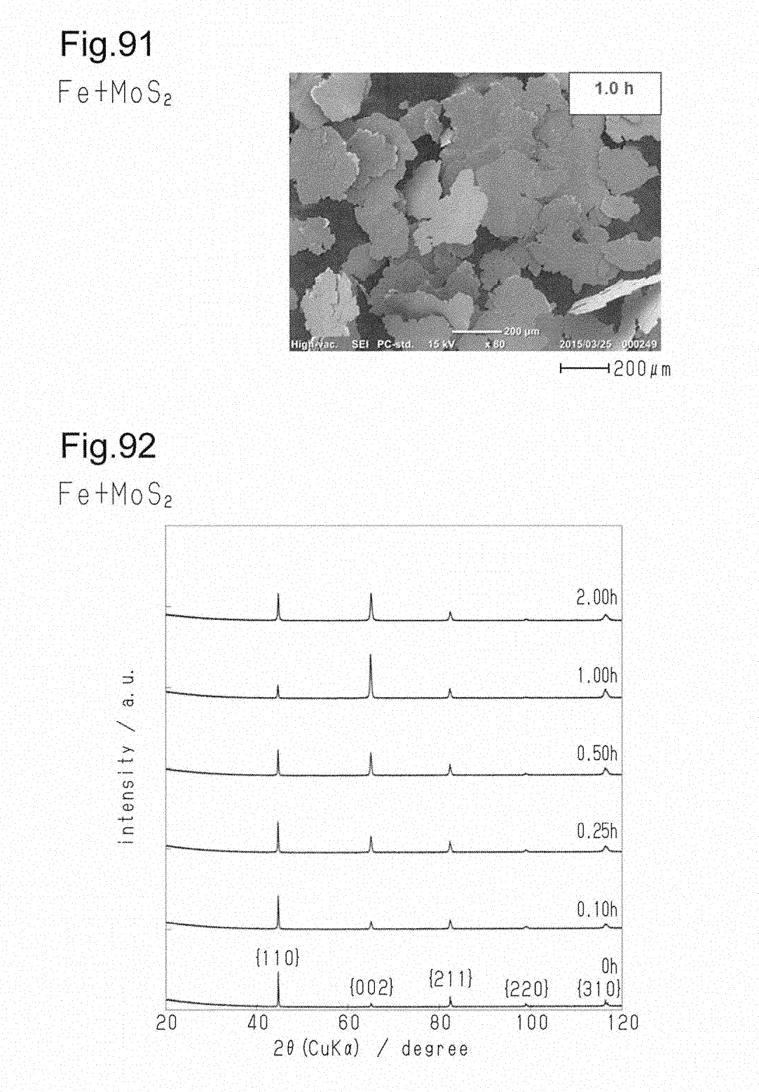

As shown in FIG. 91, a flat metal particle obtained by performing the mechanochemical treatment for 1 hour has a flat surface. The flat metal particle has an aspect ratio of 405.6.

As shown in FIG. 92, the intensity of the diffraction peak for the {002} plane is higher than the intensity of the diffraction peak for the {110} plane for the flat metal particle obtained by performing the mechanochemical treatment for 1.0 hour.

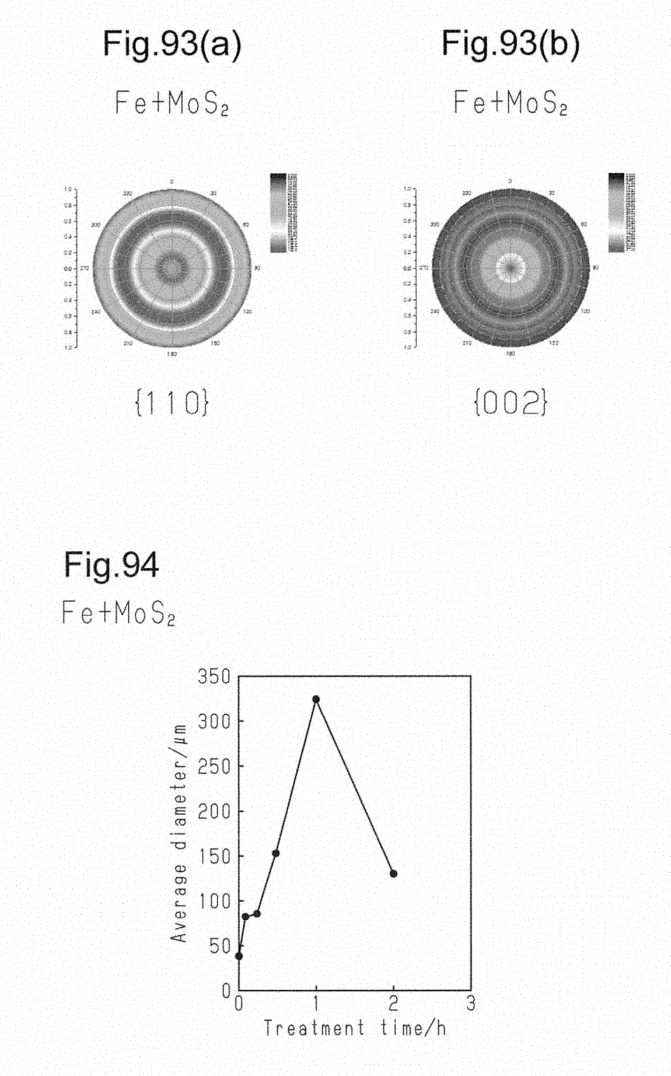

In addition, as shown in FIGS. 93(a) and 93(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 94, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of the flat metal particle becomes small according to the treatment time.

As understood from Example 20 to Example 23 (see FIGS. 79 to 94), not only the graphite but also carbon-containing lubricants can be used as the texturization aid, and the texturization of a metal particle is also more facilitated by these than in the case where the texturization aid is not used. In addition, as understood from Example 23, a lubricant not containing carbon can be used as the texturization aid, and the texturization of a metal particle is also more facilitated by this substance than in the case where the texturization aid is not used.

### Example 24

In Example 24, the atmosphere in the mechanochemical treatment is changed from the example (air atmosphere) of Example 1.

The pure iron particle (manufactured by Kobe Steel, Ltd., item number: Atmel 300M) and the graphite particle (manufactured by Nippon Graphite Industries, Co., Ltd., trade name: UCP) were put into the centrifugal ball mill (NEV-MA-8) to perform mechanochemical treatments under an oxygen atmosphere and under argon atmosphere.

Hereinafter, the example where the mechanochemical treatment was performed under the oxygen atmosphere is referred to as Example 24-1, and the example where the mechanochemical treatment was performed under the argon atmosphere is referred to as Example 24-2.

As the treatment conditions, the amount of the pure iron particle charged into the centrifugal ball mill was 2.0 g, the amount of the graphite particle charged was 0.017 g, 20 steel balls (made of SUJ-2) with ϕ 9.52 mm were used as the spherical medium, the number of revolutions was 6.4 rps, and treatment time was 1 h. In this case, the amount of the pure iron particle charged (volume ratio) is 0.00363, the amount of the graphite particle charged (volume ratio) is 0.00009, and the amount of the steel ball as the spherical medium charged (volume ratio) is 0.12786 to the inner volume of the treatment container in the centrifugal ball mill of 1.

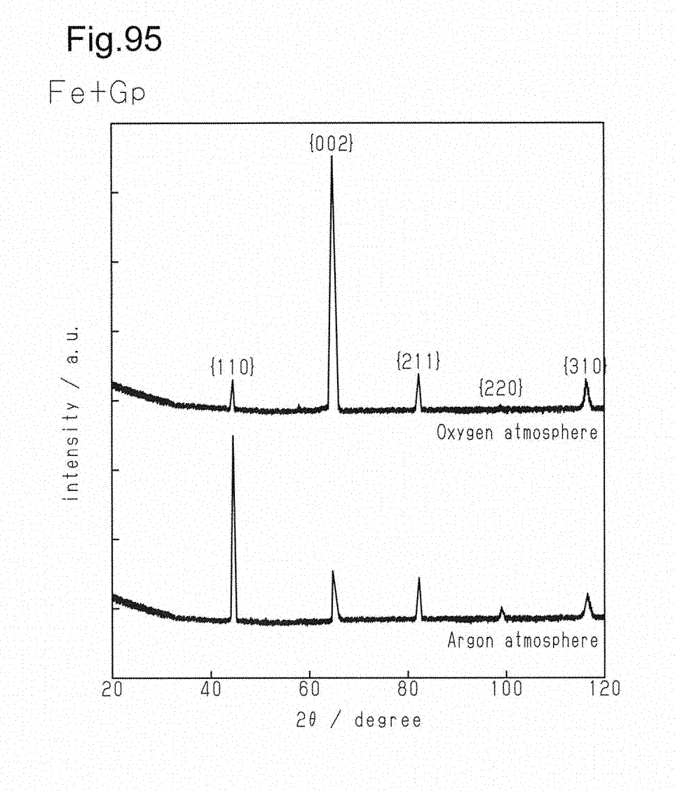

Iron particles each having a flat shape, the iron particles similar to the iron particle of Example 1 were obtained in Example 24-1 and Example 24-2. These were analyzed by the powder X-ray diffractometry to obtain XRD charts. The results are shown in FIG. 95.

In addition, the intensity ratio of each diffraction peak of the iron particle (Example 24-2) treated under the argon atmosphere and of the iron particle (Example 24-1) treated under the oxygen atmosphere, the intensity ratios obtained when the sum of the intensities of the diffraction peaks of the 5 crystal planes from the low angle side of each iron particle is set to be 100%, are shown in Table 6.

In Table 6, the rate of change in the intensity ratio of each diffraction peak based on the intensity ratio of each diffraction peak of the iron particle before the mechanochemical treatment (numerical value before mechanochemical treatment in Table 1) is shown together for each iron particle on which the mechanochemical treatment was performed.

When the changes in the intensity ratio of each diffraction peak are compared between Example 24-1 and Example 24-2, the change in the intensity ratio of each diffraction peak is larger for the iron particle treated in the oxygen atmosphere (Example 24-2) than the iron particle treated in the argon atmosphere (Example 24-2).

It was confirmed from this fact that oxygen is suitable as an atmosphere of the treatment for obtaining the texture in which the orientation property is particularly strong as understood from Example 24-1. Moreover, it was confirmed in Example 24-1 that the effect of enhancing the orientation property due to oxygen is not impaired by mixing of other gas molecules such as nitrogen, carbon dioxide, and water vapor from the comparison with the XRD chart of the iron particle treated in the air atmosphere, which is shown in Example 1.

However, a change in the intensity of 10% or more is observed in the {002}, {211}, and {220} crystal planes as understood from Table 6, and therefore it is understood that the texture having an orientation property is also obtained in Example 24-2.

TABLE 6

| | | | Rate of change in | |
|---|---|---|---|---|
| | | | intensity ratio of | |
| | | | diffraction peak based | |
| | Intensity ratio of | | on intensity ratio | |
| | diffraction peak (%) | | before treatment (%) | |
| Diffraction | Argon | Oxygen | Argon | Oxygen |
| plane | atmosphere | atmosphere | atmosphere | atmosphere |
| {110} | 47.9 | 16.0 | −3.3 | −67.8 |
| {002} | 16.6 | 56.3 | +65.2 | +459.9 |
| {211} | 15.0 | 11.4 | −12.7 | −33.6 |
| {220} | 8.2 | 6.6 | −19.2 | −34.9 |
| {310} | 12.3 | 9.7 | −6.2 | −25.8 |

### Example 25

In Example 25, the mechanochemical treatment is performed in the oxygen atmosphere in the same manner as in Example 24-1. Specifically, the mechanochemical treatment was performed in the oxygen atmosphere (99.9%, condensation pressure of 1013 hPa) to form flat metal particles of pure iron. The conditions excluding the atmosphere in the mechanochemical treatment were the same as in Example 1. In Example 25, the properties of each flat metal particle obtained by changing the treatment time for the mechanochemical treatment were investigated.

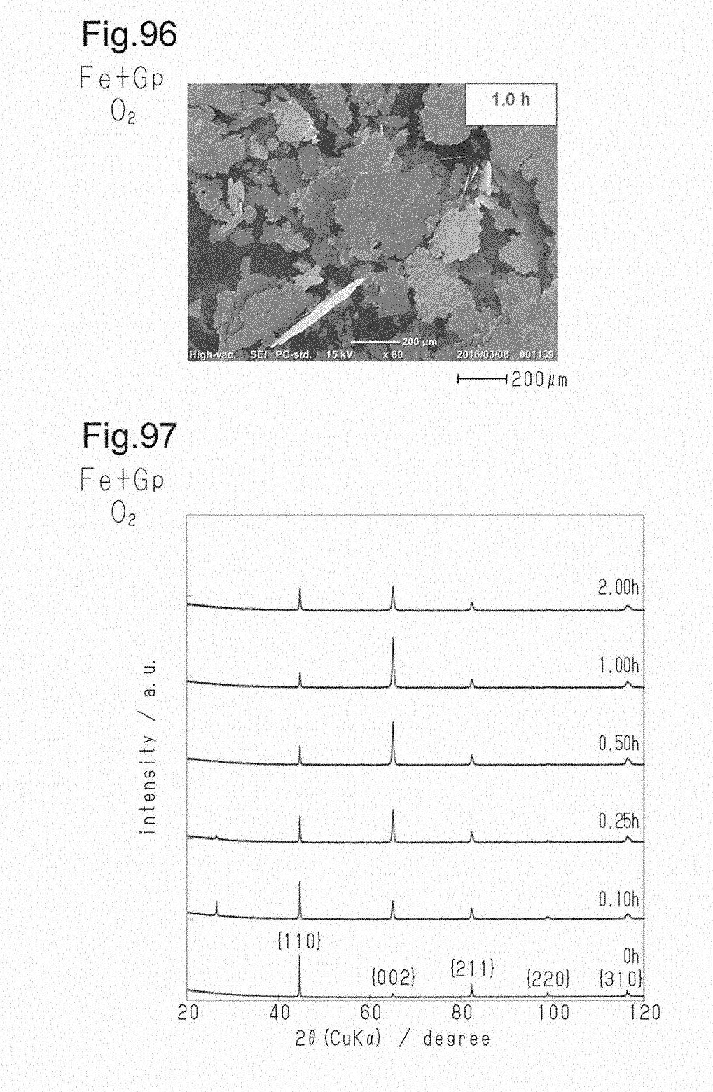

As shown in FIG. 96, a flat metal particle obtained by performing the mechanochemical treatment for 1 hour has a flat surface. The flat metal particle has an aspect ratio of 283.9.

As shown in FIG. 97, the intensity of the diffraction peak for the {002} plane is higher than the intensity of the diffraction peak for the {110} plane for a flat metal particle obtained by performing the mechanochemical treatment for 0.25 hours.

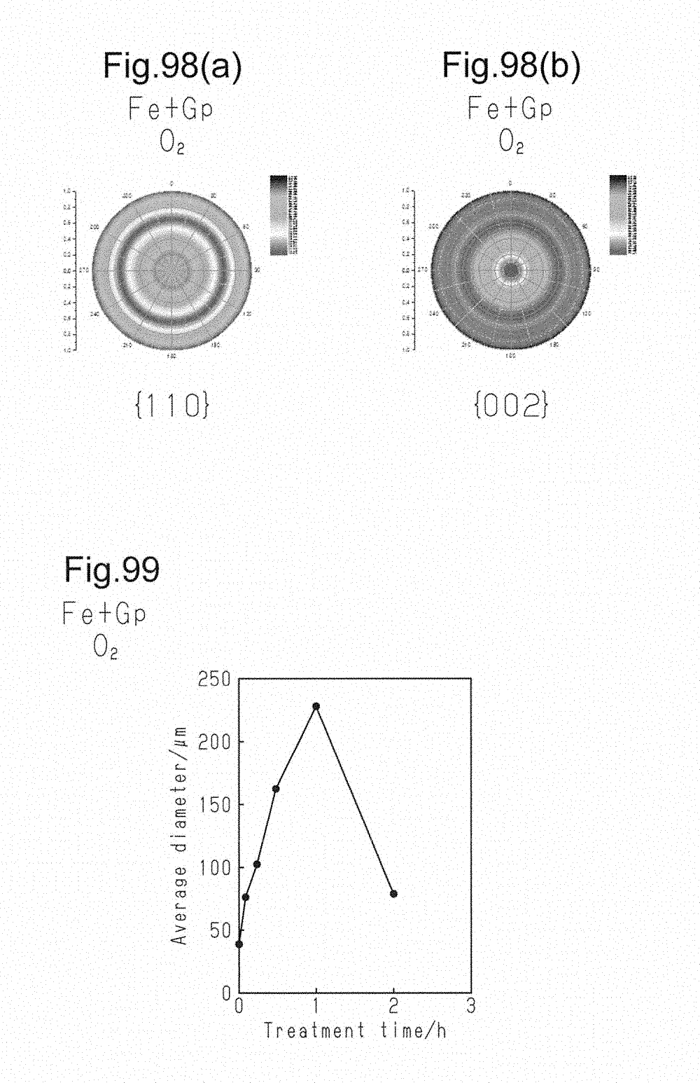

In addition, as shown in FIGS. 98(a) and 98(b), the pole figure of the {110} plane and the pole figure of the {002} plane of the flat metal particle obtained by performing the mechanochemical treatment for 1.0 hour are concentric. That is, the texture is formed in the flat metal particle. As shown in FIG. 99, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of the flat metal particle becomes small according to the treatment time.

### Example 26

In Example 26, the atmosphere in the mechanochemical treatment is changed from the example (air atmosphere) of Example 1.

Specifically, the mechanochemical treatment was performed in a nitrogen atmosphere (99.9%, condensation pressure of 1013 hPa) to form flat metal particles of pure iron. The conditions excluding the atmosphere in the mechanochemical treatment were the same as in Example 1. In Example 26, the properties of each flat metal particle obtained by changing the treatment time for the mechanochemical treatment were investigated.

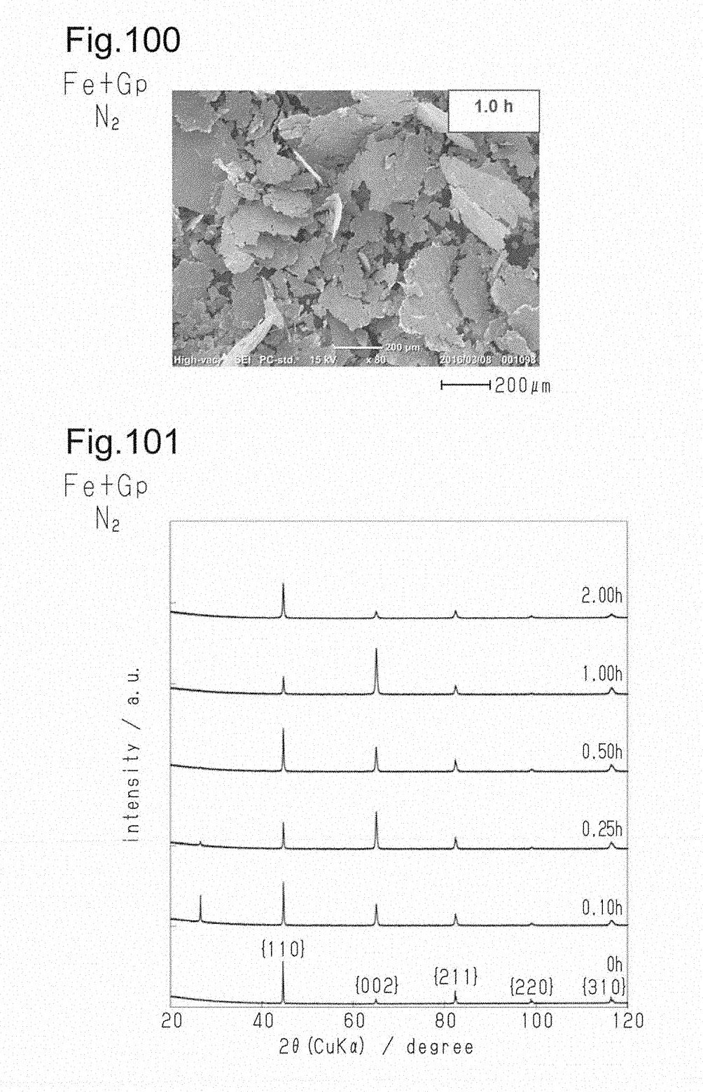

As shown in FIG. 100, a flat metal particle obtained by performing the mechanochemical treatment for 1 hour has a flat surface. The flat metal particle has an aspect ratio of 168.8.

As shown in FIG. 101, the intensity of the diffraction peak for the {002} plane is higher than the intensity of the diffraction peak for the {110} plane for a flat metal particle obtained by performing the mechanochemical treatment for 0.25 hours.

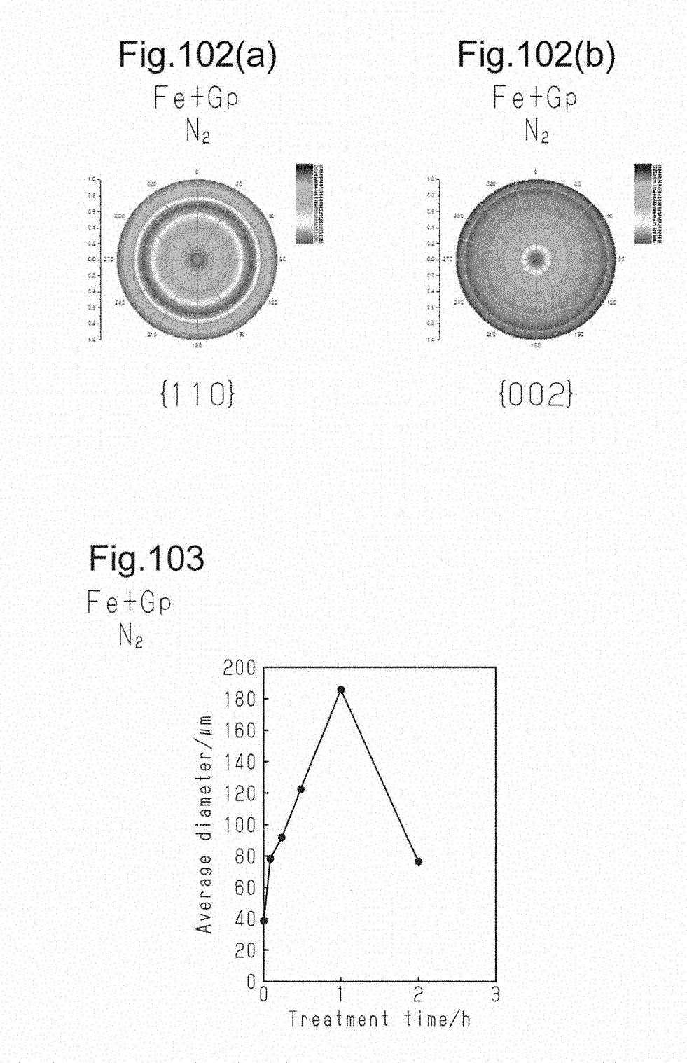

In addition, as shown in FIGS. 102(a) and 102(b), the pole figure of the {110} plane and the pole figure of the {002} plane of the flat metal particle obtained by performing the mechanochemical treatment for 1.0 hour are concentric. The texture is formed in the flat metal particle. As shown in FIGS. 101 and 102, it is understood that the mechanochemical treatment in the nitrogen atmosphere exhibits the effects which are equivalent to the effects due to the mechanochemical treatment in the oxygen atmosphere. That is, when the mechanochemical treatment is performed on a metal particle in the nitrogen atmosphere, the metal particle can be texturized while the oxidation of the metal particle is suppressed.

As shown in FIG. 103, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of the flat metal particle becomes small according to the treatment time.

### Example 27

In Example 27, the atmosphere in the mechanochemical treatment is changed from the example (air atmosphere) of Example 1. The mechanochemical treatment was performed in the argon atmosphere (99.9%, condensation pressure of 1013 hPa) to form flat metal particles of pure iron. The conditions excluding the atmosphere in the mechanochemical treatment were the same as in Example 1. In Example 27, the properties of each flat metal particle obtained by changing the treatment time for the mechanochemical treatment were investigated.

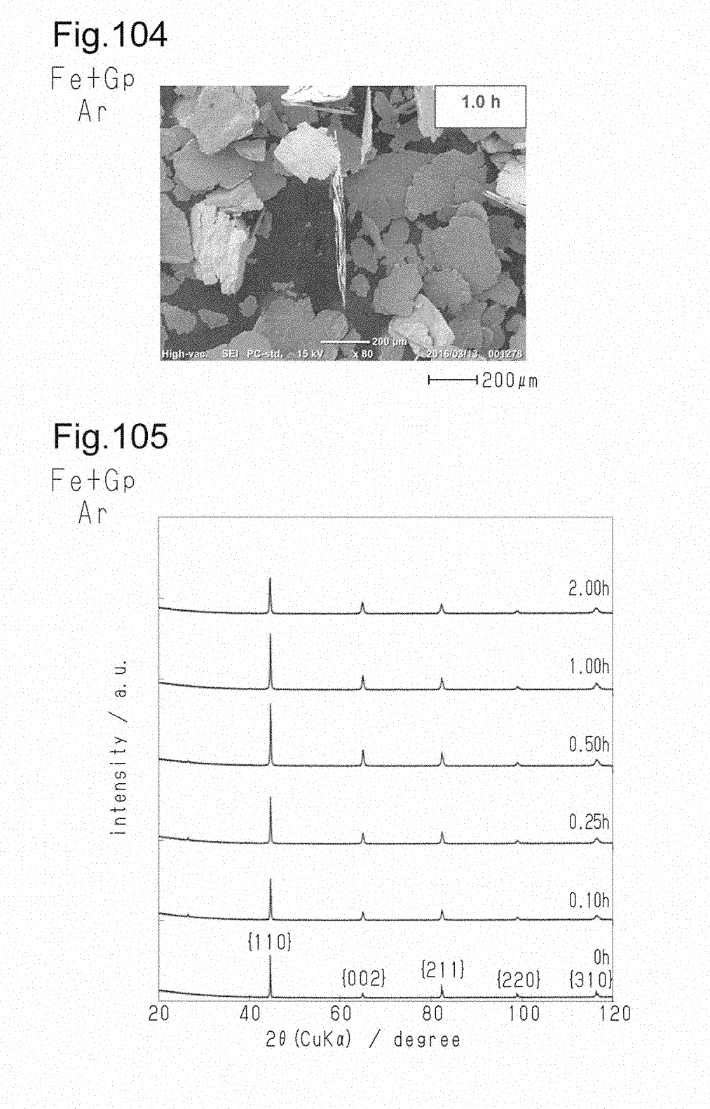

As shown in FIG. 104, a flat metal particle obtained by performing the mechanochemical treatment for 1 hour has a flat surface. The flat metal particle has an aspect ratio of 250.0.

As shown in FIG. 105, the intensity ratio of the diffraction peak for the {002} plane for a flat metal particle obtained by performing the mechanochemical treatment for 2 hours is higher than that for the metal particle with the mechanochemical treatment time being 0 hours.

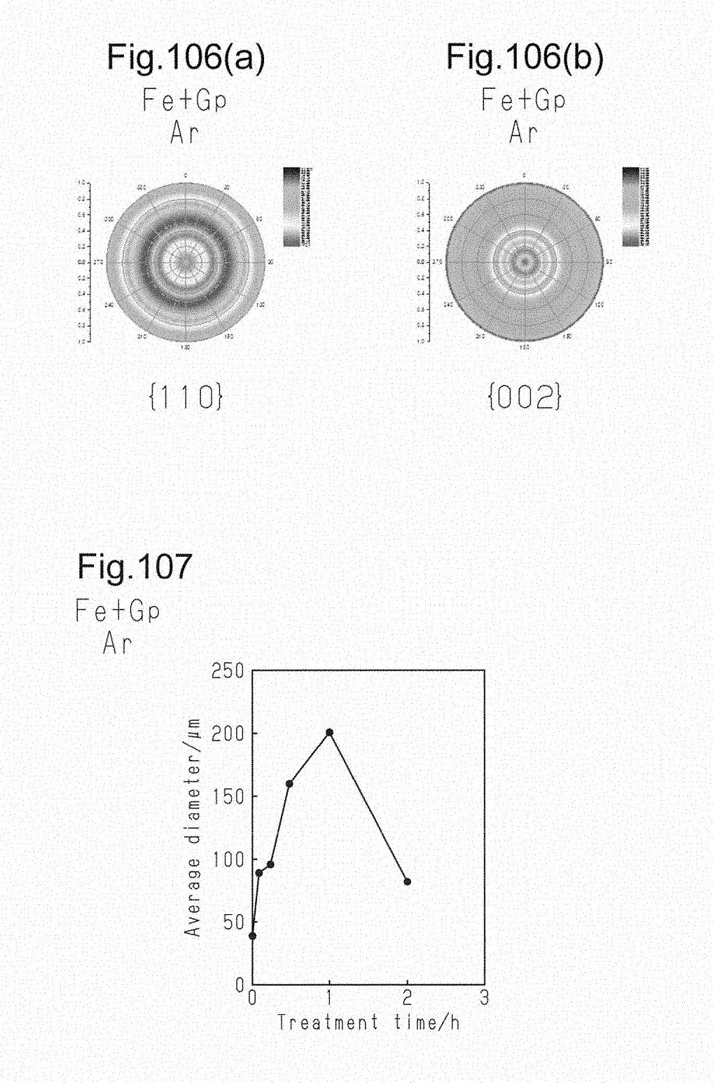

In addition, as shown in FIGS. 106(a) and 106(b), the pole figure of the {110} plane and the pole figure of the {002} plane of a flat metal particle obtained by performing the mechanochemical treatment for 1.0 hour are concentric. That is, the texture is formed in the flat metal particle. As shown in FIG. 107, there is a tendency that the average particle diameter of a flat metal particle becomes large according to the treatment time until the mechanochemical treatment time reaches 1 hour, but when the mechanochemical treatment time exceeds 1 hour, there is a tendency that the average particle diameter of the flat metal particle becomes small according to the treatment time.

As understood from Example 24 to Example 27 (see FIGS. 95 to 107), the texturization of a metal particle through the mechanochemical treatment is facilitated by oxygen or nitrogen. It is understood that oxygen and nitrogen exhibit almost the same effect with respect to the facilitation of the texturization. On the other hand, the effect of the texturization due to the graphite is not exhibited and the effect due to the graphite is diminished in the argon atmosphere even though the graphite is used as the texturization aid. That is, it is considered that the effect of the texturization due to the graphite is exerted or promoted by the existence of oxygen or nitrogen.

TABLE 7

| | Metal species | | | | Texturization aid | | | |
|---|---|---|---|---|---|---|---|---|
| | | | Average | | | Average | | |
| | | | particle | Amount | | particle | Amount | |
| | Main | Crystal | diameter | charged | | diameter | charged | |
| Example | component | structure | (um) | (mg) | | (um) | (mg) | Atmosphere |
| 17 | Fe | bcc | 39 | 2000 | Graphite | 10 | 0 mg | Air |
| 18 | Fe | bcc | 39 | 2000 | Graphite | 10 | 2 mg | Air |
| 19 | Fe | bcc | 39 | 2000 | Graphite | 10 | 140 mg | Air |
| 20 | Fe | bcc | 39 | 2000 | Carbon fiber | | 14 mg | Air |
| 21 | Fe | bcc | 39 | 2000 | PTFE | | 14 mg | Air |
| 22 | Fe | bcc | 39 | 2000 | Mineral oil | | 10 mg | Air |
| 23 | Fe | bcc | 39 | 2000 | MoS2 | | 14 mg | Air |
| 25 | Fe | bcc | 39 | 2000 | Graphite | 10 | 14 mg | Oxygen |
| 26 | Fe | bcc | 39 | 2000 | Graphite | 10 | 14 mg | Nitrogen |
| 27 | Fe | bcc | 39 | 2000 | Graphite | 10 | 14 mg | Argon |

| | Flat metal particle | | | | | | |
|---|---|---|---|---|---|---|---|
| | Average | | | Intensity change of diffraction peak at {002} | | | |
| | particle | | | Treatment | | | Rate |
| | diameter | | Aspect | time | Before | After | of |
| Example | (um) | Thickness | ratio | (hour) | treatment | treatment | change |
| 17 | 292.3 | 1.5 | 194.9 | 1.0 | 6.6 | 17.4 | 163.6 |
| 18 | 434.5 | 0.8 | 543.1 | 1.0 | 6.6 | 49.4 | 648.5 |
| 19 | 114.6 | 2.3 | 49.8 | 1.0 | 6.6 | 55.2 | 736.4 |
| 20 | 184.7 | 1.0 | 184.7 | 1.0 | 6.6 | 42.4 | 542.4 |
| 21 | 218.6 | 0.8 | 273.3 | 1.0 | 6.6 | 60.6 | 818.2 |
| 22 | 164.5 | 6.9 | 20.5 | 1.0 | 6.6 | 49.4 | 648.5 |
| 23 | 324.4 | 0.8 | 405.6 | 1.0 | 6.6 | 5836 | 787.9 |
| 25 | 227.1 | 0.8 | 283.9 | 1.0 | 6.6 | 63.1 | 856.1 |
| 26 | 185.6 | 1.1 | 168.8 | 1.0 | 6.6 | 58.0 | 778.8 |
| 27 | 200.0 | 0.8 | 250.0 | 1.0 | 6.6 | 18.2 | 175.8 |

### CONCLUSION

Table 4 summarizes the properties of the flat metal particles for Example 1 to Example 15. In the right end columns of the table, the “change in intensity of diffraction peak of given crystal plane” is shown. In these columns, the “treatment time” denotes the treatment time for the mechanochemical treatment. The value in “before treatment” denotes the intensity ratio of a diffraction peak before the treatment. The value in “after treatment” denotes the intensity ratio of a diffraction peak at the treatment time. The “rate of change” denotes “the rate of change in the intensity ratio of a diffraction peak before and after the treatment” defined above. Similarly, Table 7 is a table that summarizes the properties of the flat metal particles of Example 17 to Example 27 (excluding Example 24). The items shown in Table 4 and the items shown in Table 7 are the same.

As understood from Table 4 and Table 7, any of the flat metal particles has a value of 10% or more in terms of the “rate of change in intensity ratio of diffraction peak before and after treatment”.

In the bcc metals, the rate of change in the intensity ratio of the diffraction peak for the {002} plane is 100% or more irrespective of the existence of the added metal, the existence of the texturization aid or not, the kind of the texturization aid, and the atmosphere. On the other hand, in the fcc metals, the rate of change in the intensity ratio of the diffraction peak for the {220} plane is greatly different depending on the metal species. Similarly, in the hcp metals, the rate of change in the intensity ratio of the diffraction peak for the {0002} plane is different depending on the metal species. That is, among the fcc metals and the hcp metals, some are easily texturized and some are hard to texturize.

In addition, as understood from Table 4 and Table 7, the intensity ratio of the diffraction peak for the {002} plane is 20% or more for the iron-containing flat metal particles of the bcc structure mechanochemically treated using the texturization aid in the oxygen, nitrogen, or air atmosphere among the iron-containing flat metal particles having the bcc structure. The intensity ratio of the diffraction peak for the {002} plane is 10% or less for the iron-containing metal particles of the bcc structure on which the mechanochemical treatment is not performed, and therefore it can be said that the iron-containing flat metal particle of the bcc structure having an intensity ratio of the diffraction peak for the {002} plane of 20% or more is a novel magnetic material having magnetic orientation.

### OTHER EMBODIMENTS

It is to be noted that the present invention is not limited to the embodiments and Examples, and various modifications and replacements can be added to the embodiments without departing from the scope of the present invention. For example, the flat metal particle having the texture is used together with a flat metal particle that lacks the texture. That is, the two can be mixed.

In the case where graphite is used as the texturization aid, the graphite may be removed by heat-treating the flat metal particle or by other methods. In addition, the flat metal particle can be used in a state where the graphite is adhered thereto. In the embodiments, the flat metal particles having the texture were formed using the metal particles of the bcc structure, the metal particles of the fcc structure, and the metal particles of the hcp structure. It is considered from this fact that the flat metal particle having the texture can be obtained for all kinds of metals. Accordingly, the flat metal particle having the texture can be obtained for various kinds of alloys by the manufacturing method described above.

In addition, the flat metal particle according to the embodiment, particularly the flat iron particle according to the embodiment, can be covered with an insulating film. The flat iron particle having the insulating film (for example, resin or oxide film) as a shell is used as a material for the iron core in a transformer, an electrical motor, and a generator. For example, a molded article as the iron core is provided with a plurality of flat metal particles each having the insulating film, wherein the flat surface of the flat iron particle is orientated within a given angle range relative to the reference direction and the flat metal particles are laminated in the reference direction. Such a molded article has a lower hysteresis loss and a lower eddy current than conventional iron cores and can be used suitably as the iron core in a transformer, an electrical motor, and a generator.

### REFERENCE SIGNS LIST

100: Flat metal particle
101: Flat surface
200: Measurement surface
300: Container
301: Recessed portion

1-25. (canceled)

26. A method of manufacturing a flat metal particle, the method comprising
performing a mechanochemical treatment on metal powder comprising metal particles having an average particle diameter of 0.1 μm or greater and 1000 μm or less, wherein
in the mechanochemical treatment, the flat metal particle is formed from the metal particle(s) through a rolling treatment which includes at least one of: a a treatment of deforming and flattening the metal particles; a treatment of laminating the metal particles that are shaped into a flat shape; and a treatment of flattening a lump of the metal particles,
the metal particle has a bcc structure and contains iron, vanadium, or niobium, and
the mechanochemical treatment is performed in an oxygen-containing atmosphere using graphite as a texturization aid for facilitating texturization of the metal particles.

27. A method of manufacturing a flat metal particle, the method comprising
performing a mechanochemical treatment on metal powder comprising metal particles having an average particle diameter of 0.1 μm or greater and 1000 μm or less, wherein
in the mechanochemical treatment, the flat metal particle is formed from the metal particle(s) through a rolling treatment which includes at least one of: a a treatment of deforming and flattening the metal particles; a treatment of laminating the metal particles that are shaped into a flat shape; and a treatment of flattening a lump of the metal particles,
the metal particle has a bcc structure and contains iron, vanadium, or niobium, and
the mechanochemical treatment is performed in an air atmosphere using molybdenum disulfide as a texturization aid for facilitating texturization of the metal particles.

28. A method of manufacturing a flat metal particle, the method comprising
performing a mechanochemical treatment on metal powder comprising metal particles having an average particle diameter of 0.1 μm or greater and 1000 μm or less, wherein
in the mechanochemical treatment, the flat metal particle is formed from the metal particle(s) through a rolling treatment which includes at least one of: a a treatment of deforming and flattening the metal particles; a treatment of laminating the metal particles that are shaped into a flat shape; and a treatment of flattening a lump of the metal particles,
the metal particle has a bcc structure and contains iron, vanadium, or niobium, and
the mechanochemical treatment is performed in an air atmosphere using mineral oil as a texturization aid for facilitating texturization of the metal particle.

29. The method of manufacturing a flat metal particle according to claim 28, comprising, after the mechanochemical treatment, removing the texturization aid from the flat metal particle by dissolving the mineral oil adhered to the flat metal particle with a solvent.

30. The method of manufacturing a flat metal particle according to claim 26, wherein an aspect ratio d/t of the flat metal particle is 2 or more in the mechanochemical treatment, where t represents a thickness of the flat metal particle and d represents a particle diameter which is a size in a direction orthogonal to a thickness direction of the flat metal particle.

31. A flat metal particle comprising a texture due to mechanochemical treatment, wherein the flat metal particle includes a flat surface, has directionality in crystal orientation, and includes a plurality of layers along the flat surface,
the flat metal particle has a thickness of 0.05 μm or more and 100 μm or less, and
the flat metal particle has an aspect ratio d/t of 2 or more, where t represents the thickness of the flat metal particle and d represents a particle diameter which is a size in a direction orthogonal to a thickness direction of the flat metal particle.

32. The flat metal particle according to claim 31, wherein a pole figure, obtained by powder X-ray diffractometry, of a crystal plane of the flat metal particle shows a polar or belt-like intensity distribution.

33. The flat metal particle according to claim 32, wherein
the flat metal particle includes a metal having a body-centered cubic lattice structure, and
when a total intensity of diffraction peaks of successive 5 crystal planes from a low angle side in a powder X-ray diffraction chart of the flat metal particle is set to be 100%, an intensity ratio of at least one diffraction peak of the diffraction peaks of the 5 crystal planes from the low angle side is higher by 10% or more than an intensity ratio of a diffraction peak of a metal particle that lacks a texture.

34. The flat metal particle according to claim 32, wherein
the flat metal particle includes a metal having a body-centered cubic lattice structure, and
when a total intensity of diffraction peaks at {110}, {002}, {211}, {220}, and {310} in a powder X-ray diffraction chart of the flat metal particle is set to be 100%, an intensity ratio of the diffraction peak at {002} is 20% or more.

35. The flat metal particle according to claim 33, wherein the metal having the body-centered cubic lattice structure is a metal or an alloy, the metal being selected from the group consisting of Fe, V, Cr, Nb, Ta, and W, and the alloy comprising at least one of Fe, V, Cr, Nb, Ta, and W.

36. The flat metal particle according to claim 32, wherein
the flat metal particle includes a metal having a face-centered cubic lattice structure, and
when a total intensity of diffraction peaks of successive 5 crystal planes from a low angle side in a powder X-ray diffraction chart of the flat metal particle is set to be 100%, an intensity ratio of at least one diffraction peak of the diffraction peaks of the 5 crystal planes from the low angle side is higher by 10% or more than an intensity ratio of a diffraction peak of a metal particle that lacks a texture.

37. The flat metal particle according to claim 32, wherein
the flat metal particle includes a metal having a face-centered cubic lattice structure, and
when a total intensity of diffraction peaks at {111}, {002}, {220}, {311}, and {222} in a powder X-ray diffraction chart of the flat metal particle is set to be 100%, an intensity ratio of the diffraction peak at {220} is 10% or more.

38. The flat metal particle according to claim 36, wherein the metal having the face-centered cubic lattice structure is a metal or an alloy, the metal being selected from the group consisting of Al, Ni, Cu, Pb, Ag, Pt, Au, and Pd, and the alloy including at least one of Al, Ni, Cu, Pb, Ag, Pt, Au, and Pd.

39. The flat metal particle according to claim 32, wherein
the flat metal particle includes a metal having a hexagonal close-packed structure, and
when a total intensity of diffraction peaks of 3 crystal planes from a low angle side in a powder X-ray diffraction chart of the flat metal particle is set to be 100%, an intensity ratio of at least one diffraction peak of the diffraction peaks of the 3 crystal planes from the low angle side is higher by 10% or more than an intensity ratio of a diffraction peak of a metal particle that lacks a texture.

40. The flat metal particle according to claim 32, wherein
the flat metal particle includes a metal having a hexagonal close-packed structure, and
when a total intensity of diffraction peaks at {10-01}, {0002}, and {10-11} in a powder X-ray diffraction chart of the flat metal particle is set to be 100%, an intensity ratio of the diffraction peak at {0002} is 20% or more.

41. The flat metal particle according to claim 39, wherein the metal having the hexagonal close-packed structure is a metal or an alloy, the metal being selected from the group consisting of Ti, Co, Zn, and Zr, and the alloy including at least one of Ti, Co, Zn, and Zr.

42. A flat metal particle comprising:
the flat metal particle according to claim 31; and
an insulating film covering the flat metal particle.

43. A molded article comprising a plurality of the flat metal particles according to claim 42, wherein flat surfaces of the flat metal particles are made to face a same direction.

44. A flat metal particle comprising a texture due to mechanochemical treatment, wherein
the flat metal particle has a flat surface, has directionality in crystal orientation, has a plurality of layers along the flat surface, and has a thickness of 0.05 μm or more and 20 μm or less,
the flat metal particle has an aspect ratio d/t of 4 or more, where t represents the thickness of the flat metal particle and d represents a particle diameter which is a size in a direction orthogonal to a thickness direction of the flat metal particle,
a pole figure, obtained by powder X-ray diffractometry, of a crystal plane of the flat metal particle shows a polar or belt-like intensity distribution,
the flat metal particle is iron or an iron alloy having a body-centered cubic lattice structure, and
when a total intensity of diffraction peaks at {110}, {002}, {211}, {220}, and {310} in a powder X-ray diffraction chart of the flat metal particle is set to be 100%, an intensity ratio of the diffraction peak at {002} is 35% or more.

45. A method of manufacturing a metal plate, the method comprising:
positioning a metal powder containing the flat metal particles according to claim 31 so that the flat surfaces of the flat metal particles are orientated within a certain angle range relative to a reference direction while the flat metal particles are piled up; and
rolling, from a reference direction, a group of the metal powder positioned.
